(19) United States
(12) Patent Application Publication
(10) Pub. No.: US 2015/0125011 A1
(43) Pub. Date: May 7, 2015

(54) AUDIO SIGNAL PROCESSING DEVICE, AUDIO SIGNAL PROCESSING METHOD, PROGRAM, AND RECORDING MEDIUM

(71) Applicant: Sony Corporation, Tokyo (JP)

(72) Inventor: Toshiyuki Sekiya, Kanagawa (JP)

(73) Assignee: Sony Corporation, Tokyo (JP)

(21) Appl. No.: 14/400,875

(22) PCT Filed: Apr. 3, 2013
(86) PCT No.: PCT/JP2013/060247

§ 371 Date: Nov. 13, 2014

(30) Foreign Application Priority Data
Jul. 9, 2012 (JP) 2012-153363

(51) Int. Cl. H04S 7/00; H04S 3/00

(52) U.S. Cl. CPC H04S 7/307; H04S 3/00
USPC 381/307

(57) ABSTRACT

Provided is an audio signal processing device including frequency conversion units configured to generate a plurality of input audio spectra by performing frequency conversions on input audio signals input from a plurality of microphones provided in a housing, a first input selection unit configured to select input audio spectra corresponding to a first combination direction from among the input audio spectra based on an arrangement of the microphones for the housing, and a first combining unit configured to generate a combined audio spectrum having directivity of the first combination direction by calculating power spectra of the input audio spectra selected by the first input selection unit.

### TECHNICAL FIELD

The present disclosure relates to an audio signal processing device, an audio signal processing method, a program, and a recording medium.

### BACKGROUND ART

Audio reproduction systems for performing surround reproduction using a plurality of speakers on a plurality of pieces of audio having directivity corresponding to characteristics of each speaker when audio recorded on a recording medium such as a digital versatile disk (DVD) or a Blu-ray disk (BD) is reproduced indoors have been proposed. Such an audio reproduction device can reproduce surround-recorded audio in accordance with the characteristics of each speaker using surround technology for reproducing a realistic sound field as in a movie theater, a music hall, or the like.

In this manner, in order to implement an audio reproduction environment using this surround technology, surround reproduction systems of 5.1 channels, 7.1 channels, and the like according to characteristics (the number of installations, arrangement, sound quality, etc.) of speakers have been proposed. For example, in the 5.1-ch surround reproduction system, speakers of five channels arranged in the front left (L), the front center (C), the front right (R), surround left (SL) at the left rear, and surround left (SR) at the right rear and a 0.1-channel sub woofer (SW) are arranged with respect to the front direction of a listener. The surround system implements surround reproduction corresponding to the 5.1 channels around the listener.

In order to implement the above-described surround reproduction, it is desirable to perform surround sound recording in accordance with each speaker characteristic at the time of sound recording. Here, the surround sound recording is a process of combining and recording a plurality of combined audio signals having directivity according to speaker characteristics of the surround reproduction environment (hereinafter referred to as “directivity combining”). In this directivity combining, basically, a combining process of relatively enhancing audio arriving from a direction of a relevant speaker by reducing audio other than that arriving at the sound recording device from the direction of the speaker of the surround reproduction environment is performed.

In recent years, technology for implementing surround sound recording by installing a plurality of microphones in an imaging device so that audio of a captured moving image can be reproduced in the surround reproduction environment such as 5.1 ch even in the imaging device having an operation imaging function has been proposed. For example, in Patent Literature 1, technology for arranging three omnidirectional microphones in a video camera at positions of vertices of an equilateral triangle and combining audio signals having 5- or 7-ch unidirectivity from input audio signals input from these microphones is disclosed. In addition, in Patent Literature 2, technology for arranging four non-directional microphones at positions of vertices of a square and combining audio signals having 5-ch unidirectivity from input audio signals input from these microphones is disclosed.

### CITATION LIST

### Patent Literatures

Patent Literature 1: JP 2008-160588A
Patent Literature 2: JP 2002-223493A

### SUMMARY OF INVENTION

### Technical Problem

Incidentally, in the technologies of the above-described Patent Literatures 1 and 2, there is a constraint that a plurality of microphones be arranged at vertex positions of an equilateral triangle or a square and arranged to be close to each other (for example, a distance between microphones is about 1.0 cm). There is an advantage in that directivity combining with excellent symmetry can be implemented by arranging a plurality of microphones at symmetrical positions and input characteristics of the microphones are equivalent when sound is input to the microphones through an adjacent arrangement.

However, in the technologies of the above-described Patent Literatures 1 and 2, it is difficult to favorably implement directivity combining using an input audio signal from a relevant microphone when the arrangement of the plurality of microphones does not satisfy the above-described constraint. This is because input characteristics of the plurality of microphones are different due to an influence of a housing or the like of a sound recording device on which the microphones are installed. When the input characteristics of the microphones are different as described above, it is difficult to appropriately perform directivity combining through a process of combining input audio signals themselves or a process of combining audio spectra obtained by performing frequency conversions on the input audio signals as in the technologies of Patent Literatures 1 and 2.

For example, the case in which a combined audio signal to be used in a 5-ch surround reproduction environment as illustrated in FIG. 2 is generated from input audio signals obtained by three microphones M₁, M₂, and M₃ installed in a digital camera 1 as illustrated in FIG. 1 is considered. In the surround reproduction environment illustrated in FIG. 2, it is desirable to arrange 5 speakers C, L, R, SL, and SR around a user who is a listener and output 5 pieces of reproduced audio z_{L}, z_{C}, z_{R}, z_{SL}, and z_{SR} having directivity suitable for the arrangement from these speakers.

As illustrated in FIG. 1, two microphones M₁ and M₂ are arranged on a front-surface side (the side on which a lens 2 is arranged) of a digital camera 1 and one microphone M₃ is arranged on a rear-surface side (the side on which a screen 3 is arranged) of the digital camera 1. Thus, because the housing 4 of the digital camera 1 is located among the microphones M₁ and M₂ of the front-surface side and the microphone M₃ of the rear-surface side, the audio input characteristics for the microphones M₁, M₂, and M₃ due to the influence of the housing 4 become different. That is, the sound arriving from the rear-surface direction of the digital camera 1 is significantly attenuated by the housing 4 and input to the microphones M₁ and M₂ of the front-surface side. Because of this, a main audio signal in relation to audio arriving from the rear-surface direction is obtained by only one microphone M₃. Accordingly, because audio information of the left/right direction is not obtained with respect to the rear-surface side of the digital camera 1, it is difficult to favorably combine combined audio signals z_{SL} and z_{SR} having directivity of the SL and SR directions illustrated in FIG. 2.

In addition, because a space alias is caused between the microphones when distances between the microphones M₁ and M₂ and the microphone M₃ increase as illustrated in FIG. 1, distortion occurs in the directivity of the combined audio signal.

Further, in recent years, the constraint condition of the arrangement of the microphones in the technologies of the above-described Patent Literatures 1 and 2 is not satisfied in many cases because it is difficult to arrange a plurality of microphones at free positions of the housing due to the requirement of size reduction of sound recording devices such as digital cameras or constraints in terms of functions. Accordingly, technology capable of appropriately generating a combined audio signal having desired directivity regardless of the arrangement of the microphones for the housing is desired.

In view of the above-described circumstances, it is desirable to favorably combine a combined audio signal having desired directivity using input audio signals of relevant microphones even in a microphone arrangement in which a difference occurs in input characteristics of a plurality of microphones from an influence of a housing or the like.

### Solution to Problem

According to the present disclosure, there is provided an audio signal processing device including frequency conversion units configured to generate a plurality of input audio spectra by performing frequency conversions on input audio signals input from a plurality of microphones provided in a housing, a first input selection unit configured to select input audio spectra corresponding to a first combination direction from among the input audio spectra based on an arrangement of the microphones for the housing, and a first combining unit configured to generate a combined audio spectrum having directivity of the first combination direction by calculating power spectra of the input audio spectra selected by the first input selection unit.

Further, according to the present disclosure, there is provided an audio signal processing method including generating a plurality of input audio spectra by performing frequency conversions on a plurality of input audio signals input from a plurality of microphones provided in a housing, selecting input audio spectra corresponding to a first combination direction from among the input audio signals based on an arrangement of the microphones for the housing, and generating a combined audio spectrum having directivity of the first combination direction by calculating power spectra of the selected input audio spectra.

Further, according to the present disclosure, there is provided a program for causing a computer to execute generating a plurality of input audio spectra by performing frequency conversions on a plurality of input audio signals input from a plurality of microphones provided in a housing, selecting input audio spectra corresponding to a first combination direction from among the input audio signals based on an arrangement of the microphones for the housing, and generating a combined audio spectrum having directivity of the first combination direction by calculating power spectra of the selected input audio spectra.

Further, according to the present disclosure, there is provided a computer-readable recording medium having a program recorded thereon, the program causing a computer to execute generating a plurality of input audio spectra by performing frequency conversions on a plurality of input audio signals input from a plurality of microphones provided in a housing, selecting input audio spectra corresponding to a first combination direction from among the input audio signals based on an arrangement of the microphones for the housing, and generating a combined audio spectrum having directivity of the first combination direction by calculating power spectra of the selected input audio spectra.

According to the above-described configuration, a plurality of input audio spectra are generated by performing frequency conversions on input audio signals input from a plurality of microphones provided in a housing, input audio spectra corresponding to a first combination direction are selected from among the input audio spectra based on an arrangement of the microphones for the housing, and a combined audio spectrum having directivity of the first combination direction is generated by calculating power spectra of the selected input audio spectra. In this manner, the input audio spectra are calculated in the power spectrum domain. Thereby, it is possible to favorably generate a combined audio signal having desired directivity even when a difference occurs in sound input characteristics of the microphones due to an influence of the arrangement of the microphones for the housing.

### Advantageous Effects of Invention

According to the present disclosure as described above, it is possible to favorably combine a combined audio signal having desired directivity using input audio signals of relevant microphones even in a microphone arrangement in which a difference occurs in input characteristics of a plurality of microphones from an influence of a housing or the like.

### BRIEF DESCRIPTION OF DRAWINGS

FIG. 1 is a perspective view illustrating a digital camera on which three microphones are installed.

FIG. 2 is a schematic diagram illustrating a 5-ch surround reproduction environment.

FIG. 3 is an explanatory diagram illustrating a sound arrival direction for microphones and a housing.

FIG. 4 is a diagram illustrating results of measuring input characteristics of a front surface microphone and a rear surface microphone.

FIG. 5 is a diagram illustrating a microphone arrangement, input characteristics, and a surround reproduction environment.

FIG. 6 is a schematic diagram illustrating the principle of directivity combining according to a first embodiment of the present disclosure.

FIG. 7 is a schematic diagram illustrating the principle of the directivity combining according to the first embodiment.

FIG. 8 is a schematic diagram illustrating the principle of the directivity combining according to the first embodiment.

FIG. 9 is a plan view illustrating an arrangement of a microphone and speakers.

FIG. 10 is a waveform diagram illustrating various types of power spectra.

FIG. 11 is a waveform diagram illustrating a power spectrum.

FIG. 12 is a block diagram illustrating a hardware configuration of a digital camera to which an audio signal processing device according to the first embodiment is applied.

FIG. 13 is a block diagram illustrating a functional configuration of the audio signal processing device according to the first embodiment.

FIG. 14 is a block diagram illustrating a configuration of a first input selection unit according to the first embodiment.

FIG. 15 is a block diagram illustrating a configuration of a first combining unit according to the first embodiment.

FIG. 16 is a block diagram illustrating a specific example of a directivity combining function of the audio signal processing device according to the first embodiment.

FIG. 17 is a flowchart illustrating an audio signal processing method according to the first embodiment.

FIG. 18 is a flowchart illustrating an operation of the first input selection unit according to the first embodiment.

FIG. 19 is a flowchart illustrating an operation of the first combining unit according to the first embodiment.

FIG. 20 is a diagram illustrating results of measuring input characteristics of a front surface microphone and a rear surface microphone for every frequency band.

FIG. 21 is a schematic diagram illustrating the principle of directivity combining.

FIG. 22 is a block diagram illustrating a functional configuration of an audio signal processing device according to a second embodiment of the present disclosure.

FIG. 23 is a block diagram illustrating a configuration of a second input selection unit according to the second embodiment.

FIG. 24 is a block diagram illustrating a configuration of a second combining unit according to the second embodiment.

FIG. 25 is a block diagram illustrating a specific example of a directivity combining function of the audio signal processing device according to the second embodiment.

FIG. 26 is a schematic diagram illustrating the principle of the directivity combining according to the second embodiment.

FIG. 27 is a waveform diagram illustrating various types of power spectra.

FIG. 28 is a schematic diagram illustrating an arrangement of microphones and speakers.

FIG. 29 is a flowchart illustrating an audio signal processing method according to the second embodiment.

FIG. 30 is a flowchart illustrating an operation of a second input selection unit according to the second embodiment.

FIG. 31 is a flowchart illustrating an operation of a second combining unit according to the second embodiment.

FIG. 32 is a flowchart illustrating an operation of a first input selection unit according to the second embodiment.

FIG. 33 is a flowchart illustrating an operation of a first combining unit according to the second embodiment.

FIG. 34 is a block diagram illustrating a functional configuration of an audio signal processing device according to a third embodiment of the present disclosure.

FIG. 35 is a block diagram illustrating a configuration of an output selection unit according to the third embodiment.

FIG. 36 is a diagram illustrating a microphone arrangement and a surround reproduction environment according to the third embodiment.

FIG. 37 is a block diagram illustrating a specific example of a directivity combining function of the audio signal processing device according to the third embodiment of the present disclosure.

FIG. 38 is a diagram illustrating results of measuring input characteristics of microphones according to the third embodiment.

FIG. 39 is a diagram illustrating characteristics of a combined audio spectrum according to the third embodiment.

FIG. 40 is a diagram illustrating characteristics of an omnidirectional spectrum and a combined audio spectrum according to the third embodiment.

FIG. 41 is a flowchart illustrating an audio signal processing method according to the third embodiment.

FIG. 42 is a flowchart illustrating an operation of a first combining unit for an SL channel according to the third embodiment.

FIG. 43 is a diagram illustrating a video camera on which three microphones are arranged according to the third embodiment.

FIG. 44 is a schematic diagram illustrating a three-dimensional surround reproduction environment according to the third embodiment.

FIG. 45 is a schematic diagram illustrating a combined audio spectrum having directivity of C, L, and R directions according to the third embodiment.

FIG. 46 is a schematic diagram illustrating input characteristics of microphones and characteristics of audio spectra in directivity combining according to the third embodiment.

FIG. 47 is a schematic diagram illustrating characteristics of a combined audio spectrum according to the third embodiment.

FIG. 48 is an explanatory diagram illustrating surround reproduction environments of 2.1 ch, 3.1 ch, and 5.1 ch.

FIG. 49 is a block diagram illustrating a functional configuration of an audio signal processing device according to a fourth embodiment of the present disclosure.

FIG. 50 is a diagram illustrating a graphic user interface (GUI) screen for allowing a user to select a surround reproduction environment.

FIG. 51 illustrates an identifier (ID) sequence and a weighting coefficient w held by a holding unit of a second directivity combining unit according to the fourth embodiment.

FIG. 52 illustrates an ID sequence and weighting coefficients g and f held by a holding unit of a first directivity combining unit according to the fourth embodiment.

FIG. 53 is a flowchart illustrating an operation of a second input selection unit according to the fourth embodiment.

FIG. 54 is a flowchart illustrating an operation of a second combining unit according to the fourth embodiment.

FIG. 55 is a flowchart illustrating an operation of a first input selection unit according to the fourth embodiment.

FIG. 56 is a flowchart illustrating an operation of a first combining unit according to the fourth embodiment.

FIG. 57 is an explanatory diagram illustrating a video camera 7 on which built-in microphones and an external microphone are installed according to the fourth embodiment.

FIG. 58 is an explanatory diagram illustrating a surround reproduction environment.

FIG. 59 is a block diagram illustrating a functional configuration of an audio signal processing device according to a fifth embodiment of the present disclosure.

FIG. 60 is a schematic diagram illustrating input characteristics of the external microphone and characteristics of a combined audio spectrum according to the fifth embodiment.

FIG. 61 is a schematic diagram illustrating the characteristics of the combined audio spectrum.

FIG. 62 is a flowchart illustrating an operation of a first input selection unit according to the fifth embodiment.

FIG. 63 is a flowchart illustrating an operation of a first combining unit according to the fifth embodiment.

FIG. 64 is a diagram illustrating an arrangement of microphones of a smartphone according to the fifth embodiment.

FIG. 65 is a diagram illustrating amplitude characteristics of a microphone for capturing a moving image and a microphone for a telephone call according to a sixth embodiment of the present disclosure.

FIG. 66 is a diagram illustrating a correction coefficient according to the sixth embodiment.

FIG. 67 is a block diagram illustrating a functional configuration of an audio signal processing device according to the sixth embodiment.

FIG. 68 is a flowchart illustrating an operation of a correction unit according to the sixth embodiment.

### DESCRIPTION OF EMBODIMENTS

Hereinafter, preferred embodiments of the present invention will be described in detail with reference to the appended drawings. Note that, in this specification and the drawings, elements that have substantially the same function and structure are denoted with the same reference signs, and repeated explanation is omitted.

Also, description will be given in the following order.

1. First embodiment
1.1. Outline of directivity combining
1.2. Definitions of terms
1.3. Principle of directivity combining
1.4. Configuration of audio signal processing device
1.4.1. Hardware configuration of audio signal processing device
1.4.2. Functional configuration of audio signal processing device
1.5 Audio signal processing method
1.5.1. Overall operation of audio signal processing device
1.5.2. Operation of first input selection unit
1.5.3. Operation of first combining unit
1.6 Advantageous effects
2. Second embodiment
2.1. Outline of second embodiment
2.2. Functional configuration of audio signal processing device
2.3 Audio signal processing method
2.3.1. Overall operation of audio signal processing device
2.3.2. Operation of second input selection unit
2.3.3. Operation of second combining unit
2.3.4. Operation of first input selection unit
2.3.5. Operation of first combining unit
2.4. Advantageous effects
3. Third embodiment
3.1. Outline of third embodiment
3.2. Functional configuration of audio signal processing device
3.3. Audio signal processing method
3.3.1. Overall operation of audio signal processing device
3.3.2. Operation of first combining unit
3.3.3. Operation of output selection unit
3.4 Specific example
3.5. Advantageous effects
4. Fourth embodiment
4.1. Outline of fourth embodiment
4.2. Functional configuration of audio signal processing device
4.3. Audio signal processing method
4.3.1. Operation of second input selection unit
4.3.2. Operation of second combining unit
4.3.3. Operation of first input selection unit
2.3.4. Operation of first combining unit
4.4. Advantageous effects
5. Fifth embodiment
5.1. Outline of fifth embodiment
5.2. Functional configuration of audio signal processing device
5.3. Audio signal processing method
5.3.1. Operation of first input selection unit
5.3.2. Operation of first combining unit
5.4. Advantageous effects
6. Sixth embodiment
6.1. Outline of fifth embodiment
6.2. Functional configuration of audio signal processing device
6.3. Audio signal processing method
6.3.1. Operation of correction unit
6.4. Advantageous effects

### 1. First Embodiment

### 1.1. Outline of Directivity Combining

First, an outline of a directivity combining process according to the audio signal processing device and method according to the first embodiment of the present disclosure will be described.

As described above, it is desirable to perform surround sound recording suitable for characteristics of each speaker of a surround reproduction environment at the time of sound recording by the sound recording device so as to implement surround reproduction of 5.1 ch, 7.1 ch, or the like. In order to perform the surround sound recording, it is necessary to perform directivity combining on input audio signals obtained by a plurality of microphones in accordance with each channel of the surround reproduction environment.

At this time, in the conventional technology, a combined audio signal according to the surround reproduction environment is generally generated by combining the input audio signals themselves input from the microphones or combining input audio spectra obtained by performing frequency conversions on the input audio signals.

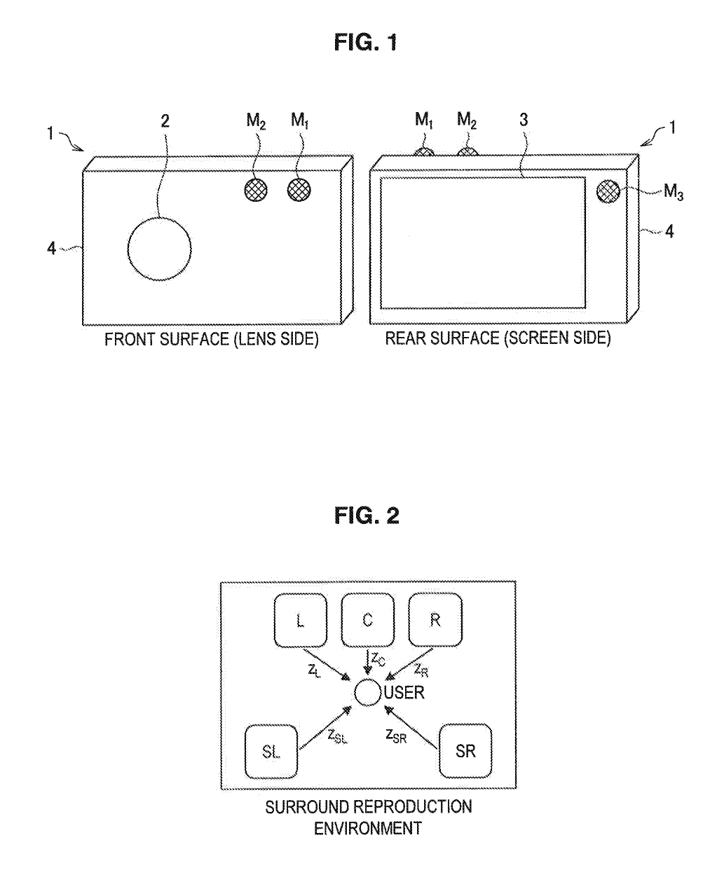

Incidentally, in the conventional directivity combining technologies disclosed in the above-described Patent Literatures 1 and 2, there is a constraint in an arrangement of a plurality of microphones (a symmetrical arrangement of an equilateral triangle or the like, an adjacent arrangement, or the like). It is difficult to implement good directivity combining when the constraint is not satisfied. This is because there is a difference between sound input characteristics for microphones M₁, M₂, and M₃ due to the influence of the housing 4 when the microphones M₁, M₂, and M₃ are arranged on both sides between which the housing 4 of the sound recording device (digital camera 1) is interposed as described in FIGS. 1 and 2.

For example, because audio arriving from a rear-surface direction of the housing 4 is interfered with by the housing 4 in the example of the microphone arrangement of FIG. 1, the audio is attenuated and input for the two microphones M₁ and M₂, of the front-surface side, but the audio is input without being attenuated for the one microphone M₃ of the rear-surface side. On the other hand, audio arriving from the front-surface direction of the housing 4 is also similar. As a result, input characteristics of the microphones M₁ and M₂ are different from those of the microphone M₃. Accordingly, in the above-described conventional technologies, it is difficult to favorably generate combined audio due to a difference between the input characteristics even when the input audio signals of the three microphones M₁, M₂, and M₃ are used. In particular, only the one microphone M₃ is arranged on the rear-surface side of the housing 4, and a main means for obtaining information with respect to sound arriving from the rear-surface direction of the housing 4 is only the microphone M₃. Accordingly, in the above-described conventional technologies, it is difficult to appropriately combine combined audio signals of the left and right directions (SL and SR directions) of the rear-surface side of the housing 4. In the illustrated example, it is possible to appropriately generate the combined audio signal of the SR direction to a certain extent using the input audio signal of the microphone M₃, but it is difficult to appropriately generate the combined audio signal of the SL direction.

Accordingly, the audio signal processing device and method according to the present embodiment are suitably applied to the case in which the input characteristics of the plurality of microphones are different due to an influence of the housing 4 because the plurality of microphones are not in a symmetrical and adjacent arrangement or the like. That is, an objective of the audio signal processing device and method according to the present embodiment is to implement good directivity combining even when some of input audio signals necessary for multi-channel surround recording are insufficient due to the constraint in a microphone arrangement or the number of installed microphones.

Because of this, in the present embodiment, a process (directivity combining) of combining audio signals is performed in a power spectrum domain instead of a time domain or a complex spectrum domain of the audio signals as in the conventional technologies. For example, in the above example of FIG. 1, audio components from the front-surface direction are input without being attenuated even when audio components from the rear-surface direction are attenuated with respect to the microphones M₁ and M₂ of the front-surface side. Accordingly, it is possible to combine an omnidirectional power spectrum Pₐₗₗ including both the audio signals of the front-surface side and the rear-surface side by appropriately mixing the input audio signals of the microphones M₁, M₂, and M₃ in the power spectrum domain. Then, it is possible to generate an audio component of the SL direction by combining a non-combination direction power spectrum Pₑₗₛₑ including the audio component from a direction other than the SL direction which is a combination direction and subtracting the non-combination direction power spectrum Pₑₗₛₑ from the above-described omnidirectional power spectrum Pₐₗₗ. The audio component from the direction other than the SL direction is mainly audio components of front and right directions, and it is possible to generate a power spectrum Pₑₗₛₑ of the audio component of a direction other than the relevant SL direction mainly using the input audio signal of the microphones M₁ and M₂ of the front-surface side.

As described above, according to the present embodiment, it is possible to favorably implement multi-channel directivity combining even in a microphone arrangement in which it is difficult to implement surround sound recording in the conventional technology by calculating audio signals obtained by a plurality of microphones in the power spectrum domain.

### 1.2. Definition of Terms

In the present specification, audio means all sounds including music, a musical composition, acoustics, mechanical sound, natural sound, and environmental sound as well as a voice of a human or an animal.

The combination direction is a direction of directivity of a combined audio signal and corresponds to a direction from the listener (user) to a speaker in the surround reproduction environment. In order to implement surround reproduction of N channels, it is only necessary to generate combined audio signals of N combination directions. For example, in order to perform surround reproduction of five channels illustrated in FIG. 2, the combination directions are 5 directions of L, C, R, SL, and SR directions and it is necessary to generate 5 combined audio signals of the L, C, R, SL, and SR directions at the time of sound recording or reproduction.

The directivity combining means a process of combining a plurality of combined audio signals having directivity according to characteristics (a direction, an arrangement, sound quality, etc.) of each speaker in the surround reproduction environment from input audio signals input from the plurality of microphones.

The surround sound recording means a process of generating a plurality of combined audio signals (a number of channels of the reproduction environment) and recording the generated combined audio signals on a recording medium according to the above-described directivity combining. In addition, the surround reproduction means a process of reproducing the plurality of combined audio signals recorded on the recording medium and outputting audio from the plurality of speakers in a surround reproduction system.

The omnidirectional power spectrum means a power spectrum substantially equally including audio components arriving from all directions around a sound recording device. In addition, a non-combination direction power spectrum means a power spectrum including audio components arriving from directions other than a specific combination direction. The non-combination direction power spectrum corresponds to a power spectrum excluding a power spectrum of an audio component arriving from the specific combination direction from the omnidirectional power spectrum.

Combining input audio signals in the power spectrum domain means a process of converting input audio signals x of the time domain into audio spectra X of the frequency domain, further calculating power spectra P of the audio spectra X, and combining the power spectra P of the audio spectra X. In addition, combining the input audio signals in the complex spectrum domain (audio spectrum domain) means a process of converting the input audio signals x of the time domain into the audio spectra X of the frequency domain and further combining the audio spectra X.

In addition, in the following description, “x” and “x(n)” represent an input audio spectrum (time domain) input from the microphone. “X” and “X(k)” represent an input audio spectrum obtained by performing frequency conversion on the audio signal (time domain) input from the microphone. “Z” and “Z(k)” represent a combined audio spectrum obtained by a first combining unit performing directivity combining. “Y” and “Y(k)” represent a combined audio spectrum obtained by a second combining unit performing directivity combining. “z” and “z(n)” represent a combined audio signal or input audio signal (time domain) output from the audio signal processing device.

In addition, “n” represents a time index (an index representing each time component when an audio signal is sampled every predetermined time), and “k” represents a frequency index (an index representing each frequency component when an audio spectrum signal is divided for every predetermined frequency band). Hereinafter, for convenience of description, a time index n or a frequency index k is appropriately omitted when it is unnecessary to specify a frequency component or a frame.

### 1.3. Principle of Directivity Combining

Next, the principle of the directivity combining process according to the audio signal processing device and method according to the present embodiment will be described.

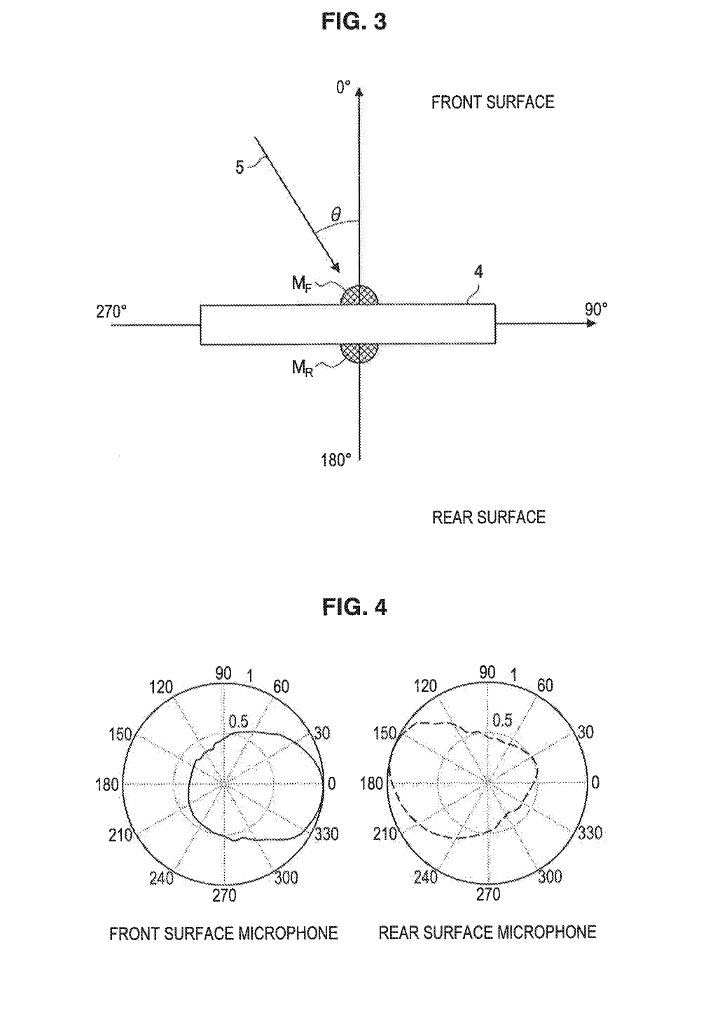

First, with reference to FIGS. 3 to 5, the basis on which it is necessary to perform directivity combining according to the present embodiment, that is, the reason for which input characteristics of a plurality of microphones are different due to an influence of the housing 4 or the like of the sound recording device, will be described.

Basically, when the housing 4 or the like of the sound recording device is present among the plurality of microphones and the housing 4 or the like serves as an obstacle of sound propagation, the input characteristics of the microphones become different. That is, because the sound arriving from a sound source is reflected or attenuated by hitting the housing 4 which is the obstacle, an audio signal level observed by the microphone varies on the front-surface side and the rear-surface side of the housing 4.

For example, the case in which sound 5 arrives at the housing 4 from a sound source located in an arbitrary direction around the housing 4 when one microphone M_{F} is arranged on the front-surface side of the housing 4 of the sound recording device and one microphone M_{R} is arranged on the rear-surface side as illustrated in FIG. 3 is considered. At this time, when an angle formed between the arrival direction of the sound 5 of the housing 4 and the front-surface direction of the housing 4 is represented by θ and the arrival direction of the sound 5 is consistent with the front-surface direction of the housing 4, θ=0 degrees. Hereinafter, the sound arrival direction is represented by θ.

FIG. 4 illustrates results of measuring input characteristics of the front surface microphone M_{F} and the rear surface microphones Ma when sound is generated from every direction at 10-degree intervals from θ=0 degrees and sound is collected by the front surface microphone M_{F} and the rear surface microphones M_{R} in the above-described microphone arrangement of FIG. 3. In FIG. 4, the value of 0 to 330 on the circumference is an angle representing the arrival direction θ of the above-described sound 5 and a value of 0.5 or 1.0 represents a ratio of a sound intensity.

As illustrated in FIG. 4, it can be seen that, when the intensity of sound from a direction of 180 degrees is set to 1 in the rear surface microphones M_{F}, the intensity of sound from a direction of 0 degrees is input after being attenuated to 0.5, that is, half. Likewise, it can be seen that the sound from the rear-surface direction (a direction of 180 degrees) is input after being attenuated to half or less even for the front surface microphone M_{F}. In this manner, it can be seen that, when the housing 4 is located between the two microphones M_{F} and M_{R}, sound arriving from opposite sides of the housing 4 interposed therebetween is significantly attenuated and input to the microphones M_{F} and M_{R}.

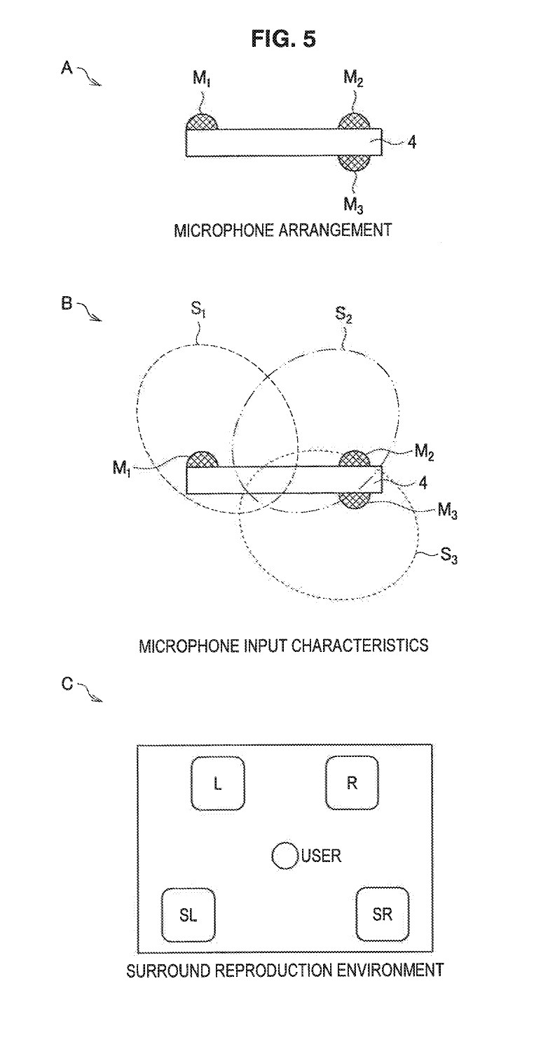

Accordingly, in the arrangement of three microphones M₁, M₂, and M₃ illustrated in FIG. 5A, input characteristics of the microphones M₁, M₂, and M₃ become input characteristics S₁, S₂, and S₃ illustrated in FIG. 5B due to the influence of the housing 4. The microphone M₁ of the front-surface side of the housing 4 mainly has high directivity for sound from the left front (L direction) and the microphone M₂ mainly has high directivity for sound from the right front (E direction). On the other hand, the microphone M₃ of the rear-surface side of the housing 4 mainly has high directivity for sound from the right rear (SR direction).

In this manner, it is possible to obtain information of input sounds of the L, R, and SR directions in the microphone arrangement illustrated in FIG. 5A, but it is difficult to sufficiently obtain information of input sound of the left rear direction (SL direction) of the housing 4 and the input characteristics S₁, S₂, and S₃ of the three microphones M₁, M₂, and M₃ are also different. Accordingly, because it is difficult to favorably generate a combined audio signal of the SL direction in the case of the microphone arrangement illustrated in FIG. 5A in the conventional directivity combining method under the assumption that the input characteristics of a plurality of microphones are consistent, it is difficult to suitably implement a surround reproduction environment of four channels as illustrated in FIG. 5C.

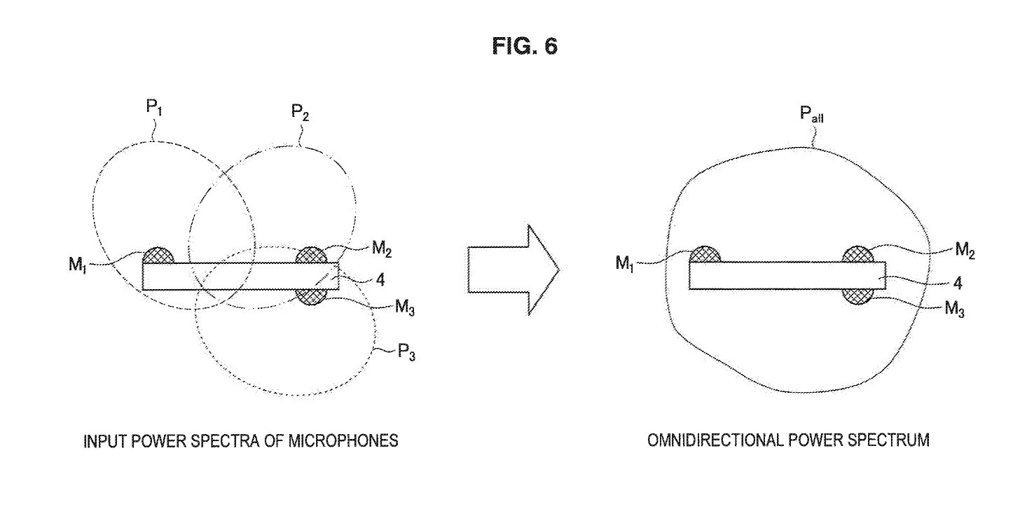

Next, with reference to FIGS. 6 to 8, the principle of the directivity combining according to the present embodiment will be described.

According to the input characteristics S₁, S₂, and S₃ of the three microphones M₁, M₂, and M₃ illustrated in FIG. 5B, sound from the rear-surface direction is attenuated in the front surface microphones M₁ and M₂, but the sound's signal level does not become 0 and the sound of the rear-surface direction is observable to a certain extent. Likewise, the sound from the front-surface direction is also attenuated in the rear surface microphone M₃, but the sound's signal level does not become 0. That is, even in the microphone arrangement illustrated in FIG. 6A, sounds input to the microphones M₁, M₂, and M₃ include an audio component of the SL direction even when the sounds are attenuated.

Therefore, in the directivity combining method according to the present embodiment, as illustrated in FIG. 6, a power spectrum (that is, an omnidirectional power spectrum Pₐₗₗ) equally including the omnidirectional audio signal component around the sound recording device is obtained by combining three input audio signals x₁, X₂, and x₃ input from the microphones M₁, M₂, and M₃ in the power spectrum domain. At this time, by performing frequency conversions on the input audio signals x₁, x₂, and x₃, input audio spectra X₁, X₂, and X₃ are generated and power spectra P₁, P₂, and P₃ of the input audio spectra X₁, X₂, and X₃ are calculated. Then, the omnidirectional power spectrum Pₐₗₗ is calculated by appropriately performing weighting addition on the power spectra P₁, P₂, and P₃ using weighting coefficients g₁, g₂, and g₃ (first weighting coefficients) set according to the arrangement of the microphones M₁, M₂, and M₃.

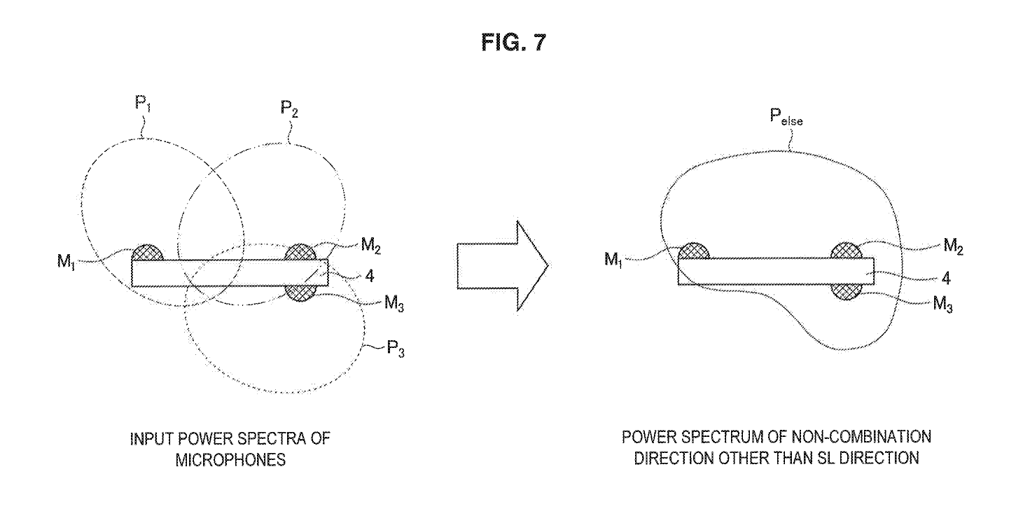

Further, as illustrated in FIG. 7, a power spectrum (that is, a power spectrum Pₑₗₛₑ) including an audio component from a direction other than the SL direction which is the combination direction by combining the three input audio signals x₁, x₂, and x₃ input from the microphones M₁, M₂, and M₃ in the power spectrum domain is obtained. At this time, the non-combination direction power spectrum Pₑₗₛₑ is calculated by appropriately performing weighting addition on the power spectra P₁, P₂, and P₃ using weighting coefficients f₁, f₂, and f₃ (second weighting coefficients) set according to the arrangement of the microphones M₁, M₂, and M₃.

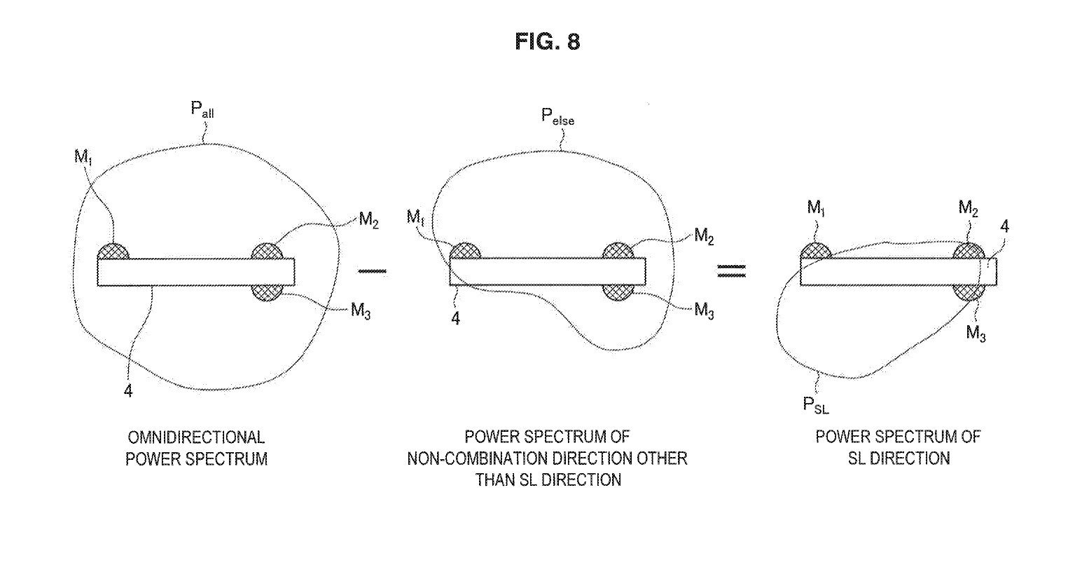

Then, as illustrated in FIG. 8, a power spectrum P_{SL} of the audio component arriving from the SL direction is estimated by subtracting the non-combination direction power spectrum Pₑₗₛₑ from the omnidirectional power spectrum Pₐₗₗ. Then, it is possible to restore a complex spectrum X_{SL} of the input audio of the SL direction from the power spectrum P_{SL} by obtaining the square root of the power spectrum P_{SL} of the SL direction and assigning an appropriate phase. Thereby, in the present embodiment, it is possible to obtain a directivity combining result of the SL direction which is not obtained in the conventional technologies.

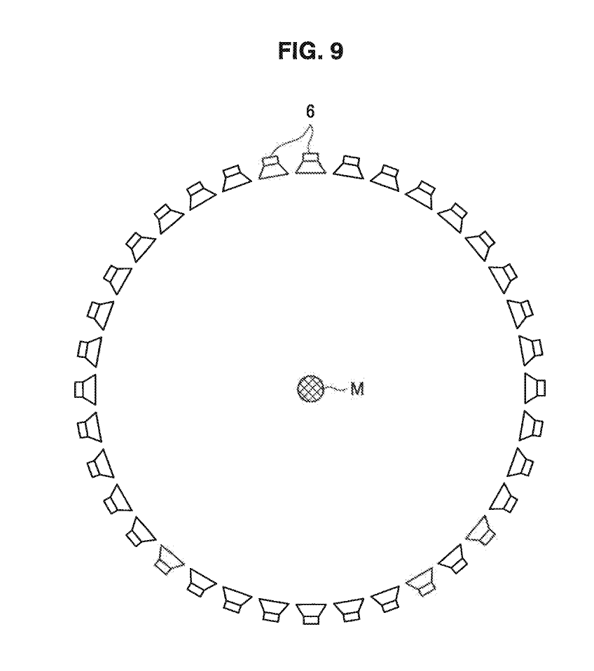

Here, with reference to FIGS. 9 to 11, a method of calculating the omnidirectional power spectrum Pₐₗₗ and the non-combination direction power spectrum Pₑₗₛₑ according to the present embodiment will be described in further detail.

As illustrated in FIG. 9, the case in which a number of speakers 6 are arranged at 10-degree intervals around the microphone M (on the circumference centered at the microphone M) and sounds are sequentially reproduced from the speakers 6 is considered. In this case, the omnidirectional spectrum Pₐₗₗ means a power spectrum including sounds arriving from all directions on a horizontal plane around the microphone M at the equal signal level as illustrated in FIG. 1 OA.

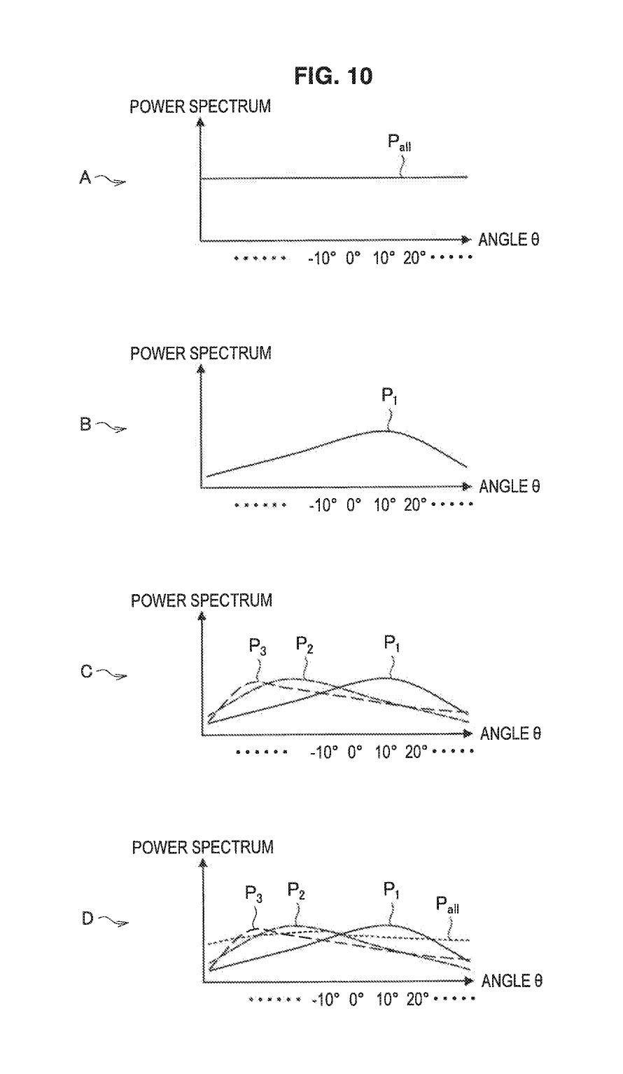

However, as illustrated in FIG. 5A of the above description, the sounds from all the directions are not input at an equal level for the microphone M when the obstacle such as the housing 4 is located at the microphone M. Because of this, sound of a specific direction in which the housing 4 is not located is input at a strong signal level without being attenuated, but sound of another specific direction in which the housing 4 is located is attenuated and input at a weak signal level. FIG. 10B illustrates the power spectrum P₁ of the input audio signal x₁ of the front surface microphone M₁, and the power spectrum P₁ increases/decreases according to a sound arrival direction θ.

As a result, a difference in input characteristics S occurs between microphones M arranged on one side and the other side of the obstacle such as the housing 4 (see FIG. 5B). The input characteristics S of such microphones M are determined by the arrangement of the microphones M for the housing 4 and differ for every microphone M. Because of this, as illustrated in FIG. 10C, the power spectrum P₁ of the front surface microphone M₁, the power spectrum P₂ of the front surface microphone M₂, and the power spectrum P₃ of the rear surface microphone M₃ have different waveforms.

Therefore, as illustrated in FIG. 10D, the omnidirectional spectrum Pₐₗₗ including sounds arriving from all the directions (θ=0 to 360 degrees) as equally as possible is generated by appropriately weighting the power spectra P₁, P₂, and P₃ obtained by the existing microphones M₁, M₂, and M₃ to perform combination. This combining process of Pₐₗₗ, for example, is implemented by weighting addition of the power spectra P₁, P₂, and P₃ using the weighting coefficients g₁, g₂, and g₃ as shown in the following Formula (10).

Pₐₗₗ=g₁·P₁+g₂·P₂+g₃·P₃ (10)

Hereinafter, a technique of calculating the weighting coefficient g to be used in the weighting addition will be described. Also, because Pₐₗₗ is calculated in the power spectrum domain of audio spectra (complex spectra) obtained by performing frequency conversion on the input audio signals x₁, x₂, and X₃, the calculation is considered by focusing on a certain frequency k among all frequency bands of audio spectra.

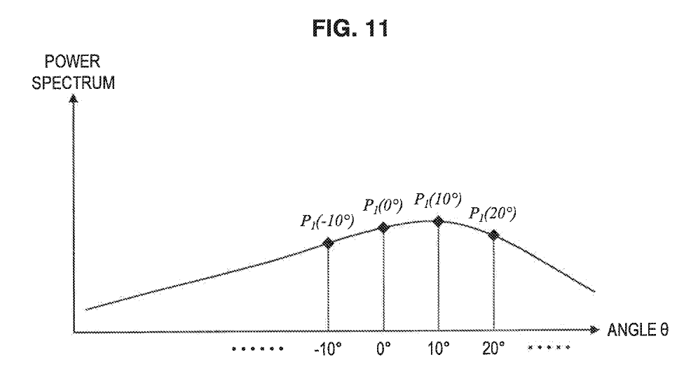

When a certain microphone M₁ has input characteristics as illustrated in FIG. 11 according to the sound arrival direction θ, the power spectrum representing the input characteristics of the microphone M₁ is represented by “P₁(θ).” Likewise, power spectra representing the input characteristics of the other microphones M₂, M₃, . . . , M_{M} are represented by “P₂(θ),” “P₃(θ),” . . . , “P_{M}(θ)”.

Here, the omnidirectional power spectrum Pₐₗₗ(θ) is combined by performing weighting addition on the power spectra P₁(θ), P₂(θ), . . . , P_{M}(θ) of the M microphones M₁, M₂, . . . , M_{M} using the weighting coefficients g₁, g₂, . . . , g_{M}. This weighting addition is represented by the following Formula (II).

Pₐₗₗ(θ)=g₁·P₁(θ)+g₂·P₂(θ)+ . . . +g_{M}·P_{M}(θ) (11)

Here, the omnidirectional power spectrum Pₐₗₗ(θ) is obtained to be the same as the value Pv for all θ as shown in the following Formula (12). Also, θ₁, θ₂, . . . , θₙ represent 0 degrees, 10 degrees, and the like illustrated in FIG. 11 and are angles obtained by dividing 360 degrees by n.

Pv=Pₐₗₗ(θ₁)=g₁·P₁(θ₁)+g₂P₂(θ₁)+ . . . +g_{M}·P_{M}(θ₁)

Pv=Pₐₗₗ(θ₂)=g₁·P₁(θ₂)+g₂·P₂(θ₂)+ . . . +g_{M}·P_{M}(θ₂)

. . .

Pv=Pₐₗₗ(θₙ)=g₁·P₁(θₙ)+g₂·P₂(θₙ)+ . . . +g_{M}·P_{M}(θₙ) (12)

Then, when equations of the above-described Formulas (12) are represented by a matrix, the following Formula (13) is given. By obtaining the solution of the following Formula (13), it is possible to obtain the weighting coefficients g₁, g₂, . . . , g_{M}. The coefficients g₁, g₂, . . . , g_{M} are determined according to the arrangement of the microphones M₁, M₂, . . . , M_{M} for the housing 4, and preset by a developer in a design stage of the sound recording device.

$$\begin{matrix}[ Math . 1 ] & \\ ( \begin{matrix}Pv \\ Pv \\ ⋮ \\ Pv\end{matrix} ) = ( \begin{matrix}{P}_{1} ( {θ}_{1} ) & {P}_{2} ( {θ}_{1} ) & … & {P}_{M} ( {θ}_{1} ) \\ {P}_{1} ( {θ}_{2} ) & {P}_{2} ( {θ}_{2} ) & … & {P}_{M} ( {θ}_{2} ) \\ ⋮ & ⋮ & ⋱ & ⋮ \\ {P}_{1} ( {θ}_{n} ) & {P}_{2} ( {θ}_{n} ) & … & {P}_{M} ( {θ}_{n} )\end{matrix} ) \cdot ( \begin{matrix}{g}_{1} \\ {g}_{2} \\ ⋮ \\ {g}_{M}\end{matrix} ) & ( 13 )\end{matrix}$$

Next, a method of calculating weighting coefficients f for obtaining the non-combination direction power spectrum Pₑₗₛₑ will be described. As in the above description and the omnidirectional power spectrum Pₐₗₗ(θ), the non-combination direction power spectrum Pₑₗₛₑ(θ) is combined by performing weighting addition on the power spectra P₁(θ), P₂(θ), . . . , P_{M}(θ) of the M microphones M₁, M₂, . . . , M_{M} using the weighting coefficients f₁, f₂, . . . , f_{M}. This weighting addition is represented by the following Formula (14).

Pₑₗₛₑ(θ)=f₁·P₁(θ)+f₂·P₂(θ)+ . . . +f_{M}·P_{M}(θ) (14)

Here, as shown in the following Formula (15), the non-combination direction power spectrum Pₑₗₛₑ(θ) is obtained to be zero for a combination direction θₘ, to be a smaller value Pv′ than Pv for angles θₘ₋₁ and θₘ₊₁ before and after θₘ, and to be the same as the value Pv for θ other than these angles. For example, as illustrated in FIG. 8, when the power spectrum Pₑₗₛₑ(θ) of a non-combination direction other than the SL direction (θ=225 degrees) is obtained, it is only necessary to set Pₑₗₛₑ (θₘ=225 degrees)=0 and to set Pₑₗₛₑ(θₘ₋₁) and Pₑₗₛₑ(θₘ₊₁) of α degrees before and after 225 degrees to smaller values than Pv.

$$Pv = {P}_{else} ( {θ}_{1} ) = {f}_{1} \cdot {P}_{1} ( {θ}_{1} ) + {f}_{2} \cdot {P}_{2} ( {θ}_{1} ) + … + {f}_{M} \cdot {P}_{M} ( {θ}_{1} ) \\ Pv = {P}_{else} ( {θ}_{2} ) = {f}_{1} \cdot {P}_{1} ( {θ}_{2} ) + {f}_{2} \cdot {P}_{2} ( {θ}_{2} ) + … + {f}_{M} \cdot {P}_{M} ( {θ}_{2} ) \\ … \\ {Pv}^{′} = {P}_{else} ( {θ}_{m - 1} ) = {f}_{1} \cdot {P}_{1} ( {θ}_{m - 1} ) + {f}_{2} \cdot {P}_{2} ( {θ}_{m - 1} ) + … + {f}_{M} \cdot {P}_{M} ( {θ}_{m - 1} ) \\ 0 = {P}_{else} ( {θ}_{m} ) = {f}_{1} \cdot {P}_{1} ( {θ}_{m} ) + {f}_{2} \cdot {P}_{2} ( {θ}_{m} ) + … + {f}_{M} \cdot {P}_{M} ( {θ}_{m} ) \\ {Pv}^{′} = {P}_{else} ( {θ}_{m + 1} ) = {f}_{1} \cdot {P}_{1} ( {θ}_{m + 1} ) + {f}_{2} \cdot {P}_{2} ( {θ}_{m + 1} ) + … + {f}_{M} \cdot {P}_{M} ( {θ}_{m + 1} ) \\ … \\ Pv = {P}_{else} ( {θ}_{n} ) = {f}_{1} \cdot {P}_{1} ( {θ}_{n} ) + {f}_{2} \cdot {P}_{2} ( {θ}_{n} ) + … + {f}_{M} \cdot {P}_{M} ( {θ}_{n} ) \qquad ( 15 )$$

Then, it is possible to obtain the weighting coefficients f₁, f₂, . . . , f_{M} by obtaining a solution of Formula (16) obtained by representing equations of the above-described Formulas (15) in a matrix. The coefficients f₁, f₂, . . . , f_{M} are also determined according to the arrangement of the microphones M₁, M₂, . . . , M_{M} for the housing 4, and preset by the developer in the design stage of the sound recording device.

$$\begin{matrix}[ Math . 2 ] & \\ ( \begin{matrix}Pv \\ Pv \\ ⋮ \\ {Pv}^{′} \\ 0 \\ {Pv}^{′} \\ ⋮ \\ Pv\end{matrix} ) = ( \begin{matrix}{P}_{1} ( {θ}_{1} ) & {P}_{2} ( {θ}_{1} ) & … & {P}_{M} ( {θ}_{1} ) \\ {P}_{1} ( {θ}_{2} ) & {P}_{2} ( {θ}_{2} ) & … & {P}_{M} ( {θ}_{2} ) \\ ⋮ & ⋮ & & ⋮ \\ {P}_{1} ( {θ}_{m - 1} ) & {P}_{2} ( {θ}_{m - 1} ) & & {P}_{M} ( {θ}_{m - 1} ) \\ {P}_{1} ( {θ}_{m} ) & {P}_{2} ( {θ}_{m} ) & ⋱ & {P}_{M} ( {θ}_{m} ) \\ {P}_{1} ( {θ}_{m + 1} ) & {P}_{2} ( {θ}_{m + 1} ) & & {P}_{M} ( {θ}_{m + 1} ) \\ ⋮ & ⋮ & & ⋮ \\ {P}_{1} ( {θ}_{n} ) & {P}_{2} ( {θ}_{n} ) & … & {P}_{M} ( {θ}_{n} )\end{matrix} ) \cdot ( \begin{matrix}{f}_{1} \\ {f}_{2} \\ ⋮ \\ {f}_{m - 1} \\ {f}_{m} \\ {f}_{m + 1} \\ ⋮ \\ {f}_{M}\end{matrix} ) & ( 16 )\end{matrix}$$

### 1.4 Configuration of Audio Signal Processing Device

### [1.4.1. Hardware Configuration of Audio Signal Processing Device]

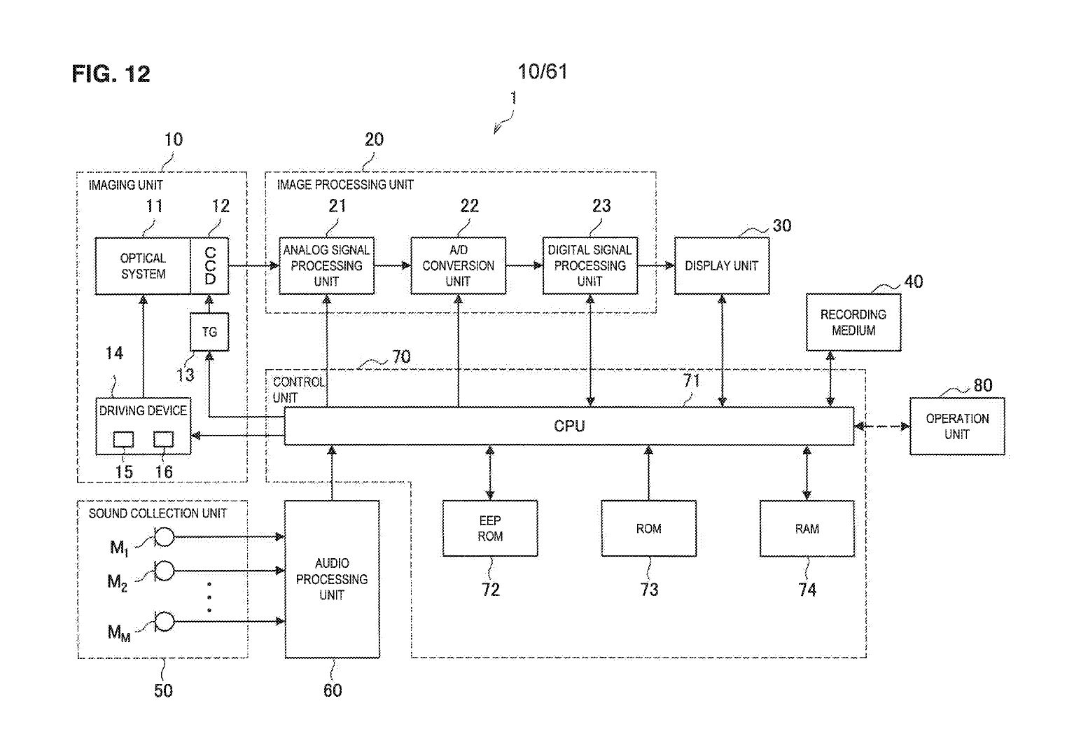

First, with reference to FIG. 12, a hardware configuration of a digital camera to which an audio signal processing device according to the present embodiment is applied will be described. FIG. 12 is a block diagram illustrating a hardware configuration of the audio signal processing device according to the present embodiment.

The digital camera 1 according to the present embodiment is, for example, an imaging device that can record a moving image and a sound when capturing the moving image. The digital camera 1 images a subject, converts a captured image (which may be a still image or a moving image) obtained from the imaging into digital image data, and records the data on a recording medium together with a sound.

As illustrated in FIG. 12, the digital camera 1 according to the present embodiment broadly has an imaging unit 10, an image processing unit 20, a display unit 30, a recording medium 40, a sound collection unit 50, an audio processing unit 60, a control unit 70, and an operation unit 80.

The imaging unit 10 images a subject and outputs an analog image signal indicating the captured image. The imaging unit 10 includes an imaging optical system 11, an image sensor 12, a timing generator 13, and a driving device 14.

The imaging optical system 11 is constituted of optical components including various lenses such as a focus lens, a zoom lens, and a correction lens, an optical filter that removes unnecessary wavelengths, a shutter, a diaphragm, and the like. An optical image (subject image) incident from a subject is formed on an exposure face of the image sensor 12 via the optical components of the imaging optical system 11. The image sensor 12 is constituted of a solid-state image sensor, for example, a charge coupled device (CCD), a complementary metal oxide semiconductor (CMOS), or the like. The image sensor 12 performs photoelectric conversion on the optical image guided from the imaging optical system 11, and outputs electric signals (analog image signals) indicating the captured image.

The imaging optical system 11 is mechanically connected to the driving device 14 that drives the optical components of the imaging optical system 11. The driving device 14 includes, for example, a zoom motor 15, a focus motor 16, a diaphragm adjustment mechanism (not illustrated), and the like. The driving device 14 drives the optical components of the imaging optical system 11 according to instructions of the control unit 70 to be described later so as to move the zoom lens and the focus lens, or to adjust the diaphragm. For example, the zoom motor 15 performs a zoom operation of adjusting an angle of view by moving the zoom lens in a telephoto or wide direction. In addition, the focus motor 16 performs a focus operation of focusing on a subject by moving the focus lens.

In addition, the timing generator (TG) generates operation pulses necessary for the image sensor 12 according to instructions of the control unit 70. For example, the TG 13 generates various kinds of pulses such as four-phase pulses for vertical transfer, field shift pulses, two-phase pulses for horizontal transfer, and shutter pulses, and supplies the pulses to the image sensor 12. As the TG 13 drives the image sensor 12, a subject image is captured. In addition, as the TG 13 adjusts a shutter speed of the image sensor 12, an exposure amount and an exposure period of a captured image are controlled (an electric shutter function). Image signals output by the image sensor 12 are input to the image processing unit 20.

The image processing unit 20 is constituted of an electric circuit such as a micro controller, performs a predetermined image process on the image signals output from the image sensor 12, and outputs the image signals that have undergone the image process to the display unit 30 and the control unit 70. The image processing unit 20 has an analog signal processing unit 21, an analog-digital (A/D) converter 22, and a digital signal processing unit 23.

The analog signal processing unit 21 is a so-called analog front-end that performs pre-processing on the image signals. The analog signal processing unit 21 performs, for example, a correlated double sampling (CDS) process, a gain process by a programmable gain amplifier (PGA), or the like on the image signals output from the image sensor 12. The A/D converter 22 converts the analog image signals input from the analog signal processing unit 21 into digital image signals, and then outputs the signals to the digital signal processing unit 23. The digital signal processing unit 23 performs a digital signal process, for example, noise removal, white balance adjustment, color correction, edge emphasis, gamma correction, or the like on the input digital image signals, and then outputs the signals to the display unit 30 and the control unit 70.

The display unit 30 is configured as a display device, for example, a liquid crystal display (LCD), an organic EL display, or the like. The display unit 30 displays various kinds of input image data according to control of the control unit 70. For example, the display unit 30 displays captured images (through images) input from the image processing unit 20 in real-time during imaging. Accordingly, a user can operate the digital camera 1 while viewing the through image being captured by the digital camera 1. In addition, when a captured image recorded on the recording medium 40 is reproduced, the display unit 30 displays the reproduced image. Accordingly, a user can recognize content of the captured image recorded on the recording medium 40.

The recording medium 40 records various kinds of data such as captured image data and metadata of the data thereon. For the recording medium 40, for example, a semiconductor memory such as a memory card, or a disc-type recording medium such as an optical disc, or a hard disk can be used. The optical disc includes, for example, a Blu-ray disc, a digital versatile disc (DVD), a compact disc (CD), and the like. The recording medium 40 may be built in the digital camera 1, or may be a removable medium that can be loaded or unloaded on the digital camera 1.

The sound collection unit 50 collects external audio around the digital camera 1. The sound collection unit 50 according to the present embodiment is constituted of the M microphones M₁, M₂, . . . , M_{M} (which may also be collectively referred to hereinafter as a “microphone M”). M is an integer greater than or equal to 3. Directivity combining according to the present embodiment can be implemented by providing three or more microphones. Although the microphone M may be a non-directional microphone or a directional microphone, an example of the non-directional microphone will be described below. In addition, the microphone M may be a microphone (for example, a stereo microphone) for collecting external audio or a microphone for a telephone call provided in a smartphone or the like.

Although these microphones M are installed on the same housing 4 of the digital camera 1, the microphones M may be arranged at arbitrary positions of the housing 4 without having to be arranged symmetrically and adjacent (for example, in an adjacent arrangement at positions of vertices of an equilateral triangle, a square, or the like) as disclosed in the above-described Patent Literatures 1 and 2. In this manner, in the present embodiment, the degree of freedom of the arrangement of the microphones M is high. The above-described microphones M output input audio signals obtained by collecting the sound of external audio. This sound collection unit 50 is configured to collect the sound of external audio during moving-image capturing and record the collected sound along with a moving image.

The audio processing unit 60 is constituted of an electronic circuit such as a micro controller, performs a predetermined sound process on audio signals, and outputs audio signals for recording. The sound process includes, for example, an A/D conversion process, a noise reduction process, and the like. The present embodiment is characterized in that the directivity combining process is performed by the audio processing unit 60, and detailed description thereof will be provided later.

The control unit 70 is constituted of an electric circuit such as a micro controller, and controls overall operations of the digital camera 1. The control unit 70 includes, for example, a CPU 71, an electrically erasable programmable ROM (EEPROM) 72, a read only memory (ROM) 73, and a random access memory (RAM) 74. The control unit 70 controls each of the units inside the digital camera 1.

The ROM 73 of the control unit 70 stores programs that cause the CPU 71 to execute various control processes. The CPU 71 operates based on the programs and executes arithmetic operations and control processes necessary for various kinds of control while using the RAM 74. The programs can be stored in advance in memory devices (for example, the EEPROM 72, the ROM 73, and the like) installed in the digital camera 1. In addition, the programs may be provided to the digital camera 1 by being stored in a removable medium such as a disk-like recording medium, or a memory card, or may be downloaded in the digital camera 1 via a network such as a LAN, or the Internet.

Here, a specific example of control of the control unit 70 will be described. The control unit 70 controls the TG 13 and the driving device 14 of the imaging unit 10 to control imaging processes performed by the imaging unit 10. For example, the control unit 70 performs automatic exposure control (an AE function) by adjusting the diaphragm of the imaging optical system 11, setting an electronic shutter speed of the image sensor 12, setting a gain of the AGC of the analog signal processing unit 21, and the like. In addition, the control unit 70 performs auto focus control (an AF function) for automatically focusing the imaging optical system 11 on a specific subject by moving the focus lens of the imaging optical system 11 and thereby changing a focus position. Furthermore, the control unit 70 adjusts an angle of view of a captured image by moving the zoom lens of the imaging optical system 11 and thereby changing a zoom position. Moreover, the control unit 70 causes various kinds of data such as captured images, metadata, and the like to be recorded on the recording medium 40, and causes data recorded on the recording medium 40 to be read and reproduced. In addition, the control unit 70 causes various display images for being displayed on the display unit 30 to be generated, and controls the display unit 30 to display the display images. In addition, the control unit 70 controls the operation of the audio processing unit 60 so as to reduce noise from audio signals collected by L and 51R.

The operation unit 80 and the display unit 30 function as user interfaces that enable a user to operate the digital camera 1. The operation unit 80 is constituted of various operation keys such as buttons or levers, or a touch panel, and includes, for example, a zoom button, a shutter button, a power button, and the like. The operation unit 80 outputs instruction information for instructing various imaging operations to the control unit 70 according to user operations.

### [1.4.2. Functional Configuration of Audio Signal Processing Device]

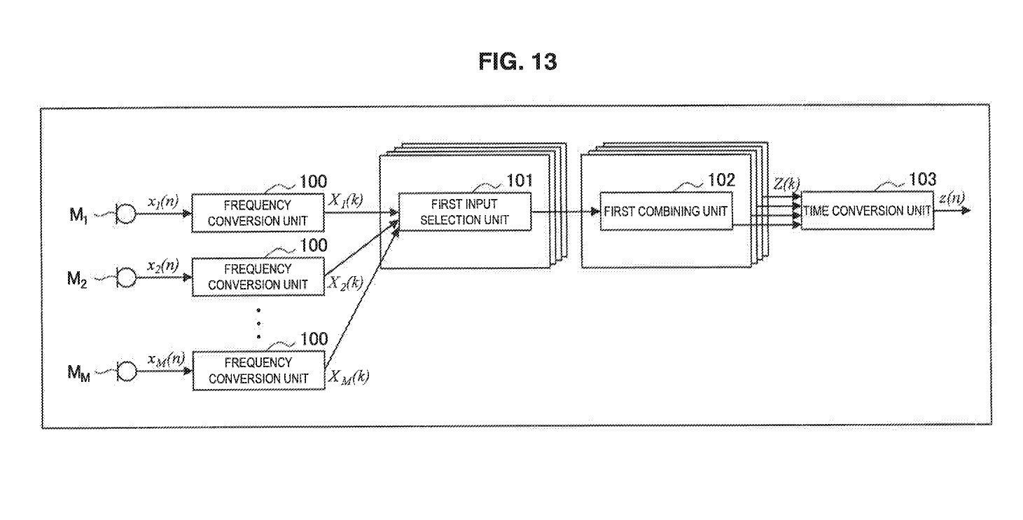

Next, with reference to FIG. 13, a functional configuration example of an audio signal processing device applied to the digital camera 1 according to the present embodiment will be described. FIG. 13 is a block diagram illustrating a functional configuration of the audio signal processing device according to the embodiment.

As illustrated in FIG. 13, the audio signal processing device according to the present embodiment includes M microphones M₁, M₂, . . . , M_{M}, M frequency conversion units 100, first input selection units 101, first combining units 102, and a time conversion unit 103. Among these, the frequency conversion units 100, the first input selection units 101, the first combining units 102, and the time conversion unit 103 constitute the above-described audio processing unit 60 of FIG. 12. Each part of the audio processing unit 60 may be constituted of dedicated hardware or software. When the software is used, it is only necessary for a processor provided in the audio processing unit 60 to execute a program for implementing a function of each functional unit to be described below.

The microphone M is constituted of a non-directional microphone as described above, and used to perform surround sound recording on audio signals of multiple channels such as 5.1 ch or 7.1 ch. The microphones M₁, M₂, . . . , M_{M} collect sound (external audio) around the digital camera 1 and generate and output input audio signals x₁(n), x₂(n), . . . , x_{M}(n). Hereinafter, input audio signals x₁(n), x₂(n), . . . , x_{M}(n) may be collectively referred to as an “input audio signal x” or “audio signal x.” The input audio signal x(n) is a time domain signal, and represents a time waveform value (time-series waveform data itself) of sound collected by the microphone M.

The frequency conversion unit 100 is provided in correspondence with each of the M microphones M₁, M₂, . . . , M_{M}. The frequency conversion units 100 convert input audio signals x of the time domain into input audio spectra X₁(k), X₂(k), . . . , X_{M}(k) of the frequency domain in units of frames. Here, the input audio spectrum x represents a frequency spectrum value (complex spectrum), n represents a time index, and k represents a frequency index. Hereinafter, the input audio spectra X₁(k), X₂(k), . . . , X_{M}(k) may be collectively referred to as an “input audio spectrum X” or “audio spectrum X.”

Each frequency conversion unit 100 generates an input audio spectrum X(k) by dividing the input audio signal x(n) input from each microphone M in units of frames of a predetermined time and performing Fourier conversion (for example, a fast Fourier transform (FFT)) on the divided audio signal x(n). At this time, for example, it is desirable for the frequency conversion unit 100 to perform frequency conversion at every 20 to 30 ms so as to follow time variation of the input audio signal x.

The first input selection unit 101 selects input audio spectra X(k) of a combination target by the first combining unit 102 from among the M input audio spectra X₁(k), X₂(k), . . . , X_{M}(k) input from the frequency conversion units 100. Here, the input audio spectra X(k) of the combination target is a plurality of input audio spectra necessary to combine an audio signal (hereinafter referred to as a “combined audio signal of a specific channel”) having directivity of a combination direction (first combination direction) corresponding to the specific channel of the surround reproduction environment. The first input selection unit 101 selects the input audio spectra X(k) of the combination target based on the arrangement of the M microphones for the housing 4 of the digital camera 1.

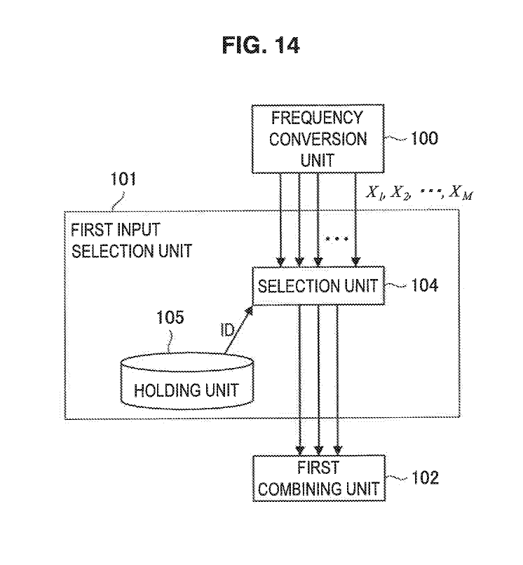

Here, with reference to FIG. 14, the configuration of the first input selection unit 101 according to the present embodiment will be described in detail. FIG. 14 is a block diagram illustrating the configuration of the first input selection unit 101 according to the present embodiment. As illustrated in FIG. 14, the first input selection unit 101 includes a selection unit 104 and a holding unit 105.

The holding unit 105 associates and holds identification information of specific channels (for example, L, R, SL, SR, and the like) of the surround reproduction environment and identification information of microphones M necessary to combine combined audio signals of the specific channels. Here, the identification information of the microphones M is an ID sequence including identification IDs (for example, microphone numbers) representing a plurality of microphones M necessary for the combination. The microphone M necessary for the combination is predetermined by the developer for every channel and every frequency band of the surround reproduction environment and the identification ID of the determined microphone M is held in the holding unit 105.

The selection unit 104 selects input audio spectra X of at least two combination targets from the M input audio spectra X input from the frequency conversion unit 100 based on the arrangement of the M microphones M for the housing 4. At this time, the selection unit 104 selects microphones M necessary to combine a combined audio signal of a specific channel by the first combining unit 102 of the rear stage by referring to the identification information of the microphones M held in the holding unit 105, and selects input audio spectra X corresponding to the selected microphones M. Thereby, the selection unit 104 selects only input audio spectra X corresponding to preset microphones M for every channel and outputs the selected input audio spectra X to the first combining unit 102 of the subsequent stage. Thereby, it is possible to extract optimum input audio spectra X for directivity combining of a desired channel.

For example, when three microphones M₁, M₂, and M₃ are necessary to combine a combined audio signal of the SL direction, the holding unit 105 holds IDs of the microphones M₁, M₂, and M₃ in association with the SL channel. The selection unit 104 selects input audio spectra X₁, X₂, and X₃ corresponding to the microphones M₁, M₂, and M₃ from among the M input audio spectra X₁, X₂, . . . , X_{M} based on the IDs of the microphones M₁, M₂, and M₃ read from the holding unit 105. The selection unit 104 outputs the selected input audio spectra X to the first combining unit 102 of the subsequent stage.

The first combining unit 102 generates a combined audio spectrum Z(k) having directivity of the combination direction (first combination direction) of the above-described specific channel by combining power spectra P of the plurality of input audio spectra X selected by the above-described first input selection unit 101. In this manner, the first combining unit 102 performs a directivity combining process in the power spectrum domain.

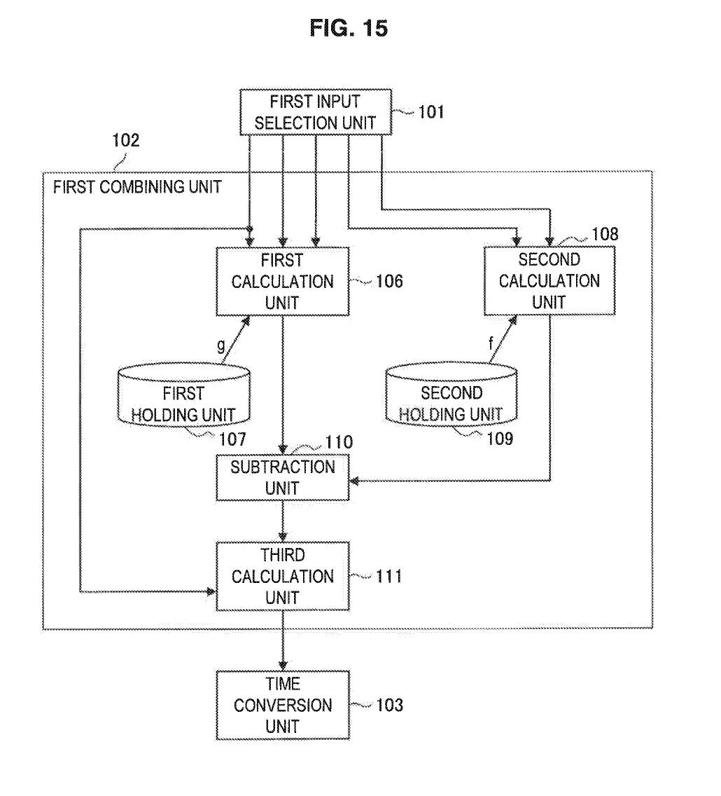

Here, with reference to FIG. 15, a configuration of the first combining unit 102 according to the present embodiment will be described in detail. FIG. 15 is a block diagram illustrating the configuration of the first combining unit 102 according to the present embodiment.

As illustrated in FIG. 15, the first combining unit 102 includes a first calculation unit 106, a first holding unit 107, a second calculation unit 108, a second holding unit 109, a subtraction unit 110, and a third calculation unit 111.

The first holding unit 107 holds weighting coefficients g₁, g₂, . . . , g_{M} (first weighting coefficients) for calculating the above-described omnidirectional power spectrum Pₐₗₗ for every combination direction. In addition, the second holding unit 109 holds weighting coefficients f₁, f₂, . . . , f_{M} (second weighting coefficients) for calculating the power spectrum Pₑₗₛₑ of a non-combination direction other than the combination direction (for example, the SL direction) of the above-described specific channel for every combination direction. The developer of the digital camera 1 presets these weighting coefficients g and f for every combination direction according to the arrangement of the microphones M₂, M₃, . . . , M_{M} for the housing 4.

The first calculation unit 106 calculates an omnidirectional power spectrum Pₐₗₗ by calculating power spectra P of a plurality of input audio spectra X selected by the first input selection unit 101 and combining the power spectra P using weighting coefficients g (see FIG. 6). For example, when the input audio spectra X₁, X₂, and X₃ are selected by the first input selection unit 101, the first calculation unit 106 calculates the omnidirectional power spectrum Pₐₗₗ by multiplying the power spectra P₁, P₂, and P₃ of the input audio spectra X₁, X₂, and X₃ by the weighting coefficients g₁, g₂, and g₃ read from the first holding unit 107 and adding the products.

The second calculation unit 108 calculates the non-combination direction power spectrum Pₑₗₛₑ by calculating the power spectra P of the plurality of input audio spectra X selected by the first input selection unit 101 and combining the power spectra P using the weighting coefficients f (see FIG. 7). For example, when the input audio spectra X₁, X₂, and X₃ are selected by the first input selection unit 101, the second calculation unit 108 calculates the non-combination direction power spectrum Pₑₗₛₑ by multiplying the power spectra P₁, P₂, and P₃ of the input audio spectra X₁, X₂, and X₃ by the weighting coefficients f₁, f₂, and f₃ read from the second holding unit 109 and adding the products.

The subtraction unit 110 generates a power spectrum P_{Z} of the combination direction (for example, SL direction) of the above-described specific channel by subtracting the non-combination direction power spectrum Pₑₗₛₑ from the above-described omnidirectional power spectrum Pₐₗₗ (see FIG. 8). The third calculation unit 111 generates a combined audio spectrum Z having directivity of the combination direction (for example, SL direction) of the above-described specific channel based on the power spectrum P_{Z}.

In this manner, the first combining unit 102 generates a combined audio spectrum Z having directivity of the combination direction (for example, SL direction) of the above-described specific channel by combining the plurality of input audio spectra X selected by the first input selection unit 101 in the power spectrum domain. The first combining unit 102 outputs the generated combined audio spectrum Z to the time conversion unit 103.

The time conversion unit 103 inversely converts the combined audio spectrum Z(k) of the frequency domain input from the first combining units 102 into an audio signal z(n) of the time domain. For example, the time conversion unit 103 generates an audio signal z_{SL}(n) in every frame unit by performing an inverse Fourier transform on a combined audio spectrum Z_{SL}(k) of the specific channel combined by the first combining units 102.

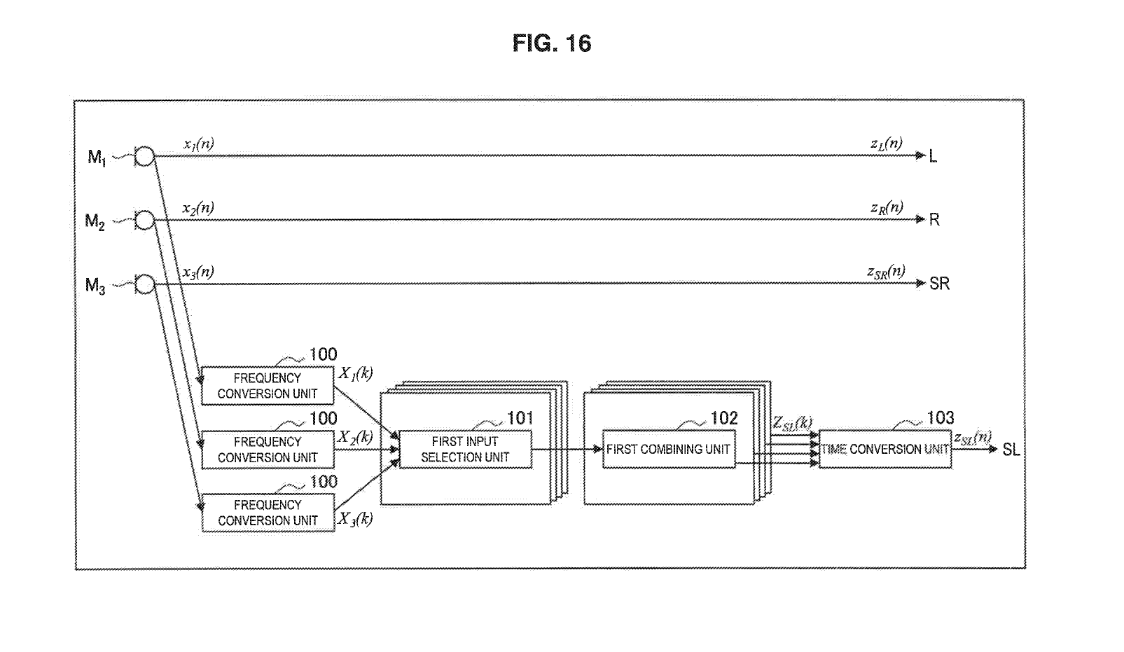

Next, with reference to FIG. 16, a specific example of a directivity combining function by the audio signal processing device according to the present embodiment will be described. FIG. 16 is a block diagram illustrating the specific example of the directivity combining function of the audio signal processing device according to the present embodiment.

FIG. 16 illustrates an example in which directivity combining of four channels L, R, SL, and SR illustrated in FIG. 5C is performed in the microphone arrangement illustrated in FIG. 5A. As described above, even when it is possible to combine the combined audio signals z_{L}, z_{R}, and z_{SR} of the L, R, and SR directions according to the conventional directivity combining technology in the case of the microphone arrangement illustrated in FIG. 5A, it is difficult to favorably combine the combined audio signal z_{SL} of the SL direction.

On the other hand, according to the present embodiment, directivity combining of the above-described power spectrum domain is performed so as to generate the combined audio signal z_{SL} of the SL direction. That is, as illustrated in FIG. 16, first, the three frequency conversion units 100 perform frequency conversions on the input audio signals x₁, x₂, and x₃ of the three microphones M₁, M₂, and M₃ to generate the input audio spectra X₁, X₂, and X₃. Then, the first input selection unit 101 selects input audio spectra X necessary for the directivity combining of the SL direction from among X₁, X₂, and X₃. In this example, the input audio spectra X₁, X₂, and X₃ of all the microphones M₁, M₂, and M₃ are selected. Further, the first combining unit 102 generates the omnidirectional power spectrum Pₐₗₗ and the non-combination direction power spectrum Pₑₗₛₑ from the input audio spectra X₁, X₂, and X₃, and generates the combined audio spectrum Z_{SL} (complex spectrum) of the SL direction from a difference between the two power spectra. Thereafter, the time conversion unit 103 generates a combined audio signal z_{SL} (time waveform) of the SL direction by performing an inverse Fourier transform on the combined audio spectra Z_{SL}.

On the other hand, in the L, R, and SR directions, as illustrated in FIG. 16, the input audio signals x₁, x₂, and x₃ of the three microphones M₁, M₂, and M₃ are output as the combined audio signals z_{L}, z_{R}, and z_{SR} of the L, R, and SR directions without change. This is because the three microphones M₁, M₂, and M₃ have directivity of the L, R, and SR directions, respectively, due to an influence of the housing 4 as illustrated in FIG. 5 because it is not particularly necessary to perform a combining process of a relevant direction.

As described above, according to the present embodiment, it is possible to output the combined audio signals z_{L}, z_{R}, z_{SL}, and z_{SR} of the four channels using the input audio signals x₁, x₂, and x₃ of the three microphones M₁, M₂, and M₃. In particular, there is an advantageous effect in that it is possible to favorably combine the combined audio signal z_{SL} of the SL direction which was difficult combine favorably in the past.

### 1.5 Audio Signal Processing Method

Next, an audio signal processing method (directivity combining method) according to the audio signal processing device according to the present embodiment will be described.

### [1.5.1. Overall Operation of Audio Signal Processing Device]

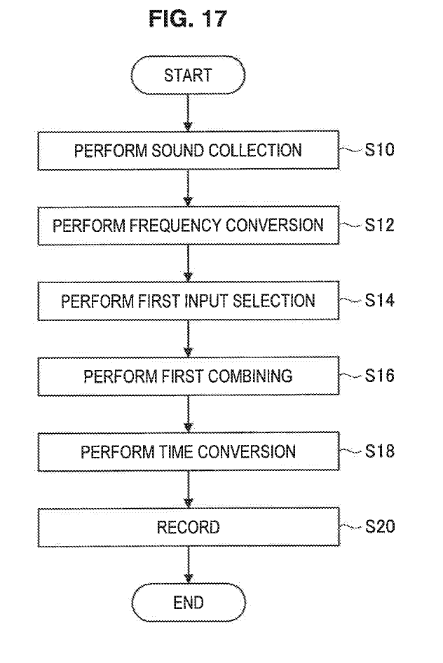

First, with reference to FIG. 17, the overall operation of the audio signal processing device according to the present embodiment will be described. FIG. 17 is a flowchart illustrating an audio signal processing method according to the present embodiment.

The audio signal processing device divides audio signals x₁, x₂, . . . , x_{M} input from the M microphones M₁, M₂, . . . , M_{M} into a plurality of frames and performs a directivity combining process in units of frames.

As illustrated in FIG. 17, first, the microphones M₁, M₂, . . . , M_{M} collect sound (external audio) around the digital camera 1, and generate the input audio signals x₁, x₂, . . . , X_{M} (S10).

Then, the frequency conversion units 100 perform frequency conversions (for example, FFTs) on the input audio signals x₁, x₂, . . . , x_{M} from the microphones M₁, M₂, . . . , M_{M}, and generate input audio spectra X₁, X₂, . . . , X_{M} (S12). This frequency conversion process is performed in a frame unit of the audio signal x. That is, when the input audio signal x(n) of an n^{th} frame is input, the frequency conversion unit 100 performs a Fourier transform on the audio signal x(n) and outputs an input audio spectrum X(k) of the n^{th} frame for every frequency component k. The frequency component X(k) of the input audio spectrum is obtained by dividing X into predetermined frequency bands.

Then, the first input selection unit 101 selects a plurality of input audio spectra X necessary to combine a desired specific channel from the input audio spectra X₁, X₂, . . . , X_{M} obtained in S12 (S14). Further, the first combining unit 102 generates a combined audio spectrum Z(k) of the specific channel by combining power spectra P of the input audio spectra X selected in S14 (S16). This combining process is also performed for every frequency component k of the input audio spectrum X(k) (k=0, 1, . . . , L−1).

Thereafter, the time conversion unit 103 generates the combined audio signal z(n) by performing time conversion (for example, inverse FFT) on the combined audio spectrum Z(k) combined in S16 (S18). Further, the control unit 70 of the digital camera 1 records the combined audio signal z(n) on the recording medium 40 (S20). At this time, along with the combined audio signal z(n) of the above-described specific channel, a combined audio signal z(n) of another channel or a moving image may also be recorded on the recording medium 40.

### [1.5.2. Operation of First Input Selection Unit]

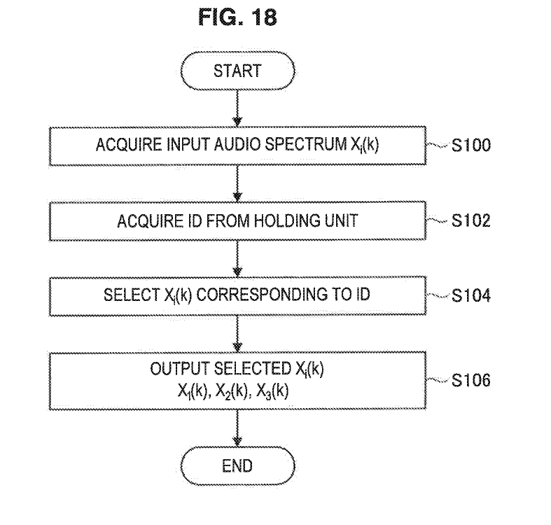

Next, with reference to FIG. 18, the operation (the first input selection process S14 of FIG. 15) of the first input selection unit 101 according to the present embodiment will be described. FIG. 18 is a flowchart illustrating the operation of the first input selection unit 101 according to the present embodiment. Also, a k^{th} frequency component x(k) of the input audio spectrum X will be described below, wherein frequency components up to k=0, 1, . . . , L−1 are present and all the frequency components are similarly processed.

As illustrated in FIG. 18, first, the first input selection unit 101 acquires the M input audio spectra x₁(k), x₂(k), . . . , x_{M}(k) output from the frequency conversion units 100 (S100).

Then, the first input selection unit 101 acquires an ID sequence from the holding unit 105 (S102). As described above, the ID sequence is identification information (for example, microphone numbers) of the microphones M necessary to combine the combined audio signal of the specific channel. The ID sequence is preset according to the arrangement of the microphones M₁, M₂, . . . , M_{M} for every channel of the surround reproduction environment. The first input selection unit 101 can determine the input audio spectrum Xᵢ(k) to be selected next in S104.

Further, the first input selection unit 101 selects some or all input audio spectra Xᵢ(k) from among the input audio spectra X₁(k), X₂(k), . . . , X_{M}(k) acquired in S100 based on the ID sequence acquired in S102 (S104). Here, the selected Xᵢ(k) is an audio spectrum necessary to combine the combined audio signal of the specific channel, and corresponds to an input audio spectrum output from the microphone M designated in the above-described ID sequence.

For example, in the example of FIG. 5, the three microphones M t, M₂, and M₃ are installed and the input audio spectra X₁(k), X₂(k), and X₃(k) of all the microphones M₁, M₂, and M₃ are necessary to combine the combined audio signal z_{SL} of the SL direction. In this case, in the ID sequence, IDs (for example, ID=1, 2, and 3) of all the three microphones M₁, M₂, and M₃ are described. Because of this, in S104, the first input selection unit 101 selects all of X₁(k), X₂(k), and X₃(k).

Thereafter, the first input selection unit 101 outputs the input audio spectrum Xᵢ(k) selected in S104 to the first combining unit 102 of the subsequent stage (S106).

### [1.5.3. Operation of First Combining Unit]

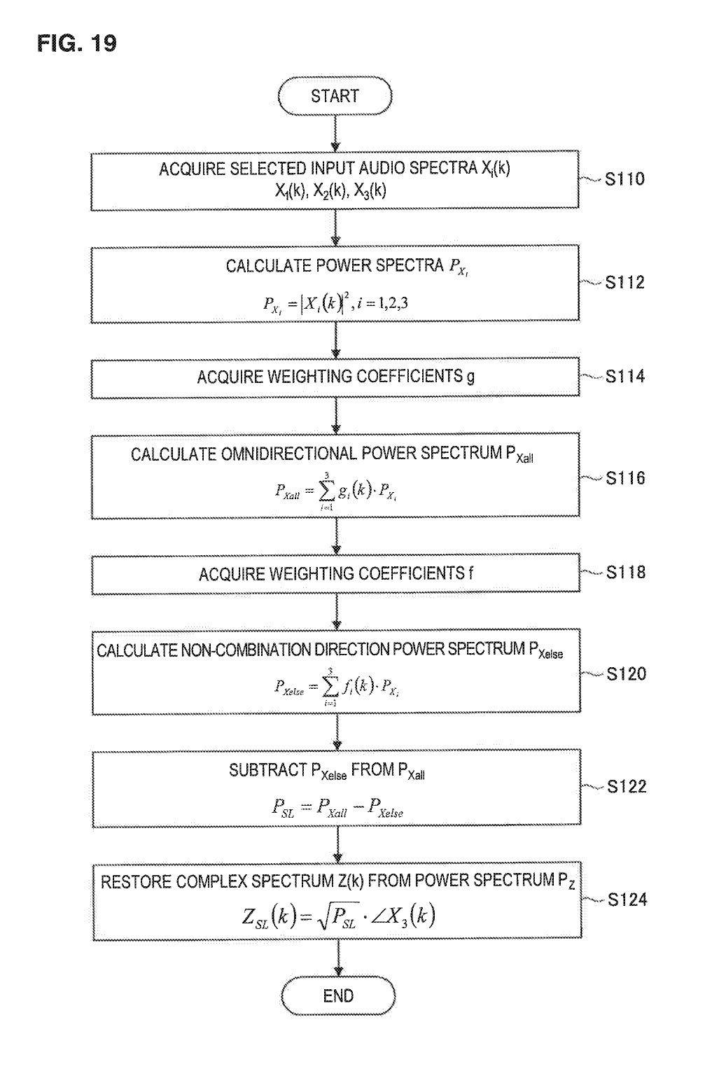

Next, with reference to FIG. 19, the operation (the first combining process S16 of FIG. 15) of the first combining unit 102 according to the present embodiment will be described. FIG. 19 is a flowchart illustrating the operation of the first combining unit 102 according to the present embodiment. Also, a k^{th} frequency component x(k) of the input audio spectrum X will be described below, wherein frequency components up to k=0, 1, . . . , L−1 are present and all the frequency components are similarly processed.

First, the first combining unit 102 acquires a plurality of input audio spectra Xᵢ(k) selected by the above-described first input selection unit 101 as the audio spectra of the combination target (S110). For example, in the case of the microphone arrangement of FIG. 5, the input audio spectra Xᵢ(k) of the combination target are the input audio spectra X₁(k), X₂(k), and X₃(k) of all the microphones M₁, M₂, and M₃.

Then, the first combining unit 102 calculates power spectra P_{Xi}(k) of the input audio spectra Xᵢ(k) acquired in S110 (S112). Because X is a complex spectrum (X=a+j·b), it is possible to calculate P_{X} from X (P_{X}=a²+b²). For example, in the microphone arrangement of FIG. 5, power spectra P_{X1}, P_{X2}, and P_{X3} are calculated.

Further, the first combining unit 102 acquires a weighting coefficient gᵢ by which each power spectrum P_{Xi} is multiplied to obtain the omnidirectional power spectrum P_{Xall} from the first holding unit 107 (S114). As described above, the first holding unit 107 holds weighting coefficients gᵢ according to the microphone arrangement for every specific channel of the combination target. Therefore, the first combining unit 102 reads the weighting coefficients gᵢ corresponding to the specific channel of the combination target from the first holding unit 107.

Thereafter, the first combining unit 102 calculates the omnidirectional power spectrum P_{Xall} by performing weighting addition on the power spectra P_{Xi} calculated in S112 using the weighting coefficients gᵢ acquired in S114 (S116). For example, in the case of the microphone arrangement of FIG. 5, the power spectrum P_{Xall} is calculated in the following Formula (17) (see FIG. 6).

P_{Xall}=g₁·P_{X1}+g₂·P_{X2}+g₃·P_{X3} (17)

Then, the first combining unit 102 acquires the weighting coefficient fᵢ by which each power spectrum P_{Xi} is multiplied to obtain the non-combination direction power spectrum P_{Xelse} from the second holding unit 109 (S118). As described above, the second holding unit 109 holds weighting coefficients fᵢ corresponding to the microphone arrangement for every specific channel of the combination target. Therefore, the first combining unit 102 reads the weighting coefficients fᵢ corresponding to the specific channel of the combination target from the second holding unit 109.

Further, the first combining unit 102 calculates the non-combination direction power spectrum P_{Xelse} by performing weighting addition on the power spectra P_{Xi} calculated in S112 using the weighting coefficients f₁ acquired in S118 (S120). For example, in the case of the microphone arrangement of FIG. 5, the power spectrum P_{Xelse} of the non-combination direction other than the SL direction is calculated in the following Formula (18) (see FIG. 7).

P_{Xelse}=f₁·P_{X1}+f₂·P_{X2}+f₃·P_{X3} (18)

Thereafter, the first combining unit 102 subtracts the non-combination direction power spectrum P_{Xelse} obtained in S120 from the omnidirectional power spectrum P_{Xall} obtained in S116 (S122). Through this subtraction process, a power spectrum Pz of the specific channel (combination direction) of the combination target is obtained (Pz=P_{Xall}−P_{Xelse}). For example, in the case of the microphone arrangement of FIG. 5, the power spectrum P_{SL} of the SL direction is calculated as Pz (see FIG. 8).

Further, the first combining unit 102 restores a complex spectrum Z(k) of a relevant specific channel from the power spectrum Pz of the specific channel (combination direction) of the combination target obtained in S122 (S124). Specifically, the first combining unit 102 can restore the complex spectrum Z(k) from the power spectrum Pz by assigning a phase ∠X to a square root of Pz. This complex spectrum Z(k) corresponds to a combined audio spectrum Z of the specific channel (combination direction) of the combination target.

Here, the restoration process of S124 will be described in detail. In general, the complex spectrum X serving as the audio spectrum includes a real part and an imaginary part and is represented by X=a+b·j. When the complex spectrum X is represented from a point in view of an amplitude and a phase of an audio signal, the complex spectrum X is represented by the following Formulas (19). In Formulas (19), the amplitude is (a²+b²)^{0.5} and the phase is ∠X.

$$\begin{matrix}[ Math . 3 ] & \\ X = a + j \cdot b = \sqrt{{a}^{2} + {b}^{2}} \cdot ∠ X \\ ∠ X = {e}^{jφ} , φ = {tan}^{- 1} ( \frac{b}{a} ) & ( 19 )\end{matrix}$$

In addition, the power spectrum P is represented by the following Formula (20). As can be seen from Formula (20), it is possible to obtain the power spectrum P by calculating a sum of squares of a real part a and an imaginary part b of the complex spectrum X.

P=a²+b² (20)

Thereby, it is possible to restore the amplitude of the complex spectrum X by obtaining a square root of the power spectrum P. It is possible to restore the complex spectrum X itself if the phase is assigned to the amplitude.

In general, it is said that the restoration of the power spectrum Pₓ is important in an audio waveform or the like, and there is no significant influence on the sense of hearing of a human even when the phase is not accurate. Therefore, in the present embodiment, the complex spectrum X_{SL} of the SL direction is estimated from the power spectrum P_{SL} of the SL direction by assigning a phase ∠X₃(k) of the input audio signal x₃ of the microphone M₃ to the amplitude (a²+b²)^{0.5} obtained from the above-described P_{SL}.

### 1.6 Advantageous Effects

The audio signal processing device and method according to the first embodiment of the present disclosure have been described above in detail. According to the present embodiment, the first combining unit 102 generates a combined audio spectrum Z having directivity of a specific channel (combination direction) of the combination target by combining a plurality of input audio spectra X selected by the first input selection unit 101 in the power spectrum domain.

This combined audio spectrum Z is not favorably generated in the conventional directivity combining technology in the time domain or the complex spectrum domain of the audio signal. That is, as described above, because input characteristics S among a plurality of microphones M are different due to the arrangement of the microphones M for the housing 4, information necessary to generate the combined audio spectrum Z_{SL} of the combination direction of the specific channel, for example, the SL direction, may be insufficient (see FIGS. 3 to 5). In this case, it is difficult to appropriately generate the combined audio spectrum Z_{SL} of the SL direction even when input audio signals of a limited number of microphones M₁, M₂, and M₃ are combined in the time domain or the complex spectrum domain as in the conventional technologies.

However, according to the present embodiment, input audio spectra X necessary for directivity combining of the combination direction (for example, the SL direction) of the specific channel are selected according to the microphone arrangement and the selected input audio spectra X are combined in the power spectrum domain. Thereby, even in the microphone arrangement in which the input characteristics S among the above-described microphones M are different, it is possible to favorably generate a combined audio spectrum Z of a desired combination direction.

In this manner, according to the present embodiment, it is possible to suitably implement surround sound recording which was difficult to implement in the past due to the influence of the microphone arrangement. In other words, it is possible to perform directivity combining of a desired number of channels in a smaller number of microphones.

Further, according to the present embodiment, the microphone arrangement having a high degree of freedom is possible and the microphones M may be arranged at arbitrary positions of the housing 4 without having to symmetrically and adjacently arrange a plurality of microphones M as disclosed in the above-described Patent Literatures 1 and 2. Accordingly, because the degree of freedom of the arrangement of the microphones M for the housing 4 is high, it is possible to contribute to size reduction, design ease, and multi-functionality of a sound recording device such as the digital camera 1, a mobile phone, or a portable information terminal. In particular, because the smartphone has multiple functions such as a telephone call function and a sound recording function, a plurality of microphones are normally arranged to be separated on one side and the other side of the housing 4. Accordingly, an advantage of a high degree of freedom of the microphone arrangement according to the above-described embodiment is useful for a device such as a smartphone.

In addition, in general, distortion occurs in directivity of a combined audio signal because a space alias occurs between the microphones M when the plurality of microphones M are excessively separated. However, according to the present embodiment, it is possible to reduce an influence of the distortion according to a combining process in the power spectrum domain. In addition, thereby, a degree of freedom of the microphone arrangement is further improved because it is possible to separately arrange the microphones M.

### 2. Second Embodiment

Next, an audio signal processing device and an audio signal processing method according to the second embodiment of the present disclosure will be described. The second embodiment is characterized in that the above-described first directivity combining process is also performed using a result of a second directivity combining process in addition to the above-described input audio spectrum X. Because other functional configurations of the second embodiment are substantially the same as those of the above-described first embodiment, detailed description thereof will be omitted.

### 2.1. Outline of Second Embodiment

First, the outline of the audio signal processing device and method according to the second embodiment will be described.

As described above, when a housing 4 or the like is located among a plurality of microphones M and serves as an obstacle to sound propagation, the bias in the input characteristics of the plurality of microphones M occurs. That is, because reflection or attenuation is caused when the sound hits the obstacle, characteristics of sound input to the microphone M are different between one side and the other side of the obstacle.

However, there is a phenomenon called diffraction in sound and sound of a low-frequency band having a long wavelength tends to be diffracted. Because of this, even when there is an obstacle (such as the housing 4), a low-frequency component of sound having a sufficiently large wavelength wraps around the obstacle and is input to a microphone located behind the obstacle. According to this sound diffraction, no bias may consequently occur in the input characteristics of the microphones M.

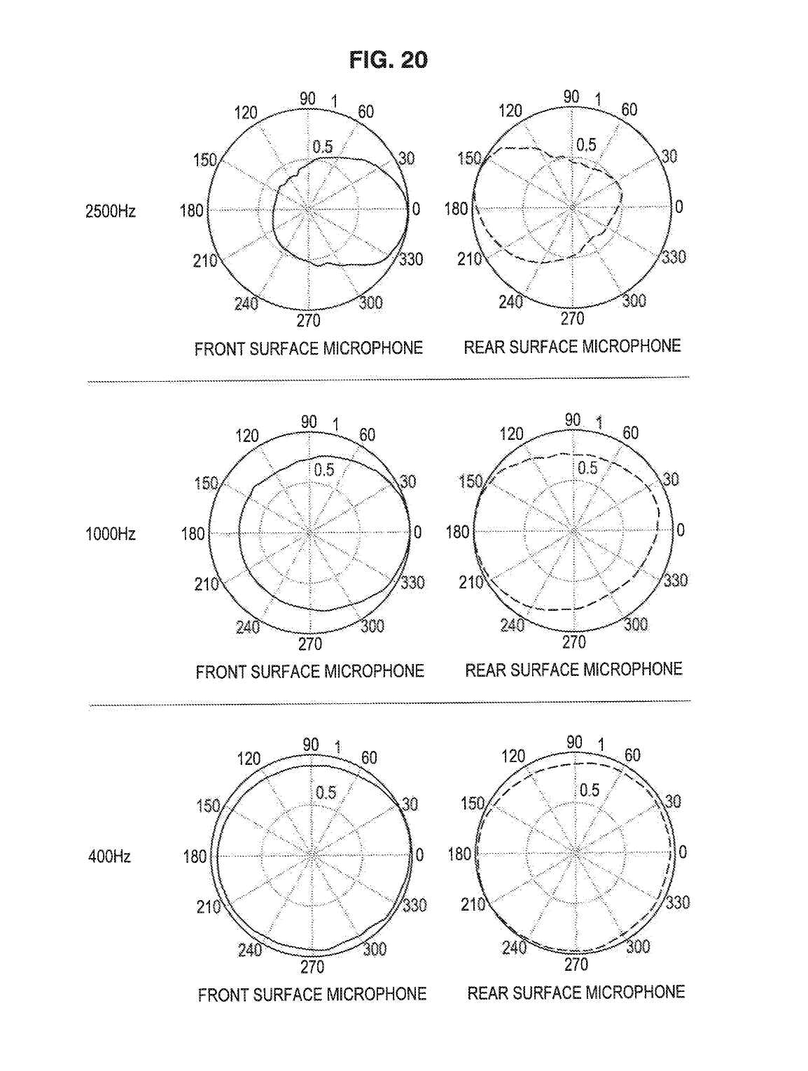

The influence of diffraction of sound by a frequency band of this sound will be described using an example of the above-described microphone arrangement illustrated in FIG. 3. FIG. 20 illustrates results of measuring input characteristics of a front surface microphone M_{F} and a rear surface microphone M_{R} when sounds of 400 Hz, 1000 Hz, and 2500 Hz are generated at every 10-degree interval from θ=0 degrees in the above-described microphone arrangement of FIG. 3.

As illustrated in FIG. 20, the input characteristics of the microphones M vary according to a frequency of sound. For example, in the high-frequency band of 2500 Hz, sound arriving from the rear is significantly attenuated and input to the front surface microphone M_{F}. Input characteristics for the rear surface microphone M_{R} of the sound arriving from the front are similar. In this manner, because the bias occurs in the input characteristics of the microphones M_{F} and M_{R} according to a sound arrival direction θ in the high-frequency band, an input characteristic difference between the microphones M_{F} and M_{R} provided on the front surface and the rear surface of the housing 4 increases.

On the other hand, as can be seen from results of an intermediate-frequency band of 1000 Hz and a low-frequency band of 400 Hz, the sound frequency is in the low-frequency band and the bias of the input characteristics of the microphone M decreases. In particular, because the sound arriving from the rear significantly diffracts in the case of the low-frequency band of 400 Hz, an amplitude similar to that of the rear surface microphone M_{R} is input to the front surface microphone M_{F} and no substantial input characteristic difference between the two microphones M_{F} and M_{R} occurs.

As described above, although the bias occurs in the input characteristics of the microphones M_{F} and M_{R} according to the sound arrival direction θ when the obstacle such as the housing 4 is located between the microphones M_{F} and M_{R} and the sound of the high-frequency band is input, the bias of the input characteristics decreases when the sound of the low-frequency band is input.

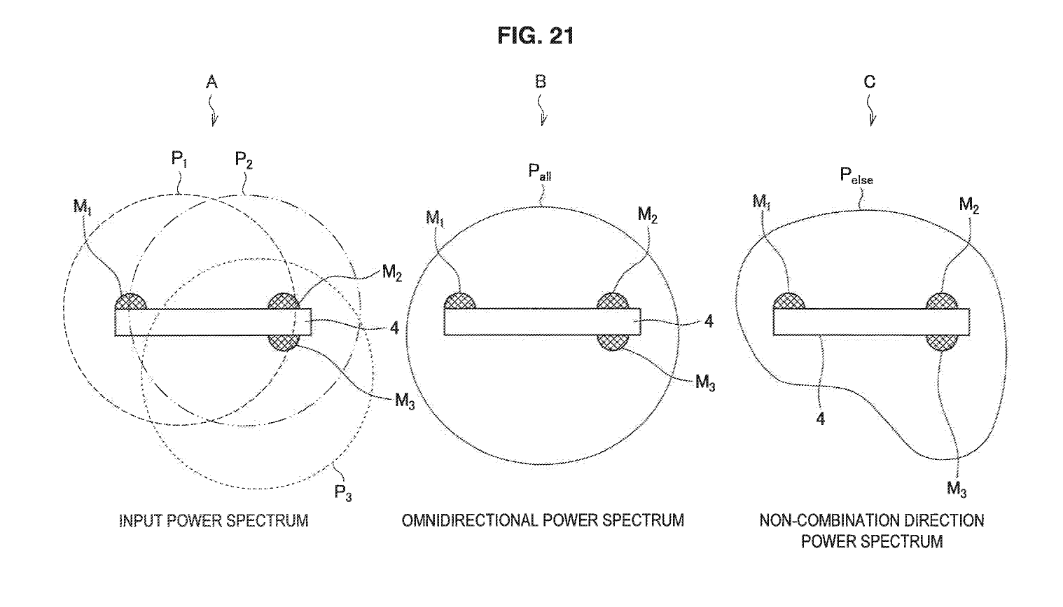

Even when input audio signals x of the plurality of microphones M are combined in the power spectrum domain when the bias of the input characteristics of the microphone M is small, it is difficult to generate a power spectrum Pₑₗₛₑ of the non-combination direction other than the SL direction as in the above-described first embodiment. The reason for this will be described with reference to FIG. 21.

FIG. 21 is a schematic diagram illustrating input characteristics when the sound of the low-frequency band (for example, 400 Hz) is input in the arrangement of the three microphones M₁, M₂, and M₃ illustrated in FIG. 5A. As described above, when the sound of the low-frequency band is input, the bias does not occur in the input characteristics of the microphones M₁, M₂, and M₃ according to a sound arrival direction θ. Because of this, even when the housing 4 is located as illustrated in FIG. 21A, the input power spectra P₁, P₂, and P₃ of the microphones M₁, M₂, and M₃ are non-directional and are configured to equally include sound components of all directions θ.

In this case, although it is possible to appropriately generate an omnidirectional power spectrum Pₐₗₗ as illustrated in FIG. 21B by combining the input power spectra P₁, P₂, and P₃ according to the method of the first embodiment, it is difficult to appropriately generate the non-combination direction power spectrum Pₑₗₛₑ as illustrated in FIG. 21C. That is, when the bias is present in the input characteristics of the microphones M₁, M₂, and M₃, it is possible to generate the power spectrum Pₑₗₛₑ of the non-combination direction other than the SL direction by performing weighting addition on P₁, P₂, and P₃ using appropriate coefficients f₁, f₂, and f₃ as illustrated in FIG. 7. However, when there is no bias in the input characteristics of the microphones M₁, M₂, and M₃ as illustrated in FIG. 21A, it is difficult to sufficiently reduce the audio component of the SL direction even when the weighting addition on P₁, P₂, and P₃ is performed and it is possible to generate only an incomplete non-combination direction power spectrum Pₑₗₛₑ as illustrated in FIG. 21C.

Therefore, a method in which the non-combination direction power spectrum Pₑₗₛₑ can be favorably generated even when the sound of the low-frequency band is input and no bias occurs in the input characteristics of the microphones M is obtained.

Incidentally, when no bias occurs in the input characteristics of the microphones M (that is, when the input characteristics are aligned), it is possible to effectively use the existing microphone array processing technology. This microphone array processing technology is technology for combining input audio signals in the complex spectrum domain, and, for example, is technology using a “delay-and-sum array” or cardioid type directivity or the like. When the input characteristics of the microphones are aligned, it is possible to appropriately generate a complex spectrum which does not include an audio component of the combination direction (for example, the SL direction of the example of FIG. 5) of the specific channel using the relevant technology.

Therefore, in the second embodiment, a directivity combining result using the existing microphone array processing technology as well as only input audio spectra X of the microphones M is used when the directivity combining is performed in the power spectrum domain. In this manner, in the second embodiment, the existing microphone array processing technology is applied to the directivity combining according to the first embodiment. Thereby, it is possible to improve performance of first directivity combining when the sound of the low-frequency band is combined.

As described above, according to the second embodiment, combined audio signals z_{L}, z_{R}, z_{SL}, and z_{SR} of four channels can be output using input audio signals x₁, x₂, and x₃ of the three microphones M₁, M₂, and M₃. In particular, even when the sound of the low-frequency band is input to the microphone M and no bias occurs in the input characteristics of the microphones M, it is possible to suitably combine a power spectrum P_{Yelse} of the non-combination direction other than the SL direction. Accordingly, good directivity combining in a wider frequency band is possible. Hereinafter, an audio signal processing device and method according to the second embodiment for implementing the above-described directivity combining will be described.

### 2.2. Functional Configuration of Audio Signal Processing Device

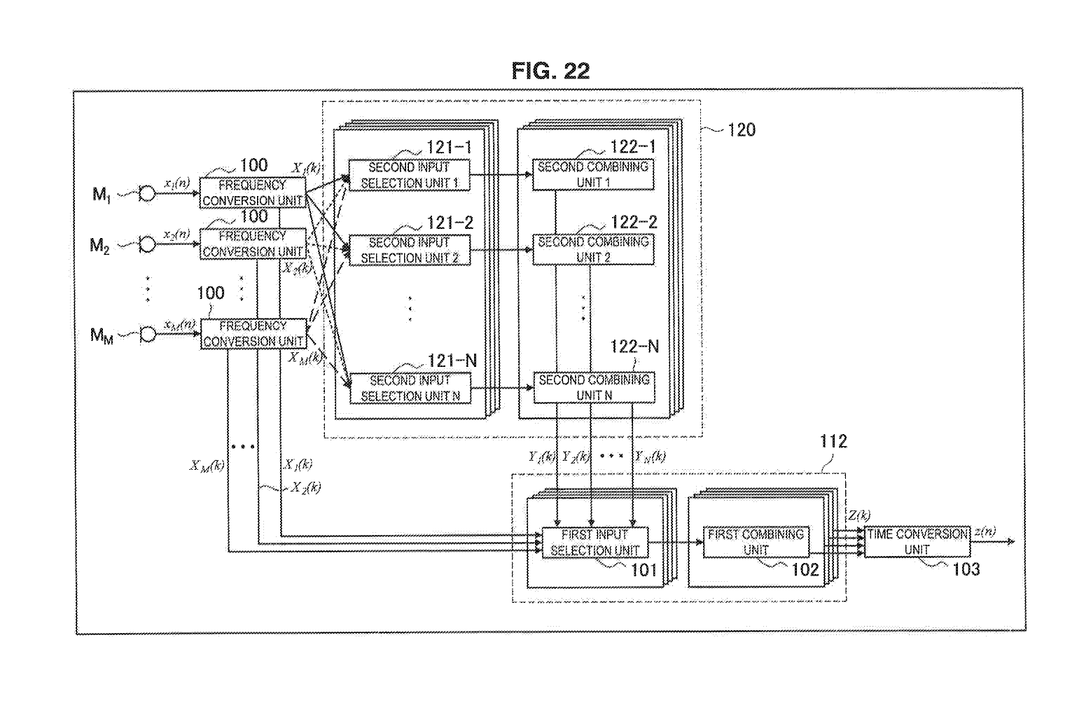

Next, with reference to FIG. 22, a functional configuration example of an audio signal processing device applied to the digital camera 1 according to the second embodiment will be described. FIG. 22 is a block diagram illustrating a functional configuration of the audio signal processing device according to the second embodiment.

As illustrated in FIG. 22, the audio signal processing device according to the second embodiment includes M microphones M₁, M₂, . . . , M_{M}, M frequency conversion units 100, a first input selection unit 101, a first combining unit 102, a time conversion unit 103, N second input selection units 121, and N second combining units 122. Among these, the frequency conversion units 100, the first input selection unit 101, the first combining unit 102, the time conversion unit 103, the second input selection units 121, and the plurality of second combining units 122 constitute the above-described audio processing unit 60 of FIG. 12. Each part of the audio processing unit 60 may be constituted of dedicated hardware or software. When the software is used, it is only necessary for a processor provided in the audio processing unit 60 to execute a program for implementing a function of each functional unit to be described below.

In this manner, the audio signal processing device according to the second embodiment includes a second directivity combining unit 120 having the second input selection units 121 and the second combining units 122 in addition to the first directivity combining unit 112 having the first input selection units 101 and the first combining units 102 according to the above-described first embodiment. The second directivity combining unit 120 performs a second directivity combining process of combining input audio signals X in the complex spectrum domain using the existing microphone array processing technology and outputs combined audio spectra Y of a plurality of combination directions as its combination result to the above-described first directivity combining unit 112.

Here, the second directivity combining unit 120 will be described in detail. As illustrated in FIG. 22, the second directivity combining unit 120 includes N second input selection units 121-1 to 121-N and N second input selection units 121-1 to 121-N corresponding to the N second input selection units 121. N is the number of channels of the surround reproduction environment. For example, in the surround reproduction environment of the four channels illustrated in FIG. 5C, N=4. That is, for each channel (for example, L, R, SL, and SR) of the surround reproduction environment, a set of the second input selection unit 121 and the second input selection unit 121 is provided. For example, the set of the second input selection unit 121-1 and the second input selection unit 121-1 performs a directivity combining process for generating a combined audio signal of a first channel (for example, L channel).

The second input selection unit 121 selects input audio spectra X(k) of a combination target by the second combining unit 122 from among the M input audio spectra X₁(k), X₂(k), . . . , X_{M}(k) input from the frequency conversion units 100. Here, the input audio spectra X(k) of the combination target is a plurality of input audio spectra necessary to combine each of audio signals (hereinafter referred to as a “combined audio signal of a plurality of channels”) having a plurality of directivities of a combination direction corresponding to the plurality of channels of the surround reproduction environment. The second input selection unit 121 selects the input audio spectra X(k) of the combination target based on the arrangement of the M microphones for the housing 4 of the digital camera 1.

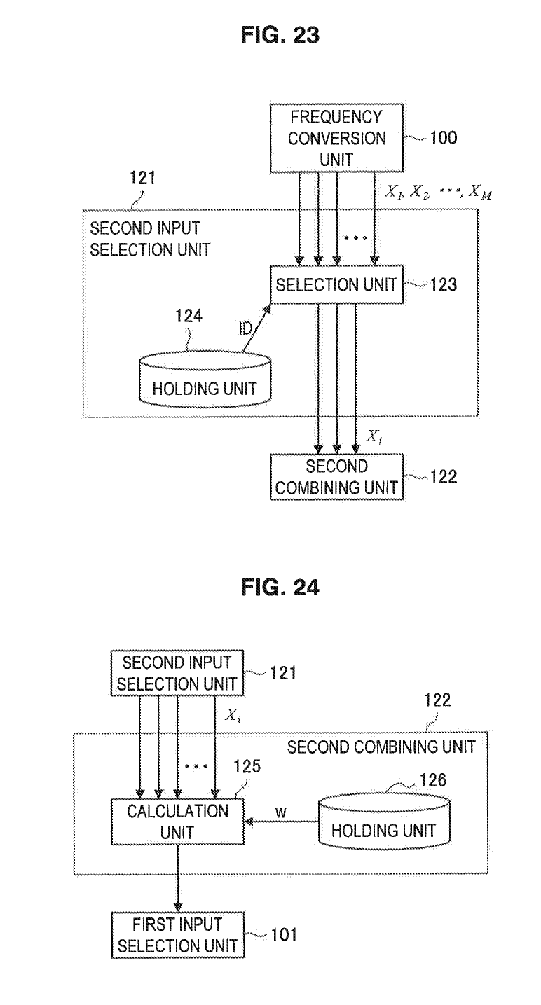

Here, with reference to FIG. 23, the configuration of the second input selection unit 121 according to the present embodiment will be described in detail. FIG. 23 is a block diagram illustrating the configuration of the second input selection unit 121 according to the present embodiment.

As illustrated in FIG. 23, the second input selection unit 121 includes a selection unit 123 and a holding unit 124.

The holding unit 124 associates and holds identification information of each of channels (for example, L, R, SL, SR, and the like) of the surround reproduction environment and identification information of microphones M, C₀, C₁, . . . , Cₚ₋₁, necessary to combine combined audio signals of each of the channels. Here, the identification information of the microphones M is an ID sequence including identification IDs (for example, microphone numbers) representing a plurality of microphones M necessary for the combination. The microphone M necessary for the combination is predetermined by the developer for every channel and every frequency band of the surround reproduction environment and the identification ID of the determined microphone M is held in the holding unit 124.

The selection unit 123 selects input audio spectra X of at least two combination targets from the M input audio spectra X input from the frequency conversion unit 100 based on the arrangement of the M microphones M for the housing 4. At this time, the selection unit 123 selects microphones M necessary to combine a combined audio signal of each of channels by the second combining unit 122 of the rear stage by referring to the identification information of the microphones M, C₀, C₁, . . . , Cₚ₋₁, held in the holding unit 124, and selects input audio spectra X corresponding to the selected microphones M. Thereby, the selection unit 123 selects only input audio spectra X corresponding to preset microphones M for every channel and outputs the selected input audio spectra X to the second combining unit 122 of the subsequent stage. Thereby, it is possible to extract optimum input audio spectra X for directivity combining of a desired channel.

For example, when two microphones M₁ and M₂ are necessary to combine a combined audio signal of the L direction, the holding unit 124 holds IDs of the microphones M₁ and M₂ in association with the L channel. The selection unit 123 selects input audio spectra X₁ and X₂ corresponding to the microphones M₁ and M₂ from among the M input audio spectra X₁, X₂, . . . , X_{M} based on the IDs of the microphones M₁ and M₂ read from the holding unit 124. The selection unit 123 outputs the selected input audio spectra X to the second combining unit 122 of the subsequent stage.

The second combining unit 122 generates a combined audio spectrum Yⱼ(k) having directivity of the combination direction of each channel described above by combining the plurality of input audio spectra X selected by the above-described second input selection unit 121. At this time, the second combining unit 122 performs combination to the combined audio spectrum Y of each channel by performing weighting addition on the above-described plurality of selected input audio spectra X using preset weighting coefficients w according to the arrangement of the microphones M.

In this manner, the second combining unit 122 performs a directivity combining process in the complex spectrum domain using the existing microphone array signal processing technology. This microphone array signal processing technology, for example, may be a “delay-and-sum array” or technology having cardioid type directivity.

Here, with reference to FIG. 24, a configuration of the second combining unit 122 according to the present embodiment will be described in detail. FIG. 24 is a block diagram illustrating the configuration of the second combining unit 122 according to the present embodiment.

As illustrated in FIG. 24, the second combining unit 122 includes a calculation unit 125 and a holding unit 126.

The holding unit 126 holds weighting coefficients w₁, w₂, . . . , w_{M} (third weighting coefficients) for calculating the combined audio spectrum Y of the combination direction of each channel. A developer of the digital camera i presets the weighting coefficients w for every combination direction according to the arrangement of the microphones M₁, M₂, . . . , M_{M} for the housing 4.

The calculation unit 125 calculates the combined audio spectrum Y of each channel by combining the plurality of input audio spectra X selected by the second input selection unit 121 using the weighting coefficients w held in the holding unit 126. For example, when the second input selection unit 121 selects input audio spectra X₁ and X₂ suitable for the L channel so as to perform the directivity combining of the L channel, the calculation unit 125 calculates a combined audio spectrum Y_{L} of the L channel by multiplying the input audio spectra X₁ and X₂ by the weighting coefficients w₁ and w₂ read from the holding unit 126 and adding the products.

In this manner, the second combining units 122-1 to 122-N generate N combined audio spectra Y₁(k), Y₂(k), . . . , Y_{N}(k) having directivity of a combination direction (for example, L, R, SL, or SR) of each channel by combining a plurality of input audio spectra X selected by the second input selection units 121-1 to 121-N in the complex spectrum domain. The second combining units 122-1 to 122-N output some or all of the generated combined audio spectra Y₁(k), Y₂(k), . . . , Y_{N}(k) to the first input selection unit 101 of the first directivity combining unit 112.

Next, the configurations of the first input selection unit 101 and the first combining unit 102 of the first directivity combining unit 112 according to the second embodiment will be described. Basic configurations of the first input selection unit 101 and the first combining unit 102 are similar to those of the first embodiment (see FIGS. 13 and 14).

Not only the M input audio spectra X₁, X₂, . . . , X_{M} from the frequency conversion units 100, but also the N combined audio spectra Y₁(k), Y₂(k), . . . , Y_{N}(k) from the above-described second combining units 122 are input to the first input selection unit 101. The first input selection unit 101 selects input audio spectra X(k) of the combination target by the first combining unit 102 from among the M input audio spectra X₁(k), X₂(k), . . . , X_{M}(k) based on the arrangement of the microphones M for the housing 4 of the digital camera 1. Further, the first input selection unit 101 also selects the combined audio spectra Y(k) of the combination target by the first combining unit 102 from among the N combined audio spectra Y₁(k), Y₂(k), . . . , Y_{N}(k) based on the arrangement of the microphones M.

Here, the input audio spectra X(k) selected by the first combining unit 102 are used to combine the above-described omnidirectional power spectrum Pₐₗₗ. On the other hand, the combined audio spectra Y(k) selected by the first combining unit 102 are used to combine the above-described non-combination direction power spectrum Pₑₗₛₑ. The first combining unit 102 outputs the selected input audio spectra X(k) and combined audio spectra Y(k) to the first combining unit 102.

The first combining unit 102 generates an omnidirectional power spectrum P_{Xall} by calculating power spectra P_{X} of the input audio spectra X(k) input from the first input selection unit 101 and combining the power spectra P_{X}. In addition, the first combining unit 102 generates a power spectrum P_{Yelse} of the non-combination direction other than the combination direction (the first combination direction, for example, the SL direction) of the specific channel by calculating power spectra Pv of the combined audio spectra Y(k) input from the first input selection unit 101 and combining the power spectra P_{Y}.

For example, when the power spectrum P_{Yelse} of the non-combination direction other than the SL direction is obtained, the first combining unit 102 calculates the power spectrum P_{Yelse} of the non-combination direction other than the SL direction by combining power spectra P_{YL}, P_{YR}, and P_{YSR} of the combined audio spectra Y_{L}, Y_{R}, and Y_{SR} of the L, R, and SR directions other than the SL direction.

Further, the first combining unit 102 generates a combined audio spectrum Z having the directivity of the combination direction of the specific channel by restoring the complex spectrum Z from the power spectrum Pz obtained by subtracting the non-combination direction power spectrum Pₑₗₛₑ from the above-described omnidirectional power spectrum Xₐₗₗ.

As described above, the first combining unit 102 generates the combined audio spectrum Z of the combination direction (for example, SL direction) of the specific channel further using the combined audio spectrum Y generated by the second combining unit 122 in addition to the input audio spectrum X obtained from the microphone M. At this time, although the first combining unit 102 generates the omnidirectional power spectrum P_{Xall} by combining the input audio spectra X, the combined audio spectra Y obtained from the second combining unit 122 are used instead of the input audio spectra X when the power spectrum P_{Yelse} of the non-combination direction other than a specific channel direction is generated. That is, the first combining unit 102 calculates the non-combination direction power spectrum P_{Yelse} by calculating power spectra P_{Y} of combined audio spectra Y of a plurality of combination directions other than the direction of the specific channel and combining the power spectra P_{Y}.

Thereby, even when the sound of a low-frequency band (for example, before and after 400 Hz) is input to the microphone M and no bias occurs in input characteristics of the microphones M (see FIG. 21A), it is possible to easily and accurately generate the power spectrum Pₑₗₛₑ of the non-combination direction other than the SL direction as illustrated in FIG. 21C. Accordingly, it is possible to favorably generate the combined audio spectrum Z_{SL} of the SL direction by subtracting the non-combination direction power spectrum P_{Yelse} from the omnidirectional power spectrum P_{Xall} generated from the input audio spectrum X.

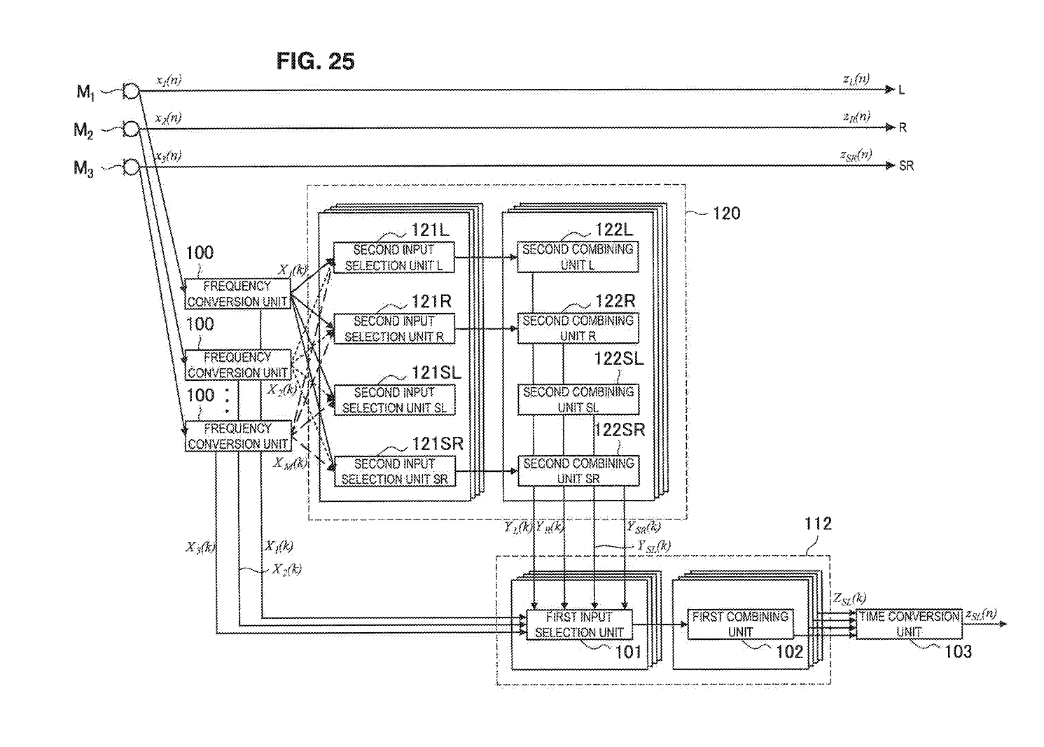

Next, with reference to FIG. 25, a specific example of a directivity combining function according to the audio signal processing device according to the second embodiment will be described. FIG. 25 is a block diagram illustrating the specific example of the directivity combining function according to the audio signal processing device according to the second embodiment.

FIG. 25 illustrates an example in which directivity combining of four channels L, R, SL, and SR illustrated in FIG. 5C are performed when sound of a low-frequency band is input to the microphones M and no bias occurs in input characteristics of the microphones M in the microphone arrangement illustrated in FIG. 5A. As described above, even when it is possible to favorably combine the combined audio signals z_{L}, z_{R}, and z_{SR} of the L, R, and SR directions according to the conventional directivity combining technology in the case of the microphone arrangement illustrated in FIG. 5A, it is difficult to favorably combine the combined audio signal z_{SL} of the SL direction. Further, in the directivity combining method according to the first embodiment, it is difficult to favorably obtain the power spectrum Pₑₗₛₑ of the non-combination direction other than the SL direction when no bias occurs in the input characteristics of the microphone M (see FIG. 21).

On the other hand, according to the second embodiment, directivity combining of the above-described power spectrum domain is performed so as to generate the combined audio signal z_{SL} of the SL direction. That is, as illustrated in FIG. 25, first, the three frequency conversion units 100 perform frequency conversions of the input audio signals x₁, x₂, and x₃ of the three microphones M₁, M₂, and M₃ into the input audio spectra X₁, X₂, and X₃.

Then, the second input selection units 121L, 121R, and 121SR select input audio spectra X necessary for directivity combining of the L, R, and SR directions from among X₁, X₂, and X₃. For example, X₁ and X₂ from the front direction are selected for the directivity combining of the L and R directions, and X₁, X₂, and X₃ are selected for the directivity combining of the SR direction. Further, the second combining units 122L, 122R, and 122SR combine combined audio spectra Y_{L}, Y_{R}, and Y_{SR} of L, R, and SR directions from the input audio spectra X₁, X₂, and X₃ and outputs the combined audio spectra Y_{L}, Y_{R}, and Y_{SR} to the first input selection unit 101.

Thereafter, the first input selection unit 101 selects input audio spectra X necessary for directivity combining of the SL direction from among X₁, X₂, and X₃. In this example, the input audio spectra X₁, X₂, and X₃ of all the microphones M₁, M₂, and M₃ are selected. Further, the first input selection unit 101 selects a combined audio spectrum Y necessary for directivity combining of the SL direction from among Y_{L}, Y_{R}, and Y_{SR}. In this example, all the combined audio spectra Y_{L}, Y_{R}, and Y_{SR} are selected.

Further, the first combining unit 102 combines the input audio spectra X₁, X₂, and X₃ to generate the omnidirectional power spectrum P_{Xall} and combines the combined audio spectra Y_{L}, Y_{R}, and Y_{SR} to generate the power spectrum P_{Yelse} of the non-combination direction other than the SL direction. Then, the combined audio spectrum Z_{SL} (complex spectrum) of the SL direction is generated from a difference between the two. Thereafter, the time conversion unit 103 generates a combined audio signal z_{SL} (time waveform) of the SL direction by performing an inverse Fourier transform on the combined audio signal z_{SL}.

On the other hand, in the L, R, and SR directions, as illustrated in FIG. 25, the input audio signals x₁, x₂, and x₃ of the three microphones M₁, M₂, and M₃ are output as the combined audio signals z_{L}, z_{R}, and z_{SR} of the L, R, and SR directions without change. This point is similar to the first embodiment.

As described above, according to the second embodiment, combined audio signals z_{L}, z_{R}, z_{SL}, and z_{SR} of four channels can be output using input audio signals x₁, x₂, and x₃ of the three microphones M₁, M₂, and M₃. In particular, even when the sound of the low-frequency band is input to the microphone M and no bias occurs in the input characteristics of the microphones M, it is possible to suitably combine a power spectrum P_{Yelse} of the non-combination direction other than the SL direction. Accordingly, there is an advantageous effect in that good directivity combining in a wider frequency band is possible.

Here, directivity obtained by combination in the complex spectrum domain by the above-described second directivity combining unit 120 will be described in further detail.

In the second embodiment, for example, an objective is to appropriately combine the combined audio signal z_{SL} of the SL direction in the microphone arrangement illustrated in FIG. 5. Because of this, the first directivity combining unit 112 estimates the omnidirectional power spectrum P_{Xall} by combining input audio spectra X obtained from the microphones M in the power spectrum domain. Further, the first directivity combining unit 112 estimates the non-combination direction power spectrum P_{Yelse} by combining the combined audio spectra Y obtained by the second directivity combining unit 120 in the spectrum domain.

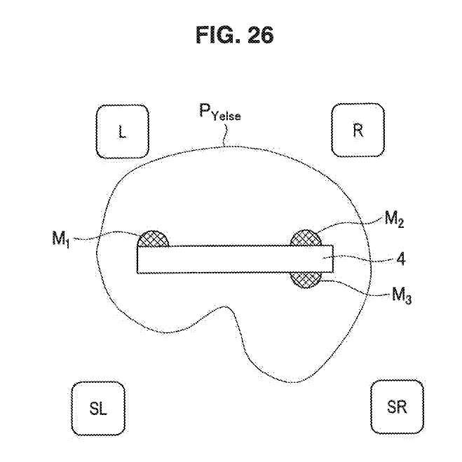

Because of this, the non-combination direction power spectrum P_{Yelse} obtained from the combined audio spectrum Y(k) output from the first directivity combining unit 112 is configured to include relatively many audio components of the L, R, and SR direction with respect to the audio component of the SL direction as illustrated in FIG. 26.

Incidentally, the input audio spectrum X(k) is obtained by performing frequency conversion on the input audio signal x(n) from the microphone M and the combined audio spectrum Y(k) is obtained by performing weighting addition on X(k). Then, the first directivity combining unit 112 estimates the non-combination direction power spectrum P_{Yelse} by performing weighting addition on the power spectrum P_{Y} of Y(k).

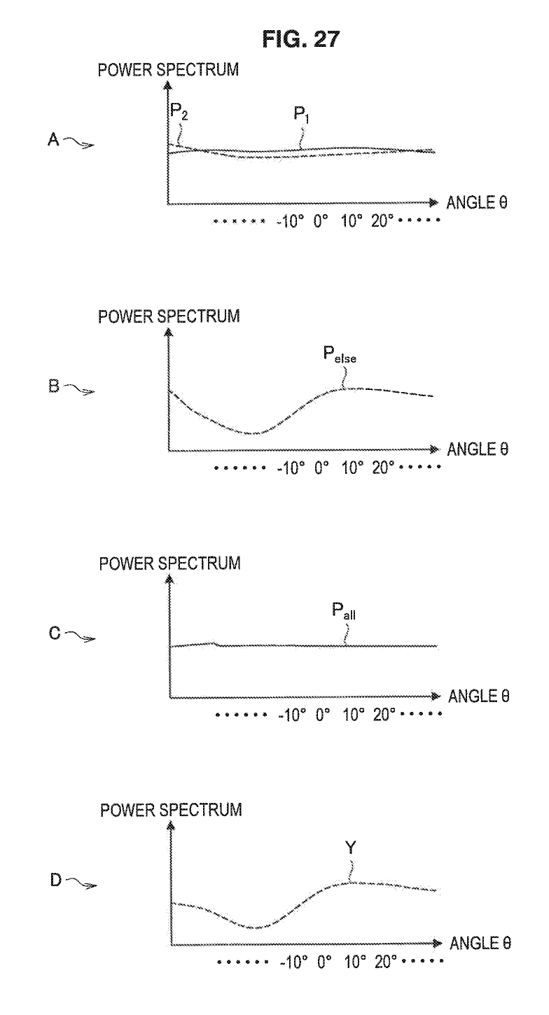

In addition, when the sound of the low-frequency band such as 400 Hz is input to the microphone M as described above, the sound from all arrival directions θ has substantially the same input characteristics because no bias occurs in the input characteristics of the microphone M as illustrated in FIG. 27A. In this case, although it is possible to combine the omnidirectional power spectrum Pₐₗₗ as illustrated in FIG. 27C, it is difficult to combine characteristics in which only an audio component of the specific direction as illustrated in FIG. 27B is reduced, that is, the power spectrum Pₑₗₛₑ of the non-combination direction which does not include only the SL direction.

However, it is possible to generate a complex spectrum Y which does not include the audio component of the SL direction as illustrated in FIG. 27D by performing calculation in the complex spectrum domain using phase information as well as the power spectrum P_{X} of X(k). This method corresponds to directivity combining using the existing microphone array technology. Because the input characteristics of the microphone M are aligned when the sound of the low-frequency band is input as described above, it is possible to apply the microphone array technology.

In this microphone array technology, weighting addition is performed on the complex spectra X using the weighting coefficients w. Therefore, an example of a method of obtaining the weighting coefficients w will be described. Also, because the input audio signal is calculated in the complex spectrum domain, the input audio spectrum X(k) of a certain frequency component k is assumed to be considered hereinafter.

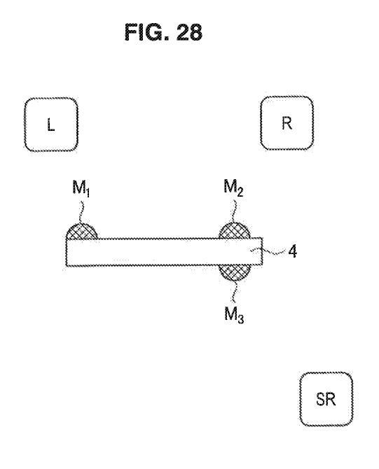

As illustrated in FIG. 28, speakers are arranged in the L, R, and SR directions around the housing 4 on which the three microphones M₁, M₂, and M₃ are arranged, a test signal (white noise) is reproduced individually from each speaker, and input audio spectra X are measured. As a result, a complex spectrum obtained when the test signal from the L direction is reproduced is represented by X_{L}_{_{—}}ᵢ(k), a complex spectrum obtained when the test signal from the R direction is reproduced is represented by X_{R}_{_{—}}ᵢ(k), and a complex spectrum obtained when the test signal from the SR direction is reproduced is represented by X_{SR}_{_{—}}ᵢ(k).

Here, in order to obtain the characteristic reduced in only the SL direction, it is only necessary to obtain the coefficients w satisfying the following Formulas (22).

1=w₁·a_{L}_{_{—}}₁(k)+w₂·a_{L}_{_{—}}₂(k)+w₃·a_{L}_{_{—}}₃(k)

1=w₁·a_{R}_{_{—}}₁(k)+w₂·a_{R}_{_{—}}₂(k)+w₃·a_{R}_{_{—}}₃(k)

1=w₁·a_{SR}_{_{—}}₁(k)+w₂·a_{SR}_{_{—}}₂(k)+w₃·a_{SR}_{_{—}}₃(k)

0=w₁·a_{SL}_{_{—}}₁(k)+w₂·a_{SL}_{_{—}}₂(k)+w₃·a_{SL}_{_{—}}₃(k) (22)

Formulas (22) mean that the audio components of the L, R, and SR directions are passed in a gain of 1, and the gain of the audio component of the SL direction is set to 0. It is possible to obtain w₁ to w₃ as the solutions of the above-described Formulas (22) through a generalized inverse matrix.

Also, a_{L}_{_{—}}ᵢ(k), a_{R}_{_{—}}ᵢ(k), and a_{SR}_{_{—}}ᵢ(k) in Formulas (22) are obtained by normalizing X_{L}_{_{—}}ᵢ(k), X_{R}_{_{—}}ᵢ(k), and X_{SR}_{_{—}}ᵢ(k) using amplitude values of the above-described test signals. When a component of the frequency component k of the test signal is represented by S(k), the input audio spectrum a_{L}_{_{—}}ᵢ(k) of the L direction is represented by the following Formula (23). The same is true in the other directions.

[Math. 4]

a_{L}_{_{—}}ᵢ(k)=X_{L}_{_{—}}ᵢ(k)/|S(k)| (23)

An example of calculation of the coefficients w according to the second embodiment has been described above. According to the above-described calculation example, the second combining unit 122 can appropriately obtain the weighting coefficients w for calculating the combined audio of each channel of the surround reproduction environment.

### 2.3 Audio Signal Processing Method

Next, the audio signal processing method (directivity combining method) by the audio signal processing device according to the second embodiment will be described.

### [2.3.1. Overall Operation of Audio Signal Processing Device]

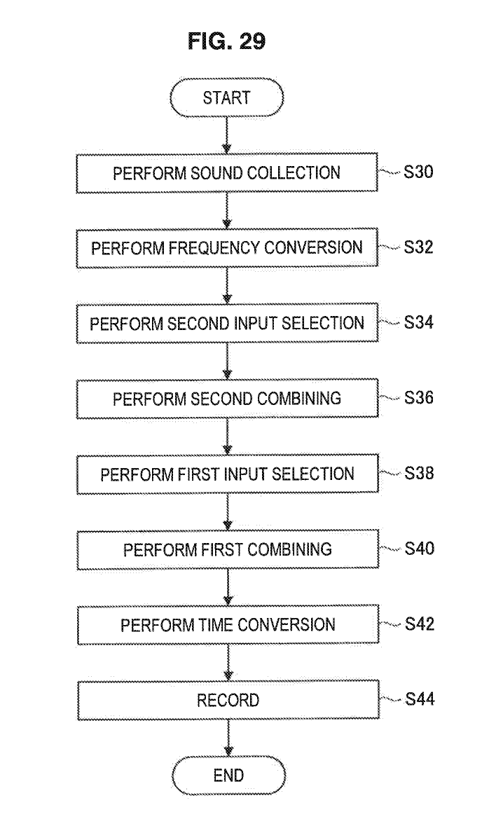

First, with reference to FIG. 29, the overall operation of the audio signal processing device according to the present embodiment will be described. FIG. 29 is a flowchart illustrating the audio signal processing method according to the present embodiment.

The second embodiment is different from the first embodiment in that a second input selection process S32 and a second combining process S34 are added.

As illustrated in FIG. 29, first, the microphones M₁, M₂, . . . , M_{M} collect sounds (external audio) around the digital camera 1, and generate the input audio signals xₗ, x₂, . . . , x_{M} (S30). Then, the frequency conversion units 100 perform frequency conversions (for example, FFTs) on the input audio signals x₁, x₂, . . . , x_{M} from the microphones M₁, M₂, . . . , M_{M}, and generates the input audio spectra X₁, X₂, . . . , X_{M}(S32). Processes of S30 and S32 are similar to the processes of S10 and S12 of FIG. 17 of the first embodiment.

Then, the second input selection unit 121 selects a plurality of input audio spectra X necessary to combine each channel of the surround reproduction environment from input audio spectra X₁, X₂, . . . , X_{M} obtained in S32 (S34). Further, the second combining unit 122 generates combined audio spectra Y₁, Y₂, . . . , Y_{N} of each channel by combining the input audio spectra X selected in S34 (S36). This combining process is also performed for every frequency component k of the input audio spectrum X(k) (k=0, 1, . . . , L−1).

Then, the first input selection unit 101 selects a plurality of input audio spectra X necessary to combine the omnidirectional power spectrum P_{Xall} from the input audio spectra X₁, X₂, . . . , X_{M} obtained in S32 (S38). Further, the first input selection unit 101 selects a plurality of input audio spectra Y necessary to combine the power spectrum P_{Yelse} of the non-combination direction other than a specific channel direction from the input audio spectra Y₁, Y₂, . . . , Y_{N} obtained in S36 (S38).

Further, the first combining unit 102 generates a combined audio spectrum Z(k) of the specific channel by combining the input audio spectra X and the combined audio spectra Y selected in S38 (S40). At this time, the omnidirectional power spectrum P_{Xall} is combined using the input audio spectra X, the power spectrum P_{Yelse} of the non-combination direction other than the specific channel direction from the combined audio spectra Y is combined, and a difference between P_{Xall} and P_{Yelse} is calculated. This combining process is also performed for every frequency component k (k=0, 1, . . . , L−1) of the input audio spectra X(k) and the combined audio spectra Y(k).

Thereafter, the time conversion unit 103 generates the combined audio signal z(n) by performing time conversion (for example, inverse FFT) on the combined audio spectrum Z(k) combined in S40 (S42). Further, the control unit 70 of the digital camera 1 records the combined audio signal z(n) on the recording medium 40 (S44). At this time, along with the combined audio signal z(n) of the above-described specific channel, a combined audio signal z(n) of another channel or a moving image may also be recorded on the recording medium 40.

### [2.3.2. Operation of Second Input Selection Unit]

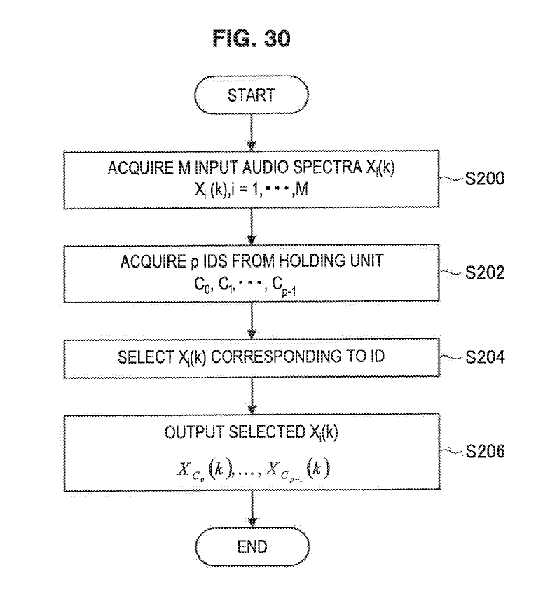

Next, with reference to FIG. 30, the operation (the second input selection process S34 of FIG. 29) of the second input selection unit 121 according to the present embodiment will be described. FIG. 30 is a flowchart illustrating the operation of the second input selection unit 121 according to the present embodiment. Also, a k^{th} frequency component x(k) of the input audio spectrum X will be described below, wherein frequency components up to k=0, 1, . . . , L−1 are present and all the frequency components are similarly processed.

As illustrated in FIG. 30, first, the second input selection unit 121 acquires the M input audio spectra x₁(k), x₂(k), . . . , x_{M}(k) output from the frequency conversion units 100 (S200).

Then, the second input selection unit 121 acquires an ID sequence including the identification information of the P microphones M, C₀, C₁, . . . , Cₚ₋₁, from the holding unit 124 (S202). As described above, the ID sequence is identification information (for example, microphone numbers) of the microphones M necessary to combine the combined audio signal of the each of channels of the surround reproduction environment. The ID sequence is preset according to the arrangement of the microphones M₁, M₂, . . . , M_{M} for every channel of the surround reproduction environment. The second input selection unit 121 can determine the input audio spectrum Xᵢ(k) to be selected next in S204.

Further, the second input selection unit 121 selects some or all input audio spectra Xᵢ(k) from among the input audio spectra X₁(k), X₂(k), . . . , X_{M}(k) acquired in S200 based on the ID sequence acquired in S202 (S204). Here, the selected Xᵢ(k) is an audio spectrum necessary to combine the combined audio signal of each of channels, and corresponds to an input audio spectrum output from the microphone M designated by the identification information C₀, C₁, . . . , Cₚ₋₁ included in the above-described ID sequence.

Thereafter, the second input selection unit 121 outputs the p input audio spectrum X(k) selected in S204 to the second combining unit 122 of the subsequent stage (S206).

### [2.2.3. Operation of Second Combining Unit]

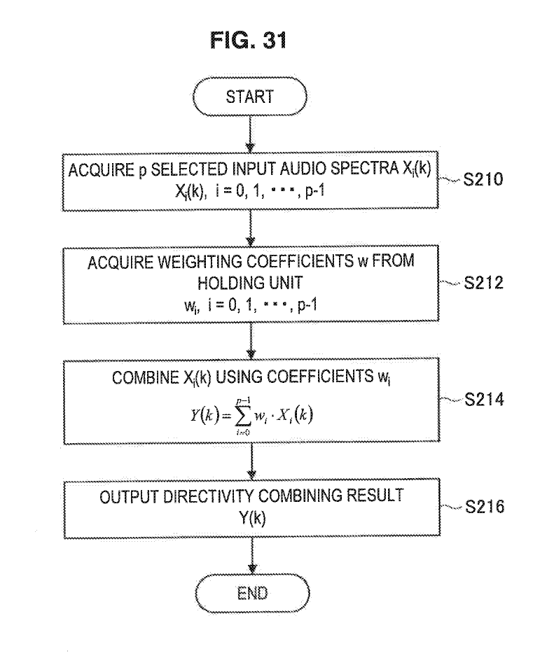

Next, with reference to FIG. 31, the operation (the second combining process S36 of FIG. 29) of the second combining unit 122 according to the present embodiment will be described. FIG. 31 is a flowchart illustrating the operation of the second combining unit 122 according to the present embodiment. Also, a k^{th} frequency component x(k) of the input audio spectrum X will be described below, wherein frequency components up to k=0, 1, . . . , L−1 are present and all the frequency components are similarly processed.

First, the second combining unit 122 acquires P input audio spectra Xᵢ(k) selected by the above-described second input selection unit 121 as the audio spectra of the combination target (S210).

Then, the second combining unit 122 acquires weighting coefficients w; for obtaining the combined audio spectrum Y of the combination direction of each channel from the holding unit 126 (S212). As described above, the holding unit 126 holds the weighting coefficients wᵢ according to the microphone arrangement for every channel. Therefore, the second combining unit 122 reads the weighting coefficients wᵢ corresponding to each channel of the combination target from the holding unit 126.

Further, the second combining unit 122 combines the combined audio spectrum Y(k) of the combination direction of each channel by performing weighting addition on the input audio spectra Xᵢ(k) acquired in S210 using the weighting coefficients wᵢ acquired in S212 (S214). That is, as in the following Formula (21), the combined audio spectrum Y(k) is calculated by multiplying Xᵢ(k) by the coefficients gᵢ and adding the products. This combining process corresponds to a combining process using the existing microphone array signal processing technology.

Y(k)=w₀·X₀(k)+w₁·X₁(k)+ . . . +wₚ₋₁·Xₚ₋₁(k) (21)

Thereafter, the second combining unit 122 outputs the combined audio spectrum Y(k) which is the combination result of S214 to the first input selection unit 101 (S216).

By perform ing the above process for N channels, the M input audio spectra X₁(k), X₂(k), . . . , X_{M}(k) are combined in the complex spectrum domain and the combined audio spectra Yᵢ(k) of the combination direction of the N channels are generated.

### [2.3.4. Operation of First Input Selection Unit]

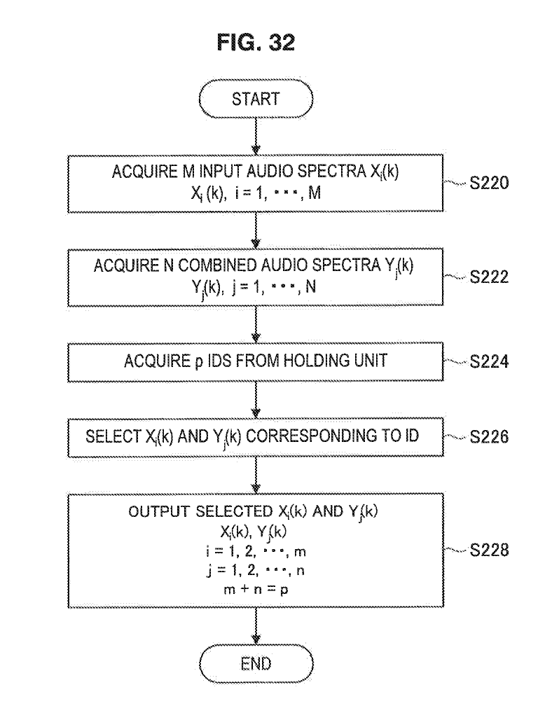

Next, with reference to FIG. 32, the operation (the first input selection process S38 of FIG. 29) of the first input selection unit 101 according to the present embodiment will be described. FIG. 32 is a flowchart illustrating the operation of the first input selection unit 101 according to the present embodiment. Also, a k^{th} frequency component x(k) of the input audio spectrum X will be described below, wherein frequency components up to k=0, 1, . . . , L−1 are present and all the frequency components are similarly processed.

As illustrated in FIG. 32, first, the first input selection unit 101 acquires the M input audio spectra X₁(k), X₂(k), . . . , X_{M}(k) output from the M frequency conversion units 100 (S220). Further, the first input selection unit 101 acquires the N combined audio spectra Y₁(k), Y₂(k), . . . , Y_{N}(k) output from the N second combining units 122-1 to 122-N (S222).

Then, the first input selection unit 101 acquires an ID sequence including P IDs from the holding unit 105 (S224). In the holding unit 105 (see FIG. 14), an ID sequence including identification information (IDs) of the microphones M necessary to combine a combined audio signal of each channel and identification information (IDs) of combined audio spectra Yᵢ is held. The developer presets the ID sequence according to the arrangement of the microphones M₁, M₂, . . . , M_{M} for every channel of the surround reproduction environment. The first input selection unit 101 can determine the input audio spectra Xᵢ(k) and the combined audio spectra Yᵢ(k) to be selected next in S226 according to the ID sequence.

Further, the first input selection unit 101 selects the input audio spectra Xᵢ(k) of the combination target by the first combining unit 102 from among the M input audio spectra X₁(k), X₂(k), . . . , X_{M}(k) based on the ID sequence acquired in S224 (S226). In addition, the first input selection unit 101 selects the combined audio spectra Yᵢ(k) of the combination target by the first combining unit 102 from among the N combined audio spectra Y₁(k), Y₂(k), . . . , Y_{N}(k) based on the ID sequence acquired in S224 (S226). Here, the selected X₁(k) and Yᵢ(k) are audio spectra necessary to combine the combined audio signal of the specific channel. The selected Xᵢ(k) is an input audio spectrum output from the microphone M corresponding to an ID acquired in the above-described S224, and the selected Yᵢ(k) is a combined audio spectrum Yᵢ(k) corresponding to the ID acquired in the above-described S224.

For example, in the example of FIG. 5, the three microphones M₁, M₂, and M₃ are installed and the input audio spectra X₁(k), X₂(k), and X₃(k) of all the microphones M₁, M₂, and M₃ are necessary to combine the combined audio signal z_{SL} of the SL direction. In this case, in the ID sequence, IDs of all the three microphones M₁, M₂, and M₃ are described. Because of this, in S226, the first input selection unit 101 selects all of X₁(k), X₂(k), and X₃(k).

In addition, in order to appropriately combine the power spectrum Pₑₗₛₑ of the non-combination direction other than the SL direction, the combined audio spectra Y_{L}(k), Y_{R}(k), and Y_{SR}(k) of the L, S, and SR directions are necessary. In this case, in the ID sequence, IDs of Y_{L}(k), Y_{R}(k), and Y_{SR}(k) are described. Because of this, in S226, the first input selection unit 101 selects Y_{L}(k), Y_{R}(k), and Y_{SR}(k) from among Y_{L}(k), Y_{R}(k), Y_{SL}(k), and Y_{SR}(k).

Thereafter, the first input selection unit 101 outputs m input audio spectra Xᵢ(k) and n combined audio spectra Yⱼ(k) selected in S226 to the first combining unit 102 of the subsequent stage (S228). Here, m+n=p, and m audio spectra are selected from X and n audio spectra are selected from Y as audio spectra specified by the above-described p IDs.

### [2.3.5. Operation of First Combining Unit]

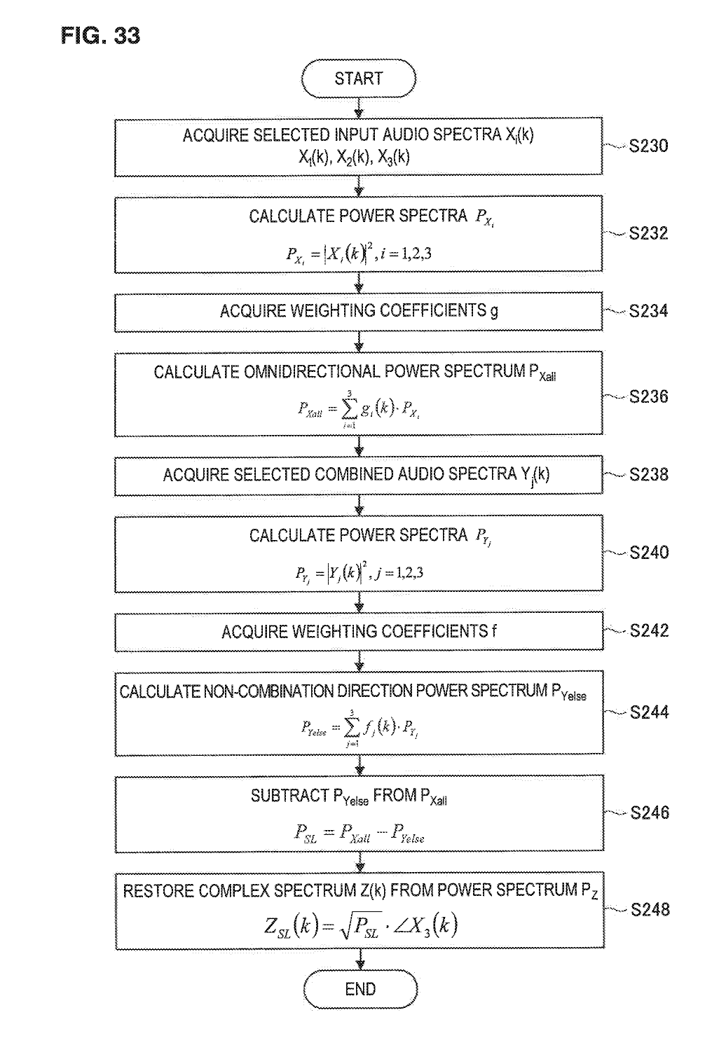

Next, with reference to FIG. 33, the operation (the first combining process S40 of FIG. 29) of the first combining unit 102 according to the present embodiment will be described. FIG. 33 is a flowchart illustrating the operation of the first combining unit 102 according to the present embodiment. Also, a k^{th} frequency component x(k) of the input audio spectrum X will be described below, wherein frequency components up to k=0, 1, . . . , L−1 are present and all the frequency components are similarly processed.

As illustrated in FIG. 33, first, the first combining unit 102 acquires a plurality of input audio spectra Xᵢ(k) selected by the above-described first input selection unit 101 as the audio spectra of the combination target (S230). Then, the first combining unit 102 calculates each of power spectra P_{Xi} of the input audio spectra Xᵢ(k) acquired in S230 (S232).

Further, the first combining unit 102 acquires a weighting coefficient gᵢ by which each power spectrum P_{Xi} is multiplied to obtain the omnidirectional power spectrum P_{Xall} from the first holding unit 107 (S234). Thereafter, the first combining unit 102 calculates an omnidirectional power spectrum P_{Xall} by performing weighting adding on the power spectrum P_{Xi} calculated in S232 using the weighting coefficient gᵢ acquired in S234 (S236). Because the above S230 to S236 are similar to S110 to S16 of FIG. 19 according to the first embodiment, detailed description thereof will be omitted.

Then, the first combining unit 102 acquires a plurality of combined audio spectra Yᵢ(k) selected by the above-described first input selection unit 101 as the audio spectra of the combination target (S238). For example, in the case of the microphone arrangement of FIG. 5, the input audio spectra Yᵢ(k) of the combination target are the combined audio spectra Y_{L}(k), Y_{R}(k), and Y_{SR}(k) of the L, S, and SR directions.

Then, the first combining unit 102 calculates power spectra P_{Yj}(k) of the combined audio spectra Yⱼ(k) acquired in S238 (S240). Because Y is a complex spectrum (Y=a+j·b), it is possible to calculate P_{Y} from Y (P_{Y}=a²+b²). For example, in the microphone arrangement of FIG. 5, power spectra P_{YL}, P_{YR}, and P_{SR} are calculated.

Then, the first combining unit 102 acquires the weighting coefficient fⱼ by which each power spectrum P_{Yj} is multiplied to obtain the non-combination direction power spectrum P_{Yelse} from the second holding unit 109 (S242). The second holding unit 109 holds weighting coefficients fⱼ corresponding to the microphone arrangement for every specific channel of the combination target. Therefore, the first combining unit 102 reads the weighting coefficients fⱼ corresponding to the specific channel of the combination target from the second holding unit 109.

Further, the first combining unit 102 calculates the non-combination direction power spectrum P_{Yelse} by performing weighting addition on the power spectra P_{Yj} calculated in S240 using the weighting coefficients fⱼ acquired in S242 (S120). For example, in the case of the microphone arrangement of FIG. 5, the power spectrum P_{Yelse} of the non-combination direction other than the SL direction is calculated in the following Formula (24) (see FIG. 7).

P_{Yelse}=f₁·P_{Y1}+f₂·P_{Y2}+f₃·P_{Y3} (24)

Thereafter, the first combining unit 102 subtracts the non-combination direction power spectrum P_{Xelse} obtained in S244 from the omnidirectional power spectrum P_{Xall} obtained in S236 (S246). Through this subtraction process, a power spectrum Pz of the specific channel (combination direction) of the combination target is obtained (Pz=P_{Xall}−P_{Yelse}). For example, in the case of the microphone arrangement of FIG. 5, the power spectrum P_{SL} of the SL direction is calculated as Pz (see FIG. 8).

Further, the first combining unit 102 restores a complex spectrum Z(k) of the specific channel from the power spectrum Pz of the specific channel (combination direction) of the combination target obtained in S246 (S248). This restoration process is as described in the first embodiment (see S124 of FIG. 19).

### 2.4. Advantageous Effects

The audio signal processing device and method according to the second embodiment have been described above in detail. According to the second embodiment, it is possible to obtain the following advantageous effects in addition to the advantageous effects of the above-described first embodiment.

According to the second embodiment, it is possible to improve the accuracy of the directivity combining process in the power spectrum domain according to the above-described first embodiment using the existing microphone array signal processing technology.

That is, because the sound of the low-frequency band such as 400 Hz is diffracted as described above, no bias occurs in the input characteristics of the microphone M and the input characteristics are aligned in all directions θ. In this case, it is difficult to accurately generate the non-combination direction power spectrum P_{Yelse} of the combination direction desired to be obtained in only a method of combining the input audio spectrum X in the power spectrum domain.

Therefore, in the second embodiment, the omnidirectional power spectrum P_{Xall} is combined using the input audio spectra X from the microphones M as in the above-described first embodiment and the non-combination direction power spectrum P_{Yelse} is generated from the combined audio spectra Y combined in the complex spectrum domain according to the existing microphone signal processing technology. When the input characteristics of the microphones M are aligned in all directions θ, it is possible to appropriately obtain the combined audio spectrum Y of a direction (for example, the L, R, or SR direction other than the SL direction) other than a desired combination direction by combining the complex spectrum. Accordingly, it is possible to generate the power spectrum P_{Yelse} of the non-combination direction other than the desired combination direction with high accuracy by performing weighting addition on the combined audio spectra Y.

Accordingly, it is possible to obtain the combined audio spectrum Z of the desired combination direction with high accuracy even for the input audio of the low-frequency band as well as the intermediate/high-frequency band. Consequently, there is an advantageous effect in that good directivity combining is possible in a wider frequency band.

### 3. Third Embodiment

Next, an audio signal processing device and an audio signal processing method according to the third embodiment of the present disclosure will be described. The third embodiment is characterized in that an easy and proper directivity combining result is obtained for every frequency properly using the above-described first directivity combining unit 112 and second directivity combining unit 120 according to the frequency band. Because other functional functions of the third embodiment are substantially the same as those of the above-described second embodiment, detailed description thereof will be omitted.

### 3.1. Outline of Third Embodiment

First, the outline of the audio signal processing device and method according to the third embodiment will be described.

In the above-described second embodiment, the second directivity combining unit 120 calculates the combined audio spectrum Y as only auxiliary information for directivity combining in the power spectrum domain by the first directivity combining unit 112.

However, when the input audio signal of the low-frequency band (400 Hz or the like) less than a predetermined frequency is combined, it is possible to easily and favorably generate the combined audio having the directivity of the objective even when only a combination result (the combined audio spectrum Y combined in the complex spectrum domain) by the second directivity combining unit 120 is used. As described above, because no bias occurs in the input characteristics of the microphones M for the sound of the low-frequency band (see FIG. 20), it is possible to favorably combine the combined audio spectrum Y having directivity of a direction of each channel according to the directivity combining in the complex spectrum domain by the second directivity combining unit 120.

On the other hand, when the input audio signal of the intermediate/high-frequency band (1000 Hz, 2500 Hz, or the like) more than or equal to the predetermined frequency is combined, the bias occurs in the input characteristics of the microphone M (see FIG. 20). Because of this, it is difficult to combine a good combined audio spectrum Y in the directivity combining by the second directivity combining unit 120 and it is preferable to perform directivity combining by the first directivity combining unit 112 in the power spectrum domain.

Therefore, the present embodiment is characterized in that the above-described first and second directivity combining methods are properly used according to the frequency band of the input audio signal. That is, when the sound component of the low-frequency band less than the reference frequency (for example, 1000 Hz) is combined, the combined audio spectra Y combined by the second directivity combining unit 120 in the complex spectrum domain are selected and output. On the other hand, when the audio component of the intermediate/high-frequency band more than or equal to the reference frequency (for example, 1000 Hz) is combined, a combined audio spectrum Z combined by the first directivity combining unit 112 in the power spectrum domain is selected and output. Thereby, it is possible to obtain an easy and proper directivity combining result for every frequency band. Hereinafter, the audio signal processing device and method according to the third embodiment for implementing the above-described directivity combining will be described.

### 3.2. Functional Configuration of Audio Signal Processing Device

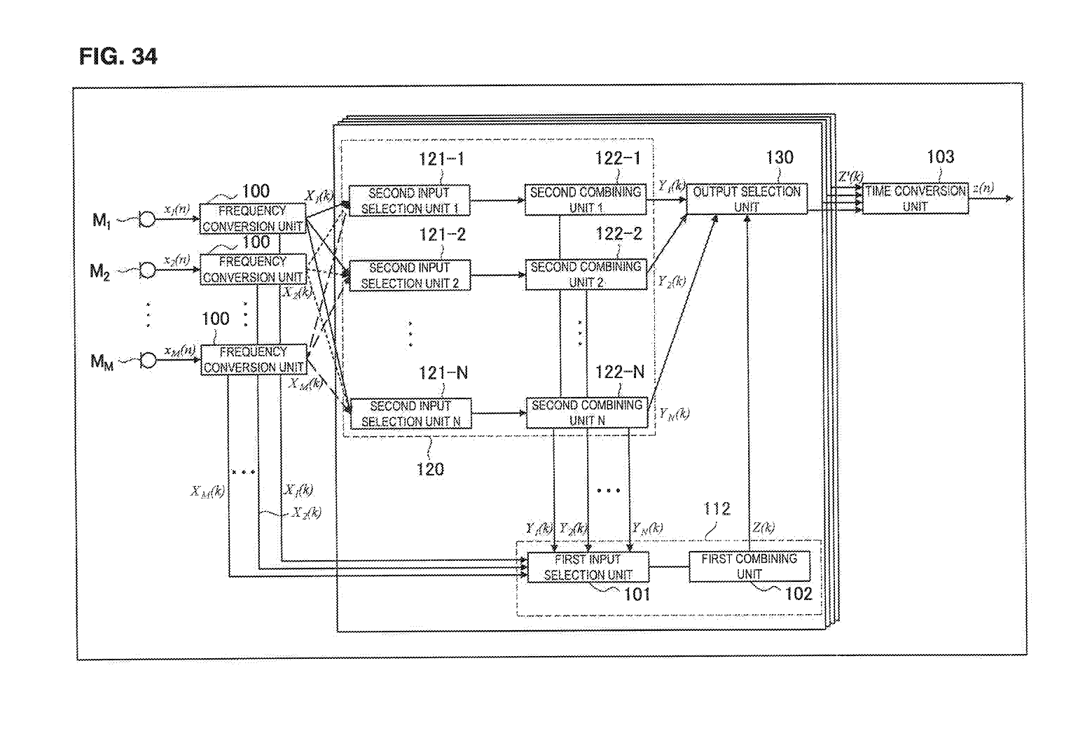

Next, with reference to FIG. 34, a functional configuration example of the audio signal processing device applied to the digital camera 1 according to the third embodiment will be described. FIG. 34 is a block diagram illustrating the functional configuration of the audio signal processing device according to the third embodiment

As illustrated in FIG. 34, the audio signal processing device according to the third embodiment includes M microphones M₁, M₂, . . . , M_{M}, M frequency conversion units 100, a first input selection unit 101, a first combining unit 102, a time conversion unit 103, N second input selection units 121-1 to 121-N, N second combining units 122-1 to 122-N, and an output selection unit 130. M is the number of installed microphones and N is the number of channels of the surround reproduction environment.

As can be seen from FIG. 34, the audio signal processing device according to the third embodiment further includes the output selection unit 130 in addition to the constituent elements of the audio signal processing device (see FIG. 22) according to the above-described second embodiment. In addition, combined audio spectra Y₁(k), Y₂(k), . . . , Y_{N}(k) generated by the second combining units 122-1 to 122-N of the second directivity combining unit 120 are output to the output selection unit 130 as well as the first input selection unit 101. Further, the combined audio spectrum Z(k) generated by the first combining unit 102 of the first directivity combining unit 112 is output to the output selection unit 130.

The output selection unit 130 selects and outputs either a combination result (combined audio spectrum Z(k)) by the first directivity combining unit 112 or a combination result (combined audio spectrum Yᵢ(k)) by the second directivity combining unit 120 as a combined audio spectrum Z′(k) having directivity of the combination direction of each channel. The combined audio spectrum Z′(k) output from the output selection unit 130 is output to the time conversion unit 103 and is converted into a combined audio signal z(k) having the directivity of each channel according to time conversion.

In further detail, the output selection unit 130 outputs only the combined audio spectrum Y(k) generated by the second combining unit 122 as the combined audio spectrum Z′(k) in the low-frequency band less than a reference frequency (for example, less than 1000 Hz). On the other hand, in the high-frequency band more than or equal to the above-described predetermined frequency (for example, 1000 Hz or more), the output selection unit 130 selects and outputs either the combined audio spectrum Z(k) generated by the first combining unit 102 or the combined audio spectrum Y(k) generated by the second combining unit 122 as the combined audio spectrum Z′(k) based on the arrangement of the microphones M for the housing 4.

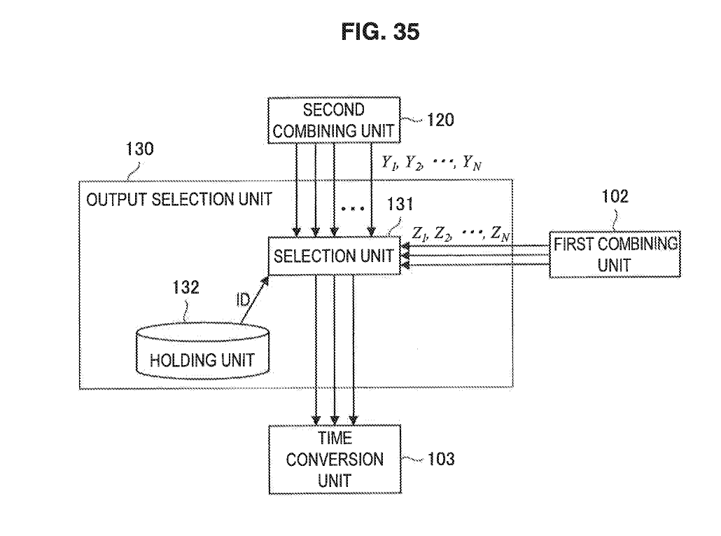

Here, with reference to FIG. 35, a configuration of the output selection unit 130 according to the present embodiment will be described in detail. FIG. 35 is a block diagram illustrating the configuration of the output selection unit 130 according to the present embodiment. As illustrated in FIG. 35, the output selection unit 130 includes a selection unit 131 and a holding unit 132.

The holding unit 132 associates and holds identification information (channel IDs) of channels (for example, C, L, R, SL, SR, and the like) of the surround reproduction environment, identification information (a frequency band ID) representing a frequency band of a combined audio signal, and identification information (a combining method ID) of the directivity combining method to be selected.

Here, the frequency band ID represents either one of the low-frequency band (for example, a frequency band ID=b1) less than the above-described reference frequency and the intermediate/high-frequency band (for example, a frequency band ID=b2) more than or equal to the above-described reference frequency. In addition, the combining method ID represents either one of a directivity combining method (for example, combining method ID=m1) by the above-described first directivity combining unit 112 in the power spectrum domain and a directivity combining method (for example, combining method ID=m2) by the above-described second directivity combining unit 120 in the complex spectrum domain. The developer predetermines a combining method ID for every channel and every band of the surround reproduction environment according to the arrangement of the microphones M for the housing 4, and the determined combining method ID is held in the holding unit 132.

The audio spectrum Z of each channel combined by the first directivity combining method is input from the first combining unit 102 to the selection unit 131, and the audio spectrum Yᵢ of each channel combined by the second directivity combining method is input from the second combining unit 122 to the selection unit 131. The selection unit 131 selects either the audio spectrum Z or the audio spectrum Yᵢ as an ultimately output combined audio spectrum Z₁′ for every channel and every frequency band of the surround reproduction environment based on the ID sequence held in the above-described holding unit 132, and outputs the selected audio spectrum Z or Y₁ to the time conversion unit 103.

At this time, the selection unit 131 selects the combined audio spectrum Z combined by the first combining unit 102 or the combined audio spectrum Yᵢ combined by the second combining unit 122 according to the frequency band of the combined audio signal. For example, when the audio component of the low-frequency band is combined (for example, frequency band ID=b1), the selection unit 131 selects the combined audio spectrum Yᵢ (for example, combining method ID=m2) in relation to all channels (for example, channel ID=D, L, R, SL, and SR). On the other hand, when the audio component of the intermediate/high-frequency band is combined (for example, frequency band ID=b2), the selection unit 131 selects either the combined audio spectrum Z combined by the first combining unit 102 or the above-described combined audio spectrum Yᵢ based on the combining method ID set for every channel. For example, Yᵢ from the second combining unit 122 is selected when the combining method ID=m2 is set for the L channel, and Zᵢ from the first combining unit 102 is selected when the combining method ID=m1 is set for the SL channel.

The functional configuration of the output selection unit 130 has been described above in detail. Because functional configurations of the frequency conversion unit 100, the first input selection unit 101, the first combining unit 102, the time conversion unit 103, the second input selection unit 121, and the second combining unit 122 are similar to those of the second embodiment except for the above-described points, detailed description thereof will be omitted.

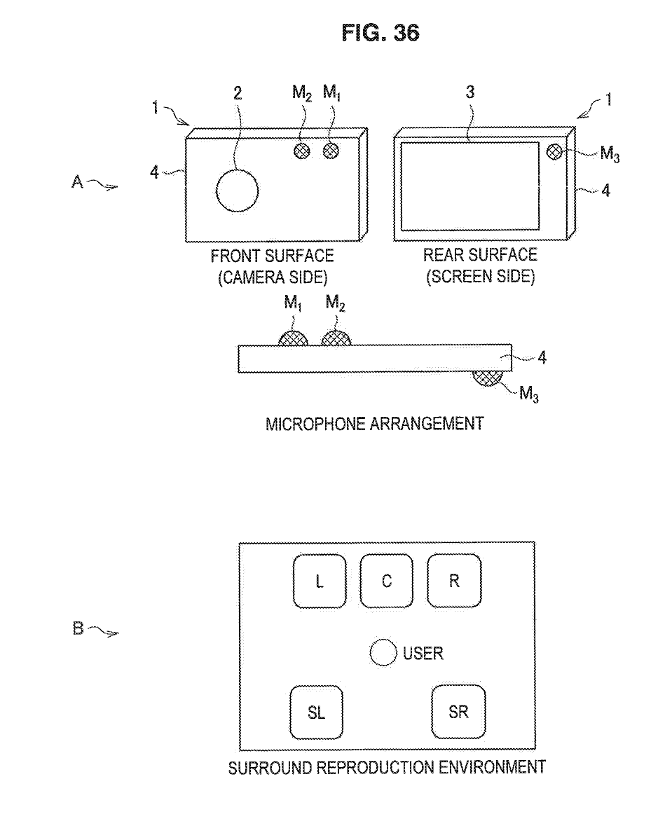

Next, an example in which a 5.1-ch surround reproduction environment illustrated in FIG. 36B is implemented by applying the audio signal processing device according to the above-described third embodiment to the digital camera 1 of the microphone arrangement illustrated in FIG. 36A will be described.

In this example, as illustrated in FIG. 36A, two microphones M₁ and M₂ are arranged on the front surface of the digital camera 1 and one microphone M₃ of the rear surface is arranged. In addition, as illustrated in FIG. 36B, in the surround reproduction environment, speakers of five channels C, L, R, SL, and SR are arranged around the user. Here, an objective is to implement 5.1-ch surround sound recording using the above-described three microphones M₁, M₂, and M₃.

As described above, when an obstacle such as the housing 4 is located between the sound arrival direction and the microphone M, a sound component arriving from an opposite sides of the housing 4 interposed therebetween is significantly attenuated and input to the microphone M because the frequency of the arrival sound increases. That is, the sound arriving from the rear-surface side of the housing 4 is significantly attenuated and input to the front surface microphones M₁ and M₂.

In this case, in the intermediate/high-frequency band (for example, 1000 Hz or more), it is necessary to combine the audio having directivity of the SL and SR directions mainly using only the microphone of the rear-surface side. However, because only the one microphone M₃ is located on the rear-surface side of the housing 4 in the example of FIG. 36A, it is difficult to appropriately combine two piece of combined audio of the left and right of the SL and SR directions in the conventional combination technology. Therefore, in the third embodiment, the directivity combining is performed in the power spectrum domain using the first directivity combining unit 112 in the SL and SR direction.

On the other hand, it is important to mainly acquire an audio component arriving from the front-surface side in the L, C, and R directions of the front-surface side and it is possible to sufficiently combine combined audio of the L, C, and R directions using only the two front surface microphones M₁ and M₂. Accordingly, in the third embodiment, the combined audio of the L, C, and R directions is easily combined using the existing microphone array technology by the second directivity combining unit 120 without using the first directivity combining unit 112.

In addition, in the low-frequency band (400 Hz or the like described above), input characteristics of all the microphones M₁, M₂, and M₃ are aligned (see FIG. 20). Therefore, in the third embodiment, the second directivity combining unit 120 can combine all combined audio spectra Y of the C, L, R, SL, and SR directions.

Also, in the low-frequency band, as in the second embodiment, it is possible to generate combined audio of the C, L, R, SL, and SR directions in the method of performing combination by the first directivity combining unit 112 using all the combination results (combined audio spectra Y) by the second directivity combining unit 120 and the input audio spectra X from the microphones M. It is only necessary to appropriately select whether to adopt the combining method according to the second embodiment or the combining method according to the third embodiment according to the microphone arrangement or the like.

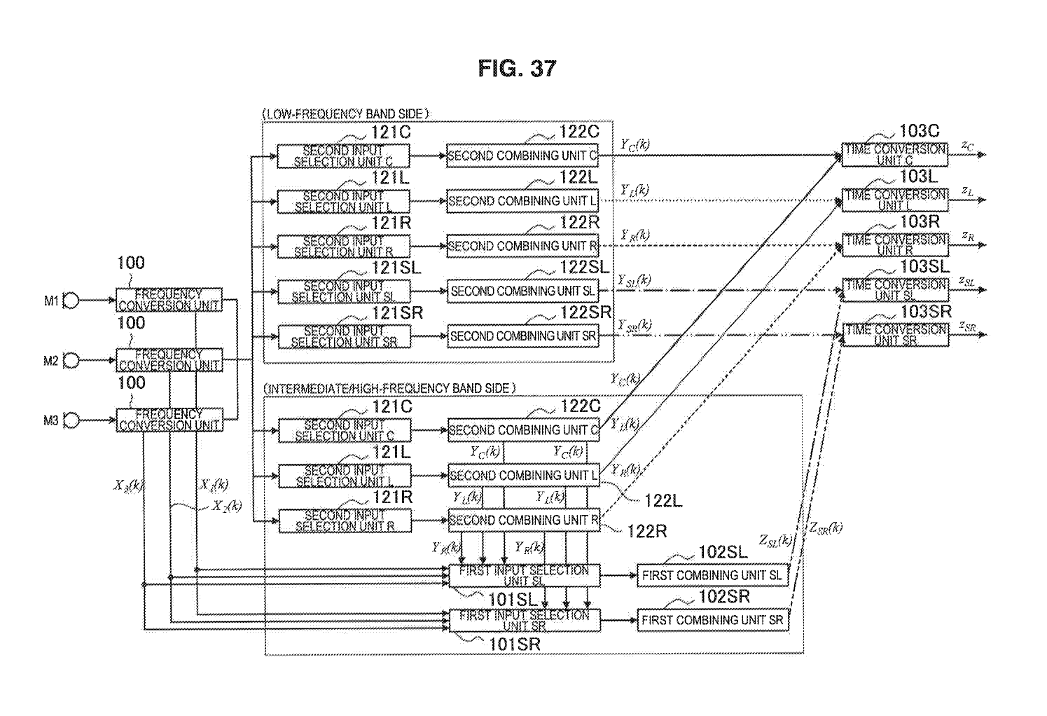

Next, with reference to FIG. 37, a specific example of a directivity combining function according to the audio signal processing device according to the third embodiment will be described. FIG. 37 is a block diagram illustrating the specific example of the directivity combining function according to the audio signal processing device according to the third embodiment.

FIG. 37 illustrates a configuration example in which directivity combining of five channels C, L, R, SL, and SR illustrated in FIG. 36B is performed in the microphone arrangement illustrated in FIG. 36A. Although a configuration having functional units for every frequency component k is shown in the basic configuration illustrated in FIG. 34, functional units are divided into two of the low-frequency band and the intermediate/high-frequency band and the divided functional units are shown in the configuration example illustrated in FIG. 37. Also, because the frequency band is divided into two and whether the combined audio spectrum Y or Z is selected is clearly shown in FIG. 37, the output selection unit 130 illustrated in FIG. 34 is omitted.

In the configuration example of FIG. 37, the first directivity combining unit 112 (the first input selection unit 101 and the first combining unit 102) functions in only the signal processing of the intermediate/high-frequency band. On the other hand, the second directivity combining unit 120 (the second input selection unit 121 and the second combining unit 122) functions in signal processing of both the low-frequency band and the intermediate, high-frequency band. That is, the directivity combining is performed in only the second directivity combining unit in the low-frequency band (for example, less than 1000 Hz) in which no bias occurs in the input characteristics of the microphones M₁, M₂, and M₃ according to the sound arrival direction θ. In addition, the directivity combining is performed in only the second directivity combining unit in the intermediate/high-frequency band (for example, less than 1000 Hz) in which the bias occurs in the input characteristics of the microphones M₁, M₂, and M₃.

As described above, only the second directivity combining unit 120 can suitably generate combined audio of the C, L, R, SL, and SR directions for an audio component of the low-frequency band in the complex spectrum domain in the case of the microphone arrangement illustrated in FIG. 36. On the other hand, because it is difficult for the second directivity combining unit 120 to suitably generate the combined audio of the SL and SR directions for the audio component of the intermediate/high-frequency band, the first directivity combining unit 112 has to combine the combined audio of the SL and SR directions in the power spectrum domain.

Therefore, in the third embodiment, as illustrated in FIG. 37, directivity combining of all the channels C, L, R, SL, and SR are performed using only the second directivity combining unit 120 for the audio component of the low-frequency band.

In detail, first, the frequency conversion units 100 perform frequency conversions of the input audio signals x₁, x₂, and x₃ of the microphones M₁, M₂, and M₃ into the input audio spectra X₁, X₂, and X₃, and output the input audio spectra X₁, X₂, and X₃ to the second input selection units 121C to 121SR. Then, the second input selection units 121C to 121 SR and the second combining units 122C to 122SR generate combined audio spectra Y_{C}, Y_{L}, Y_{R}, Y_{SL}, and Y_{SR} of the C, L, R, SL, and SR directions by combining X₁, X₂, and X₃ in the complex spectrum domain. Then, the combined audio spectra Y_{C}, Y_{L}, Y_{R}, Y_{SL}, and Y_{SR} are output to the time conversion units 103C to 103SR and converted into combined audio signals z_{C}, z_{L}, z_{R}, z_{SL}, and z_{SR} of the time domain, so that the combined audio signals z_{C}, z_{L}, z_{R}, z_{SL}, and z_{SR} are recorded on the recording medium 40 as ultimate combination results.

On the other hand, for the audio component of the intermediate/high-frequency band, directivity combining of the channels C, L, and R of the front-surface side are performed using only the second directivity combining unit 120 and directivity combining of the channels SL and SR of the rear-surface side are performed using the first directivity combining unit 112 and the second directivity combining unit 120.

In detail, first, the frequency conversion units 100 perform frequency conversions of the input audio signals x₁, x₂, and x₃ of the three microphones M₁, M₂, and M₃ into the input audio spectra X₁, X₂, and X₃, and output the input audio spectra X₁, X₂, and X₃ to the second input selection units 121C to 121SR and the first input selection units 101SL and 101SR. Then, the second input selection units 121C, 121L, and 121R and the second combining units 122C, 122L, and 122R generate the combined audio spectra Y_{C}, Y_{L}, and Y_{R} of the C, L, and R directions by combining X₁ and X₂ of X₁, X₂, and X₃ in the complex spectrum domain. Then, Y_{C}, Y_{L}, and Y_{R} are output to the first input selection units 101SL and 101 SR as well as the time conversion units 103C, 103L, and 103R.

In addition, the first input selection units 101SL and 101SR and the first combining units 102SL and 102SR combine X₁, X₂, and X₃ and Y_{C}, Y_{L}, and Y_{R} in the power spectrum domain and generate combined audio spectra Z_{SL} and Z_{SR} of the SL and SR directions. At this time, the omnidirectional power spectrum P_{Xall} is generated from X₁, X₂, and X₃, the non-combination direction power spectrum P_{Yelse} is generated from Y_{C}, Y_{L}, and Y_{R}, and Z_{SL} and Z_{SR} are generated from a difference between P_{Xall} and P_{Yelse}.

Here, signals to be selected by the second input selection unit 121 and the first input selection unit 101 according to a frequency band are summarized as follows.

The second input selection units 121C, 121L, and 121R select the input audio spectra X₁, X₂, and X₃ from all the microphones M₁, M₂, and M₃ in the low-frequency band, and select only input audio spectra X₁ and X₂ from the microphones M₁ and M₂ of the front-surface side in the intermediate/high-frequency band. In addition, the second input selection units 121SL and 121SR select the input audio spectra X₁, X₂, and X₃ from all the microphones M₁, M₂, and M₃ in the low-frequency band and do not operate in the intermediate/high-frequency band.

On the other hand, the first input selection unit 101SL selects the input audio spectra X₁, X₂, and X₃ from all the microphones M₁, M₂, and M₃ and the input audio spectra Y_{C} and Y_{R} output from the second combining units 122C and 122R in the intermediate/high-frequency band without being operated in the low-frequency band. In addition, the first input selection unit 101SR selects the input audio spectra X₁, X₂, and X₃ from all the microphones M₁, M₂, and M₃ and the input audio spectra Y_{C} and Y_{L} output from the second combining units 122C and 122L in the intermediate/high-frequency band without being operated in the low-frequency band.

Thereafter, Y_{C}, Y_{L}, and Y_{R} generated by the above-described second combining units 122C, 122L, and 122R and Z_{SL} and Z_{SR} generated by the first combining units 102SL and 102SR are output to the time conversion units 103C to 103SR and converted into combined audio signals z_{C}, z_{L}, z_{R}, z_{SL}, and z_{SR} of the time domain, so that the combined audio signals z_{C}, z_{L}, z_{R}, z_{SL}, and z_{SR} are recorded on the recording medium 40 as ultimate combination results.

As described above, in the third embodiment, operations of the first directivity combining unit 112 and the second directivity combining unit 120 are switched according to a frequency band of input audio. Thereby, it is possible to easily and appropriately perform directivity combining of five channels.

Here, a specific example of a directivity combining based on the above-described configuration example of FIG. 37 in the intermediate/high-frequency domain (4000 Hz) will be described.

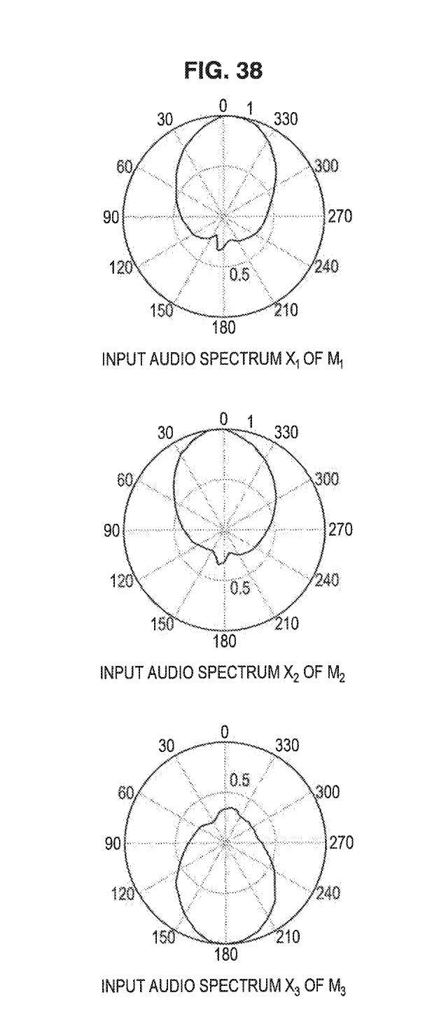

FIG. 38 illustrates input audio spectra X₁, X₂, and X₃ input from the microphones M₁, M₂, and M₃. As illustrated in FIG. 38, X₁ and X₂ have the directivity of the front-surface direction (θ=0 degrees) and X₃ has the directivity of the front-surface direction (θ . . . 180 degrees). However, because any one of X₁, X₂, and X₃ does not have the directivity of the left and right directions (θ=90 and 270 degrees), it is difficult to generate combined audio having the directivity of the SL and SR directions from X₁, X₂, and X₃ of this state.

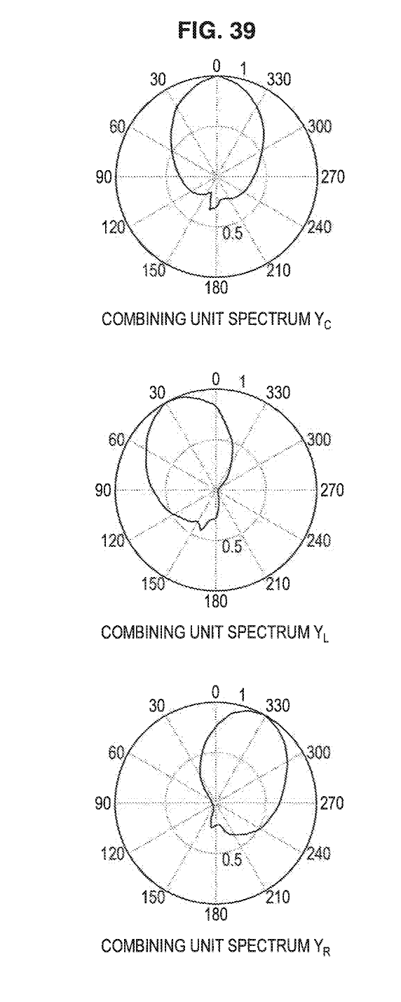

FIG. 39 illustrates characteristics of the combined audio spectra Y_{C}, Y_{L}, and Y_{R} obtained by the second combining unit 122 according to the present embodiment combining the input audio spectra X₁ and X₂. As illustrated in FIG. 39, it is possible to generate the combined audio spectra Y_{C}, Y_{L}, and Y_{R} having directivity of three directions such as C, L, and R of the front-surface side only using the two input audio spectra X₁ and X₂ having directivity at the front-surface side (6=0 degrees).

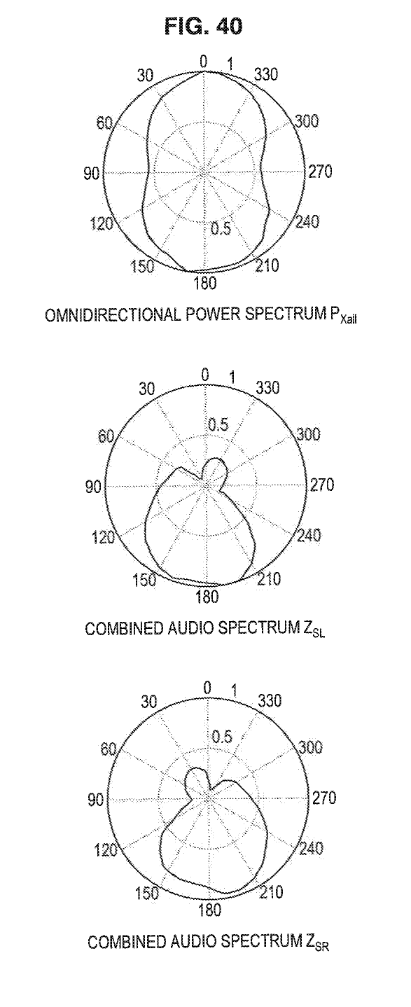

FIG. 40 illustrates characteristics of the omnidirectional power spectrum P_{Xall} obtained by combining X₁, X₂, and X₃ and the combined audio spectra Z_{SL} and Z_{SR} combined by the first combining unit 102. As illustrated in FIG. 40, the first combining unit 102 can generate the omnidirectional power spectrum P_{Xall} by combining the three input audio spectra X₁, X₂, and X₃ having the directivity of the front- and rear-surface directions. Further, it is possible to obtain a value (non-combination direction power spectra P_{SLelse} and P_{SRelse}) obtained by multiplying the combined audio spectra Y_{C}, Y_{L}, and Y_{R} of the C, L, and R directions generated by the second combining unit 122 by appropriate coefficients w and generate combined audio spectra Z_{SL} and Z_{SR} having directivity of the Sl and SR directions by subtracting P_{SLelse} and P_{SRelse} from the above-described P_{Xall}.

As described above, it is possible to favorably generate combined audio spectra Y_{C}, Y_{L}, Y_{R}, Y_{SL}, and Y_{SR} having directivity of five channels C, L, R, SL, and SR using the directivity combining by the second combining unit 122 and the directivity combining by the first combining unit 102 together even in the intermediate/high-frequency domain (4000 Hz).

### 3.3. Audio Signal Processing Method

Next, the audio signal processing method (directivity combining method) according to the audio signal processing device according to the third embodiment will be described.

### 3.3. Overall Operation of Audio Signal Processing Device

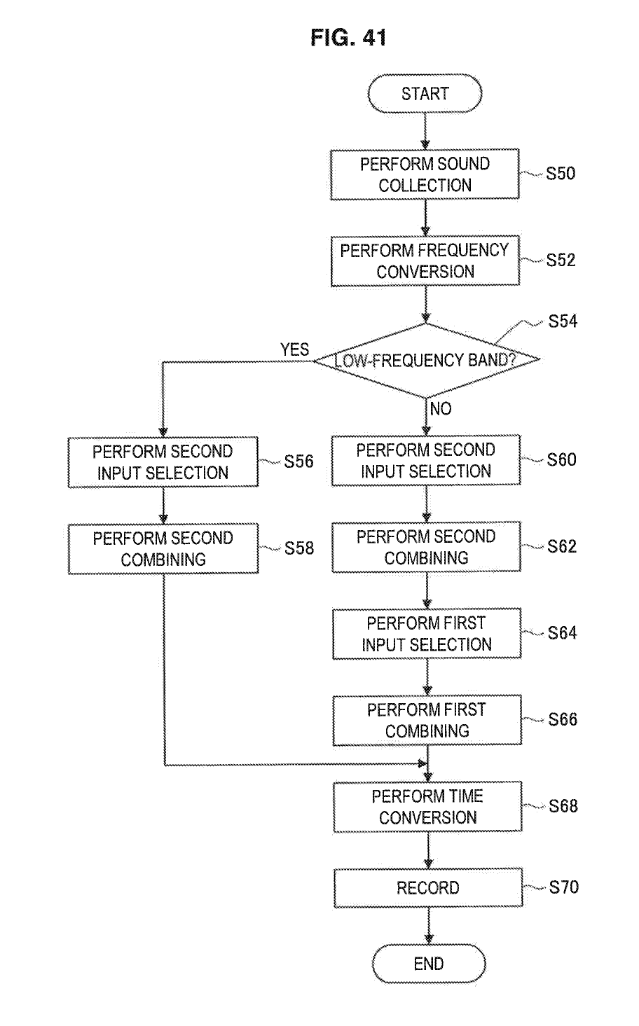

First, with reference to FIG. 41, the overall operation of the audio signal processing device according to the present embodiment will be described. FIG. 41 is a flowchart illustrating an audio signal processing method according to the present embodiment.

The third embodiment is different from the third embodiment in that a frequency-band determination process S54, a second input selection process S56, and a second combining process S58 are added.

As illustrated in FIG. 41, first, the microphones M₁, M₂, . . . , M_{M} collect sounds (external audio) around the digital camera 1, and generate the input audio signals x₁, x₂, . . . , x_{M} (S50). Then, the frequency conversion units 100 perform frequency conversions (for example, FFTs) on the input audio signals x₁, x₂, . . . , x_{M} from the microphones M₁, M₂, . . . , M_{M}, and generates the input audio spectra X₁, X₂, . . . , X_{M} (S52). Processes of S50 and S52 are similar to the processes of S10 and S12 of FIG. 17 of the first embodiment.

Then, a frequency-band determination unit (not illustrated) determines whether a frequency band of a frequency component k of the input audio spectrum X currently input is the low-frequency band or the intermediate/high-frequency band (S54). The low-frequency band is a frequency band less than a predetermined reference frequency (for example, 1000 Hz), and the intermediate/high-frequency band is a frequency band more than or equal to the reference frequency. The reference frequency is appropriately set according to the arrangement or input characteristics of the microphones M or the like. The processes of S56 and S58 are performed when it is determined that the frequency band is the low-frequency band in S54, and the processes of S60 to S66 are performed when it is determined that the frequency band is the intermediate/high-frequency band.

When it is determined that the frequency band is the low-frequency band in the above-described S54, only the directivity combining process by the second directivity combining unit 120 is performed (S56 and S58).

Specifically, first, the second input selection unit 121 selects a plurality of input audio spectra X necessary to combine each channel of the surround reproduction environment from input audio spectra X₁, X₂, . . . , X_{M} obtained in S52 (S56). Further, the second combining unit 122 generates combined audio spectra Y₁, Y₂, . . . , Y_{N} of each channel by combining the input audio spectra X selected in S56 (S58). This combining process is also performed for every frequency component k of the input audio spectrum X(k) (k=0, 1, . . . , L−1).

After S58, the time conversion units 103 convert the combined audio spectra Y₁, Y₂, . . . , Y_{N} combined in S58 into the combined audio signals z₁(n), z₂(n), . . . , z_{N}(n) of the time domain according to time conversions (for example, inverse FFTs) (S68). Further, the control unit 70 of the digital camera 1 records the combined audio signal z(n) on the recording medium 40.

On the other hand, when it is determined that the frequency band is the intermediate/high-frequency band in the above-described S54, the directivity combining process (S60 and S62) by the second directivity combining unit 120 and the directivity combining process (S64 and S66) by the first directivity combining unit 112 are performed.

Specifically, first, the second input selection unit 121 selects a plurality of input audio spectra X necessary to combine each channel of the surround reproduction environment from input audio spectra X₁, X₂, . . . , X_{M} obtained in S52 (S60). Further, the second combining unit 122 generates combined audio spectra Y₁, Y₂, . . . , Y_{N} of each channel by combining the input audio spectra X selected in S60 (S62). This combining process is also performed for every frequency component k of the input audio spectrum X(k) (k=0, 1, . . . , L−1).

Then, the first input selection unit 101 selects a plurality of input audio spectra X necessary to combine the omnidirectional power spectrum P_{Xall} from the input audio spectra X₁, X₂, . . . , X_{M}, obtained in S52 (S64). Further, the first input selection unit 101 selects a plurality of input audio spectra Y necessary to combine the power spectrum P_{Yelse} of the non-combination direction other than a specific channel direction from the input audio spectra Y₁, Y₂, . . . , Y_{N} obtained in S62 (S64).

Further, the first combining unit 102 generates a combined audio spectrum Z(k) of the specific channel by combining the input audio spectra X and the combined audio spectra Y selected in S66 (S66). At this time, the omnidirectional power spectrum P_{Xall} is combined using the input audio spectra X, the power spectrum P_{Yelse} of the non-combination direction other than the specific channel direction from the combined audio spectra Y is combined, and a difference between P_{Xall} and P_{Yelse} is calculated. This combining process is also performed for every frequency component k (k=0, 1, . . . , L−1) of the input audio spectra X(k) and the combined audio spectra Y(k).

Thereafter, the time conversion unit 103 generates a combined audio signal z(n) of the time domain by performing time conversion (for example, inverse FFT) on a combined audio spectrum Z(k) of a specific channel (for example, SL or SR) combined in S66 and a combined audio spectrum Y(k) of a channel (for example, C, L, or R) other than the specific channel combined in S62 (S68). Further, the control unit 70 of the digital camera 1 records the combined audio signal z(n) on the recording medium 40 (S70). At this time, the combined audio signal z(n) or a moving image of another channel is also recorded on the recording medium 40 along with the combined audio signal z(n) of the above-described specific channel.

### [3.3.2. Operation of First Combining Unit]

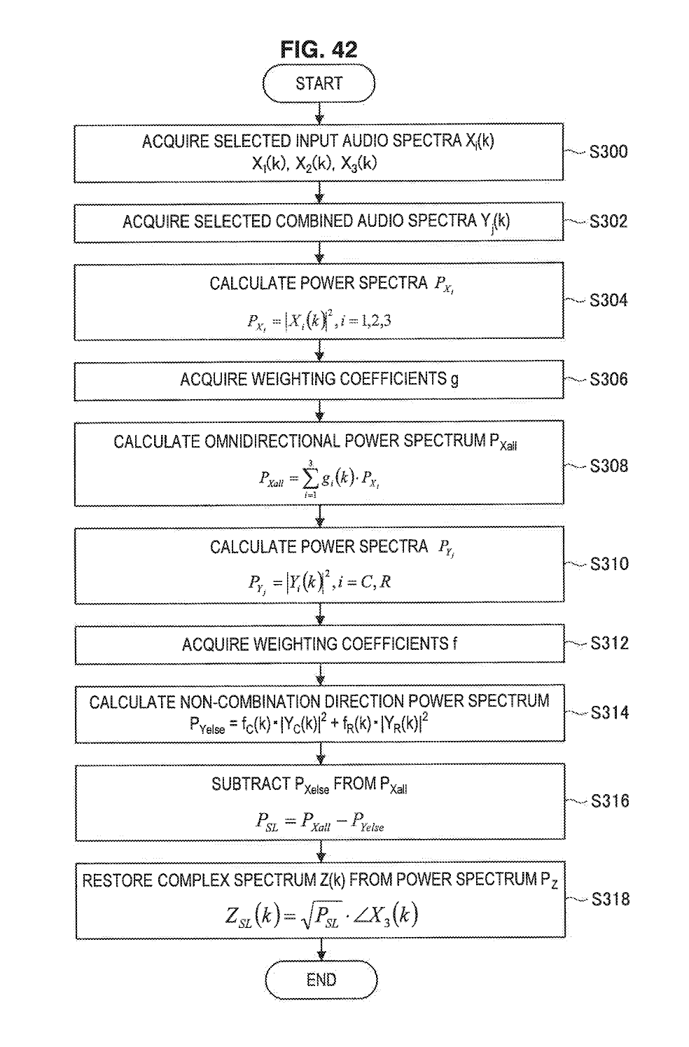

Next, with reference to FIG. 42, an operation (the first combining process S66 of FIG. 41) of the first combining unit 102SL for the SL channel according to the configuration example illustrated in FIG. 37 will be described in detail. FIG. 42 is a flowchart illustrating the operation of the first combining unit 102SL for the SL channel according to the present embodiment.

Also, a k^{th} frequency component x(k) of the input audio spectrum X will be described below, wherein frequency components up to k=0, 1, . . . , L−1 are present and all the frequency components are similarly processed. In addition, the second combining unit 122SL and the second combining unit 122SR are substantially the same except for different reference data. Because of this, only the operation of the second combining unit 122SL will be described and the operation of the second combining unit 122SR is also similar.

As illustrated in FIG. 42, first, the first combining unit 102SL acquires a plurality of input audio spectra X₁(k), X₂(k), and X₃(k) selected as the audio spectra of the combination target from the first input selection unit 101SL (S300). Further, the first combining unit 102SL acquires a plurality of combined audio spectra Y_{C}(k) and Y_{R}(k) selected as the audio spectra of the combination target from the first input selection unit 101SL (S302).

Then, the first combining unit 102SL calculates power spectra P_{X1}, P_{X2}, and P_{X3} of the input audio spectra X₁(k), X₂(k), and X₃(k) acquired in S300 (S304).

Further, the first combining unit 102SL acquires weighting coefficients g₁, g₂, and g₃ by which the power spectra g₁, g₂, and g₃ are multiplied to obtain the omnidirectional power spectrum P_{Xall} from the holding unit 107 (S306). Thereafter, the first combining unit 102SL calculates the omnidirectional power spectrum P_{Xall} by performing weighting addition on the power spectra P_{X1}, P_{X2}, and P_{X3} calculated in S304 using the weighting coefficients g₁, g₂, and g₃ acquired in S306 (S308).

Then, the first combining unit 102SL calculates power spectra P_{YC} and P_{YR} of the combined audio spectra Y_{C}(k) and Y_{R}(k) acquired in S302 (S310). Because Y is a complex spectrum (Y=a+j·b), it is possible to calculate P_{Y} from Y (P_{Y}=a²+b²).

Thereafter, the first combining unit 102SL acquires weighting coefficients f_{C} and f_{R} by which the power spectra P_{YC} and P_{YR} are multiplied to obtain the non-combination direction power spectrum P_{Yelse} from the holding unit 109 (S312).

Further, the first combining unit 102SL calculates the non-combination direction power spectrum P_{Yelse} by performing weighting addition on the power spectra P_{YC} and P_{YR} calculated in S310 using the weighting coefficients f_{C} and f_{R} acquired in S312 (S314),

Thereafter, the first combining unit 102SL subtracts the non-combination direction power spectrum P_{Xelse} obtained in S314 from the omnidirectional power spectrum P_{Xall} obtained in S308 (S316). According to this subtraction process, the power spectrum P_{SL} of the SL direction is obtained (P_{SL}=P_{Xall}−P_{Yelse}).

Further, the first combining unit 102SL restores the complex spectrum Z_{XL}(k) of the SL direction from the power spectrum P_{SL} of the SL direction obtained in S316 (S318). This restoration process is as described in the first embodiment (see S124 of FIG. 19).

The operation of the first combining unit 102 according to the third embodiment has been described above with reference to FIG. 42. Also, because operations of the second input selection unit 121, the second combining unit 122, and the first input selection unit 101 according to the third embodiment are similar to those of the above-described second embodiment, detailed description thereof will be omitted (see FIGS. 30, 31, and 32).

### 3.4 Specific Example

Next, a specific example of the arrangement of the microphones M when the audio signal processing device according to the third embodiment is applied to the video camera 7 will be described.

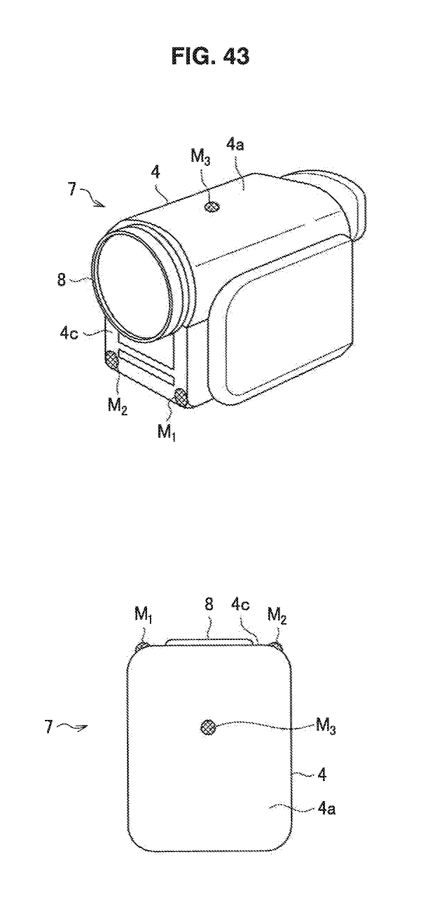

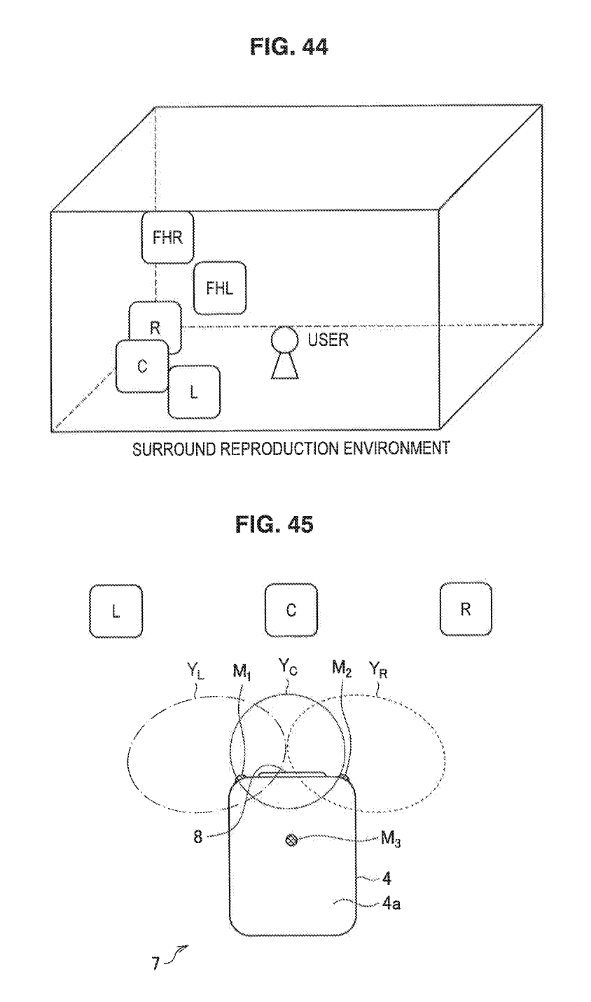

Here, an example in which the video camera 7 of the microphone arrangement illustrated in FIG. 43 performs surround sound recording and implements a surround reproduction environment illustrated in FIG. 44 will be described. FIG. 43 illustrates the video camera 7 on which three microphones M are arranged and FIG. 44 illustrates a three-dimensional surround reproduction environment.

As illustrated in FIG. 43, two microphones M₁ and M₂ are arranged on both the left and the right below a front surface 4c of the video camera 7 and one microphone M₃ is arranged on the center of a top surface 4a of the video camera 7. The lens 8 of the video camera 7 and the microphones M₁ and M₂ all face forward. In addition, in the surround reproduction environment illustrated in FIG. 44, speakers of the five channels arranged on the front left (L), the front center (C), a front right (R), a front high left (FHL), and a front high right (FHR) are installed with respect to the front direction of the user.

In this case, for the audio component of the low-frequency band (for example, less than 1000 Hz) in which no difference occurs in the input characteristics of the microphones M, it is possible to combine combined audio signals z_{C}, z_{L}, z_{R}, Z_{FHL}, and Z_{FHR} of five channels of C, L, R, FHL, and FHR using the input audio spectra X₁, X₂, and X₃ of the three microphones M₁, M₂, and M₃.

However, for the audio component of the intermediate/high-frequency frequency band (for example, 1000 Hz or more), a difference gradually occurs in the input characteristics of the microphones M₁, M₂, and M₃ because the microphones M₁, M₂, and M₃ have different installation surfaces. Because of this, it is difficult to generate a combined audio signal z having good directivity in the conventional technology for combining the input audio spectra X₁, X₂, and X₃ in the complex spectrum domain.

Therefore, for the audio component of the intermediate/high-frequency band, the combined audio signals z_{C}, z_{L}, and z_{R} having directivity of the C, L, and R directions are generated by combining the input audio spectra X₁ and X₂ of the two microphones M₁ and M₂, the input characteristics of which are consistent to a certain extent, in the complex spectrum domain (second directivity combining). On the other hand, for the combined audio signals z_{FHL} and z_{FHR} having directivity of the FHL and FHR directions, combination (first directivity combining) in the power spectrum domain is used. Hereinafter, a procedure of directivity combining in the intermediate/high-frequency band will be described.

First, as illustrated in FIG. 45, the second directivity combining unit 120 generates the combined audio spectra Y_{C}, Y_{L}, and Y_{R} having directivity of the C, L, and R directions by performing weighting addition on the input audio spectra X₁ and X₂ of the two front surface microphones M₁ and M₂.

Next, the combined audio spectrum Z_{FHL} of the FHL direction is combined. It is only necessary to exclude the audio components of the C and R directions from the omnidirectional power spectrum Pₐₗₗ so as to combine the combined audio spectrum Z_{FHL} of the FHL direction.

Specifically, first, the first directivity combining unit 112 generates the omnidirectional power spectrum Pₐₗₗ using the input audio spectrum X₃ of the microphone M₃. Here, Pₐₗₗ is obtained from only the input audio spectrum X₃ of the microphone M₃ without estimating Pₐₗₗ from the input audio spectra X₁, X₂, and X₃ of the microphones M₁, M₂, and M₃. Then, a power spectrum P_{FHLalse} of the non-combination direction other than the FHL direction is generated using the combined audio spectra Y_{C} and Y_{R} generated by the second directivity combining unit 120. Thereafter, the combined audio spectrum Z_{FHL} of the FHL direction is combined by subtracting the non-combination direction power spectrum P_{FHLalse} from the omnidirectional power spectrum Pₐₗₗ.

Further, the combined audio spectrum Z_{FHR} the FHR direction is combined. It is only necessary to exclude the audio components of the C and L directions from the omnidirectional power spectrum Pₐₗₗ so as to combine the combined audio spectrum Z_{FHL} of the FHR direction. Therefore, first, as in the above-described FHL, Pₐₗₗ is generated from the input audio spectrum X₃ of the microphone M₃. Then, a non-combination direction power spectrum P_{FHRalse} is generated using the combined audio spectra Y_{C} and Y_{L}. Thereafter, the combined audio spectrum Z_{FHR} of the FHR direction is combined by subtracting P_{FHRalse} from Pₐₗₗ.

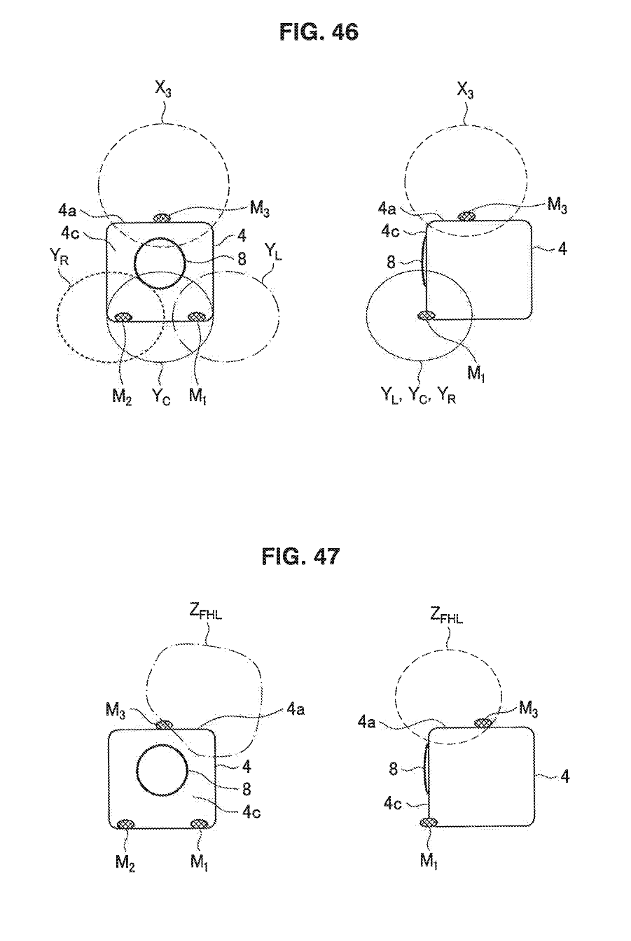

Here, with reference to FIGS. 46 and 47, the principle of the directivity combining of the F-IL direction in the above-described intermediate/high-frequency frequency band will be described. FIG. 46 illustrates input characteristics of the microphone M₃ (characteristics of the input audio spectrum X₃) and characteristics of combined audio spectra Y_{C}, Y_{L}, and Y_{R} in the directivity combining. In addition, FIG. 47 illustrates the characteristics of the combined audio spectrum Z_{FHL}.

As illustrated in FIG. 46, the microphones M₁ and M₂ are installed below the front surface of the video camera 7. Accordingly, combined audio spectra Y_{C}, Y_{L}, and Y_{R} generated by directivity combining from the input audio spectra X₁ and X₂ of the microphones M₁ and M₂ include a small number of upward audio components as compared to the input audio spectrum X₃ of the microphone M₃. On the other hand, although the input audio spectrum X₃ of the microphone M₃ includes a large number of upward audio components, it is difficult to identify characteristics of left and right directions from X₃.

Accordingly, it is possible to generate characteristics of the upward and left/right directions by combining the above-described Y_{C}, Y_{L}, Y_{R}, and X₃. Consequently, it is possible to combine the combined audio spectrum Z_{FHL} of the FHL direction diagonally upward to the left as illustrated in FIG. 47.

### 3.5. Advantageous Effects

The audio signal processing device and method according to the third embodiment have been described above in detail. According to the third embodiment, it is possible to obtain the following advantageous effects in addition to the advantageous effects of the above-described first and second embodiments.

According to the third embodiment, the first directivity combining in the power spectrum domain and the second directivity combining in the complex spectrum domain are properly used according to a frequency band. Thereby, it is possible to obtain an easy and appropriate directivity combining result in each frequency band and improve combination accuracy.

### 4. Fourth Embodiment

Next, the audio signal processing device and audio signal processing method according to the fourth embodiment of the present disclosure will be described. The fourth embodiment is characterized in that the audio spectra X and Y and the weighting coefficients g, f, and w to be used in the above-described first and second directivity combining are changed according to the surround reproduction environment selected by the user. Because the other functional configurations of the fourth embodiment are substantially the same as those of the above-described second and third embodiments, detailed description thereof will be omitted.

### 4.1. Outline of Fourth Embodiment

First, the outline of the audio signal processing device and method according to the fourth embodiment will be described.

In the normal surround sound collection, the number of channels of the surround reproduction environment is normally set to the specific number of channels, for example, 5.1 ch, and combined audio signals of the set 5.1 ch are combined and recorded. Then, when reproduction is performed in the surround reproduction environment of 2 ch, the combined audio signals of the 5.1 ch are down-mixed to combined audio signals of 2 ch for reproduction. In this manner, the number of channels of the surround sound recording is fixed in accordance with the number of channels of a main surround reproduction environment and the number of channels is generally not changed during the surround sound recording.

However, the surround reproduction environment has recently been diversified and variation of the number of channels has increased. Further, the user may adjust the number of channels or a speaker arrangement in accordance with his/her preference.

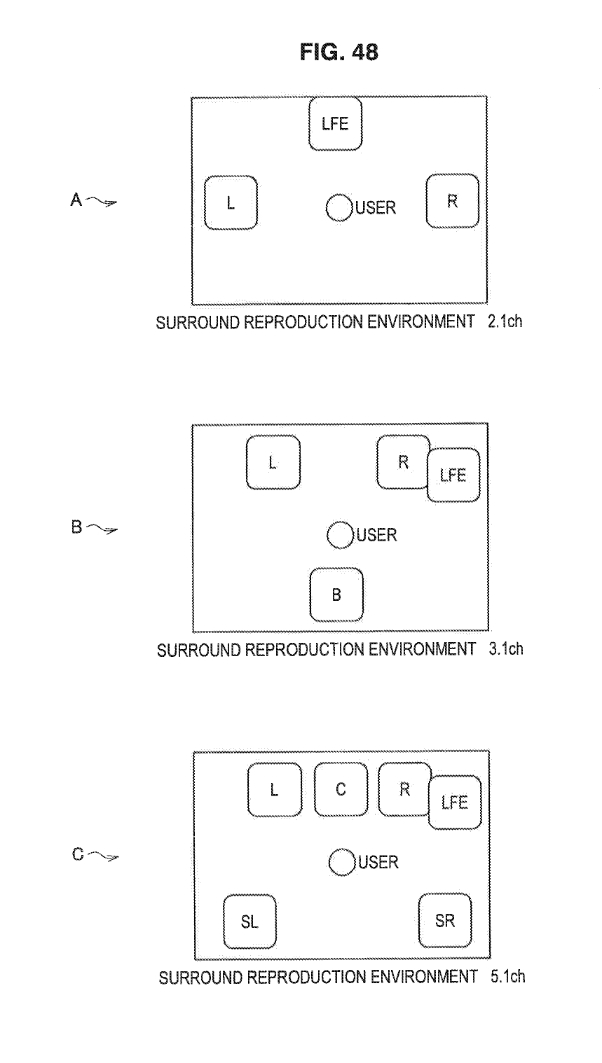

FIG. 48 is an explanatory diagram illustrating surround reproduction environments of 2.1 ch, 3.1 ch, and 5.1 ch. As illustrated in FIG. 48, the number of installed speakers or the speaker arrangement is different according to the number of channels of the surround reproduction environment. Because of this, it is desirable to generate combined audio in accordance with the number of channels of a user-desired surround reproduction environment during the surround sound reproduction using the sound recording device. For example, in the case of the 3.1-ch surround reproduction environment illustrated in FIG. 48B, it is desirable to generate and record combined audio signals of 3 channels+1 channel including L, R, back (B), and low-frequency effect (LFE).

Therefore, in view of the above-described circumstances, in the fourth embodiment, the user is allowed to select a surround reproduction environment during sound recording using the sound recording device. Then, the number of channels of the surround sound recording, that is, the number of channels of the recorded combined audio signal z, is variable according to the surround reproduction environment selected by the user.

Incidentally, because the input characteristics of the microphones M vary dependent upon the above-described arrangement of the microphones M, it is necessary to select (that is, select the audio spectra X and Y of the combination target) the microphones M to be used in directivity combining according to a directivity direction (combination direction) in which combination is desired. If the surround reproduction environment varies as described above, the number of combined audio signals to be generated during the surround sound recording or the directivity direction also varies. Because of this, it is necessary to change the microphones M to be used in the directivity combining of each channel according to the selected surround reproduction environment. In addition, it is also necessary to change the weighting coefficients g, f, and w to be used in the directivity combining according to the change in the microphone M to be selected.

Therefore, in the fourth embodiment, a control unit for controlling operations of the first directivity combining unit 112 and the second directivity combining unit 120 is provided. This control unit changes the audio spectra X and Y to be combined by the first directivity combining unit 112 and the second directivity combining unit 120 and various weighting coefficients g, f, and w to be used in a combining process according to the selected surround reproduction environment. Then, the directivity combining unit 112 and the second directivity combining unit 120 perform the above-described directivity combining process using the audio spectra X and Y and the weighting coefficients g, f, and w set by the control unit.

Thereby, it is possible to combine and record an appropriate combined audio signal according to the number of channels of the surround reproduction environment selected by the user. Hereinafter, the audio signal processing device and method according to the fourth embodiment for implementing the directivity combining as described above will be described.

### 4.2. Functional Configuration of Audio Signal Processing Device

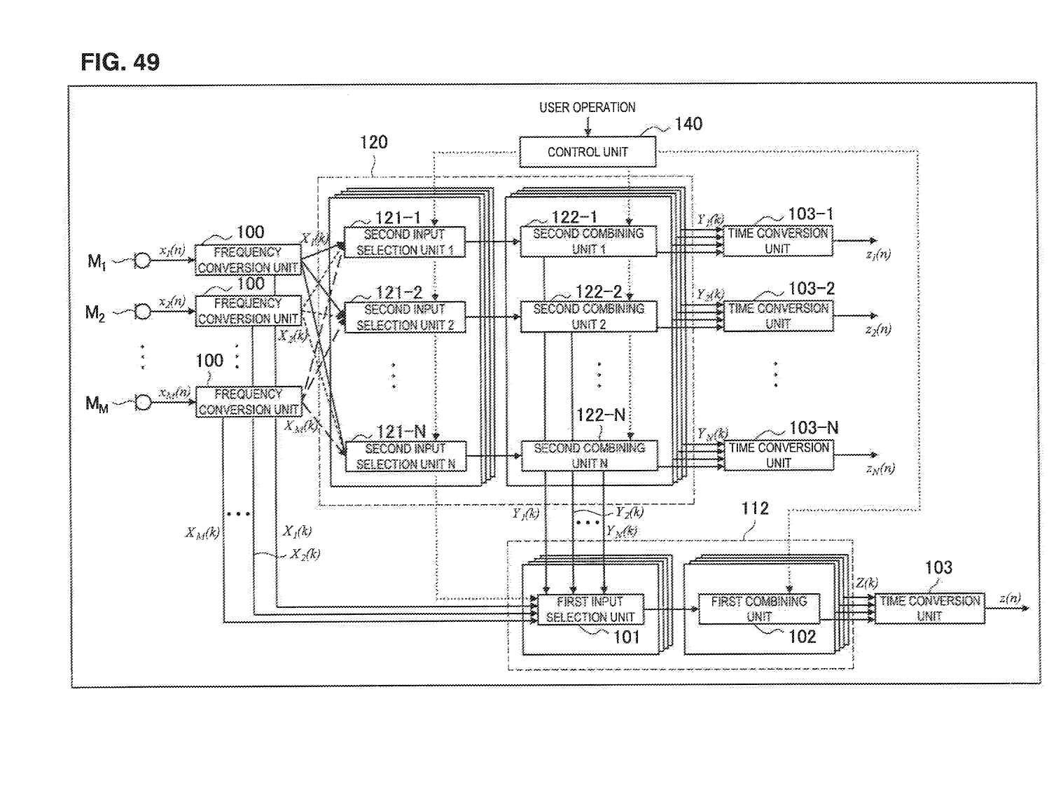

Next, with reference to FIG. 49, a functional configuration example of an audio signal processing device applied to the digital camera 1 according to the fourth embodiment will be described. FIG. 49 is a block diagram illustrating a functional configuration of the audio signal processing device according to the fourth embodiment.

As illustrated in FIG. 49, the audio signal processing device according to the fourth embodiment includes M microphones M₁, M₂, . . . , M_{M}, M frequency conversion units 100, a first input selection unit 101, a first combining unit 102, a time conversion unit 103, N second input selection units 121-1 to 121-N, N second combining units 122-1 to 122-N, N time conversion units 103-1 to 103-N, and a control unit 140. Also, M is the number of installed microphones and N is the number of channels of the surround reproduction environment. In addition, the control unit 140 may also be used as the control unit 70 of the digital camera 1 illustrated in FIG. 12.

As can be seen from FIG. 49, the audio signal processing device according to the fourth embodiment further includes the control unit 140 in addition to the constituent elements of the audio signal processing device (see FIGS. 22 and 34) according to the above-described second and third embodiments. The fourth embodiment is characterized in that the control unit 140 switches operations of the first input selection unit 101, the first combining unit 102, the second input selection unit 121, and the second combining unit 122 according to the surround reproduction environment selected by the user. Because the other functional configurations according to the fourth embodiment are substantially the same as those of the above-described second and third embodiments, detailed description thereof will be omitted.

As illustrated in FIG. 49, the control unit 140, for example, sets the surround reproduction environment according to the user's selection, and controls the first input selection unit 101, the first combining unit 102, the second input selection unit 121, and the second combining unit 122 based on the surround reproduction environment.

In the present embodiment, combination directions (such as L and R directions) of combined audio spectra Z₁, Z₂, . . . , Z_{N} correspond to channels of the surround reproduction environment. Then, the user can select the number of channels of the surround reproduction environment, that is, the number of channels to be used for surround sound recording.

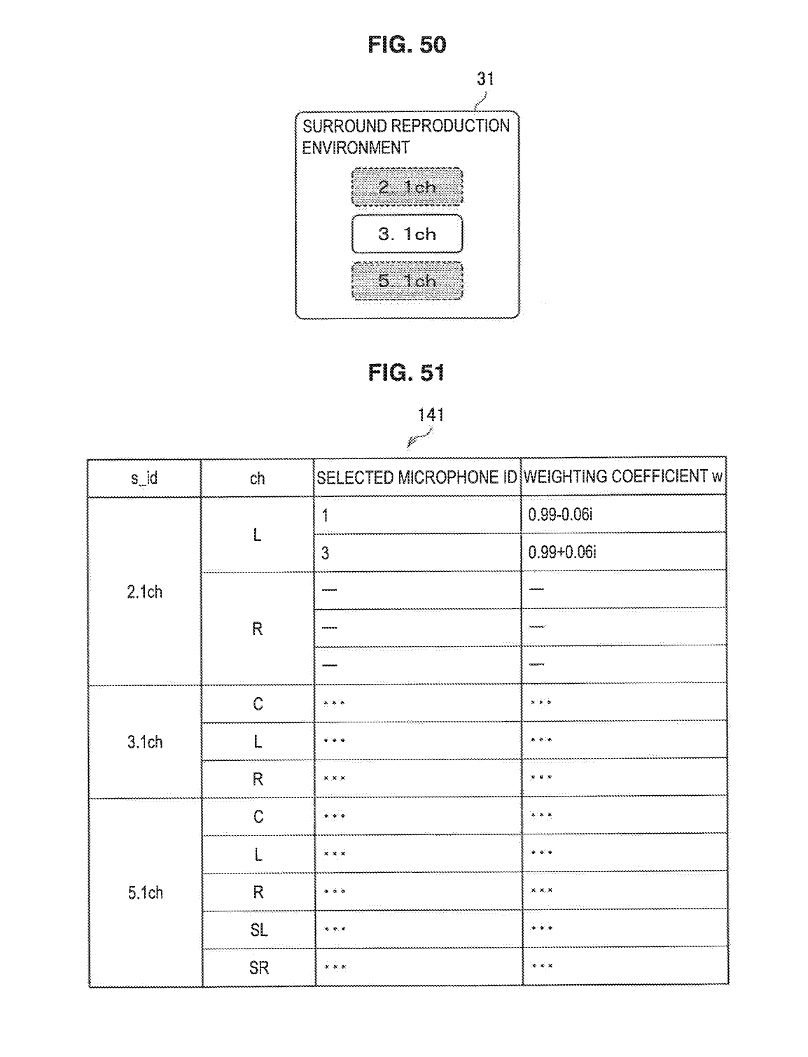

FIG. 50 illustrates a GUI screen 31 for allowing the user to select a surround reproduction environment. As illustrated in FIG. 50, for example, the GUI screen is displayed on the display unit 30 of the digital camera 1 at the initiation of surround sound recording. On the GUI screen 31, selectable surround reproduction environments (2.1 ch, 3.1 ch, and 5.1 ch) are displayed. The user can select a desired surround reproduction environment on the GUI screen 31 by operating the operation unit 80 (such as a dial, a key, or a touch panel) of the digital camera 1. In the illustrated example, the surround reproduction environment of 3.1 ch is selected.

Upon receiving the user's operation of selecting the surround reproduction environment, the control unit 140 controls the above-described units to combine a combined audio spectrum Z corresponding to each channel of the surround reproduction environment selected by the user.

In detail, the control unit 140 controls the input audio spectra X or Y to be selected by the first input selection unit 101 or the second input selection unit 121, the weighting coefficients g, f, and w to be used by the first combining unit 102 and the second combining unit 122, or the like to be changed according to the surround reproduction environment. Because of this, the control unit 140 notifies the first input selection unit 101, the second input selection unit 121, the first combining unit 102, and the second combining unit 122 of the identification information (for example, s_id to be described later) representing the surround reproduction environment selected by the user. The first input selection unit 101, the second input selection unit 121, the first combining unit 102, and the second combining unit 122 switch processing content of the above-described directivity combining based on the identification information representing the surround reproduction environment of the notification provided from the control unit 140.

Specifically, the first input selection unit 101 changes an audio spectrum X to be selected as the combination target by the first combining unit 102 from a plurality of input audio spectra X according to the above-described surround reproduction environment. The first input selection unit 101 holds an ID sequence (selected microphone IDs) representing the microphones M to be selected for every surround reproduction environment in the holding unit 105 (see FIG. 14). The first input selection unit 101 selects input audio spectra X of the microphones M necessary to combine the omnidirectional power spectrum Pₐₗₗ or the non-combination direction power spectrum Pₑₗₛₑ suitable for the surround reproduction environment based on the selected microphone IDs.

In addition, the first combining unit 102 changes the weighting coefficient g to be used when performing weighting addition on power spectra P of a plurality of audio spectra X and Y selected by the first input selection unit 101 according to the above-described surround reproduction environment. The first combining unit 102 holds the weighting coefficients g and f set for every surround reproduction environment in the holding units 107 and 109 (see FIG. 15). The first combining unit 102 combines the omnidirectional power spectrum Pₐₗₗ or the non-combination direction power spectrum Pₑₗₛₑ suitable for the surround reproduction environment by performing weighting addition on the input audio spectra X using the weighting coefficients g and f.

Further, the second input selection unit 121 changes an audio spectrum X to be selected as the combination target by the second combining unit 122 from a plurality of input audio spectra X according to the above-described surround reproduction environment. The second input selection unit 121 holds an ID sequence (selected microphone IDs) representing the microphones M to be selected for every channel of the surround reproduction environment in the holding unit 124 (see FIG. 23). The second input selection unit 121 selects input audio spectra X of the microphones M necessary to combine the combined audio spectrum Y of each of channels of the surround reproduction environment based on the selected microphone IDs.

The second combining unit 122 changes the weighting coefficients w to be used when performing weighting addition on a plurality of audio spectra selected by the second input selection unit 121 according to the above-described surround reproduction environment. The second combining unit 122 holds the weighting coefficients w set for every surround reproduction environment in the holding unit 126 (see FIG. 24). The second combining unit 122 combines the combined audio spectra Y of each channel of the surround reproduction environment by performing weighting adding on the input audio spectra X using the weighting coefficients w.

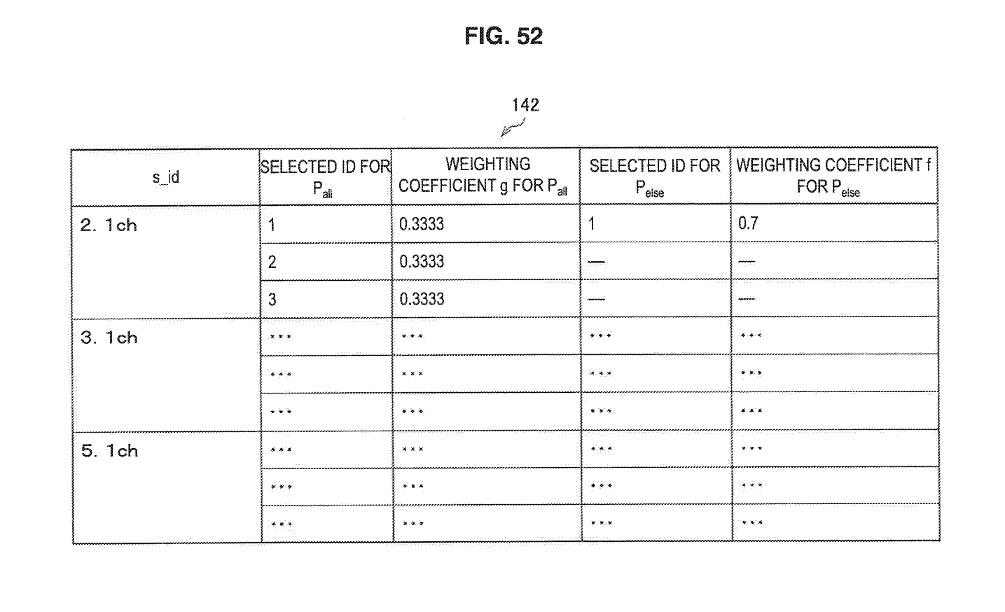

Here, with reference to FIGS. 51 and 52, the ID sequences and the weighting coefficients g, f, and w set for every surround reproduction environment will be described. FIG. 51 illustrates the ID sequences and the weighting coefficients w held by the holding units 124 and 126 of the second directivity combining unit 120.

As illustrated in FIG. 51, a table of environment setting information 141 is held in the holding units 124 and 126 of the second directivity combining unit 120. In the table of the environment setting information 141, identification information s_id representing the surround reproduction environment, a channel ID, a selected microphone ID, and a weighting coefficient w are associated and described.

The channel ID is an ID for identifying a plurality of channels of the surround reproduction environment. For example, when the surround reproduction environment is 2.1 ch, two channel IDs of the L channel and the R channel are described.

The selected microphone ID) is an ID of a microphone which is selected to combine the combined audio spectra Y of each channel of the surround reproduction environment by the second input selection unit 121. For example, microphone IDs are microphone Nos. 1, 2, 3, . . . and the like uniquely assigned to the microphones M₁, M₂, M₃, . . . .

As described above, the microphones M to be used to combine the combined audio spectra Y having directivity of a certain channel vary with the entire surround reproduction environment (for example, 2.1 ch, 3.1 ch, or the like). For example, the case in which two microphones M₁ and M₃ among the above-described microphones M₁, M₂, M₃, . . . are selected to generate a combined audio spectrum Y_{L} of L ch in the 2.1-ch reproduction environment is considered. That is, a second combining unit 122_{L} for L ch may generate the combined audio spectrum Y_{L} of L ch by combining the input audio spectra X₁ and X₃ of the microphones M₁ and M₃ in the complex spectrum domain. In this case, as illustrated in FIG. 51, IDs (microphone Nos.=1 and 3) of the microphones M₁ and M₃ are described as the selected microphone IDs of L ch in 2.1 ch.

In addition, the weighting coefficient w illustrated in FIG. 51 is a coefficient by which the input audio spectrum X of the microphone M selected by the above-described selected microphone ID is multiplied when the second combining unit 122 combines the combined audio spectrum Y. Because the input audio spectrum X is a complex spectrum, the weighting coefficient w is also a complex number. An extent to which weighting is performed on the input audio spectrum X of the microphone M selected by the above-described second input selection unit 121 also varies with the surround reproduction environment. Therefore, the weighting coefficient w is also set for every channel of the surround reproduction environment.

As described above, it is noted that the second input selection unit 121 and the second combining unit 122 are provided for every frequency component k. Therefore, data held by the table of the environment setting information 141 in FIG. 51 is a selected microphone ID and the coefficient w to be used at a time of certain frequency component k, and data of the selected microphone ID and the coefficient w may be changed for other frequency components.

In addition, because the second directivity combining unit 120 in the example of FIG. 51 does not perform directivity combining of R ch of 2.1 ch, the selected microphone ID of R ch is not described. When the second directivity combining unit 120 also performs directivity combining of R ch, the selected microphone ID, the weight w and the like of R ch are set as in the above-described L ch. In addition, even in the cases of the 3.1 ch and 5.1 ch, the selected microphone ID and the coefficient w are set as in the above-described case of 2.1 ch.

In addition, FIG. 52 illustrates ID sequences and weighting coefficients g and f held by the holding units 105, 107, and 109 of the first directivity combining unit 112. As illustrated in FIG. 52, a table of environment setting information 142 is held in the holding units 105, 107, and 109 of the first directivity combining unit 112. In the table of the environment setting information 142, identification information s_id representing the surround reproduction environment, a channel ID, a selected ID and a weighting coefficient g for Pₐₗₗ, and a selected ID and a weighting coefficient f for Pₑₗₛₑ are associated and described.

The selected ID for Pₐₗₗ is an ID of the microphone M selected to combine the omnidirectional power spectrum Pₐₗₗ by the first combining unit 102. In order to combine Pₐₗₗ, some microphones M among the M microphones M₁, M₂, . . . , M_{M} are selected. In the illustrated example, the surround reproduction environment of 2.1 ch is configured so that the microphones M₁, M₂, and M₃ are selected and the omnidirectional power spectrum Pₐₗₗ is generated by combining input audio spectra X₁, X₂, and X₃ of the microphones M₁, M₂, and M₃.

The weighting coefficient g for Pₐₗₗ is a coefficient by which the input audio spectrum X of the microphone M selected by the above-described selected ID is multiplied when the first combining unit 102 combines the omnidirectional power spectrum Pₐₗₗ. In the illustrated example, the input audio spectra X₁, X₂, and X₃ of the microphones M₁, M₂, and M₃ are multiplied by the coefficient g of an equal value (=0.333 . . . ).

The selected microphone ID for Pₑₗₛₑ is an ID of an output of the second combining unit 122 selected for the first combining unit 102 to combine a non-combination direction power spectrum Pₑₗₛₑ. In order to combine Pₑₗₛₑ, some of the combined audio spectra Y₁, Y₂, . . . , Y_{N} output from the N second combining units 122 are selected. In the illustrated example, in the 2.1-ch surround reproduction environment, the non-combination direction power spectrum Pₑₗₛₑ is generated from the combined audio spectrum Y₁ of the second combining unit 122-1 to which the selected ID=1 is assigned.

The weighting coefficient f for Pₑₗₛₑ is a coefficient by which the audio spectra X and Y selected by the above-described selected ID is multiplied when the first combining unit 102 combines the non-combination direction power spectrum Pₑₗₛₑ. In the illustrated example, the combined audio spectrum Y₁ of the second combining unit 122-1 is multiplied by a coefficient f(=0.7).

As described above, it is noted that the first input selection unit 101 and the first combining unit 102 are provided for every frequency component k. Therefore, data held by the table of the environment setting information 142 in FIG. 52 is a selected ID and the coefficient g and f to be used at a time of certain frequency component k, and data of the selected ID and the coefficient w may be changed for other frequency components.

Hereinafter, for example, an example in which the second combining unit 122-1 performs directivity combining of the L channel and the first combining unit 102 performs directivity combining of the R channel when the surround reproduction environment is 2.1 ch will be described.

### 4.3. Audio Signal Processing Method

Next, the audio signal processing method (directivity combining method) according to the audio signal processing device according to the fourth embodiment will be described.

Also, because the overall operation of the audio signal processing device according to the fourth embodiment is similar to those of the above-described second and third embodiments (see FIGS. 29 and 41), the illustration of the overall flow will be omitted. However, when the user selects a desired surround reproduction environment before the initiation of a sound collection process (S30 of FIG. 29 and S50 of FIG. 41) by the microphone M in the fourth embodiment, the control unit 140 notifies each unit of the first directivity combining unit 112 and the second directivity combining unit 120 of the surround reproduction environment. Then, each unit switches the directivity combining process (the selected audio spectrum and the weighting coefficients w, g, and f according to the surround reproduction environment.

### [4.3.1. Operation of Second Input Selection Unit]

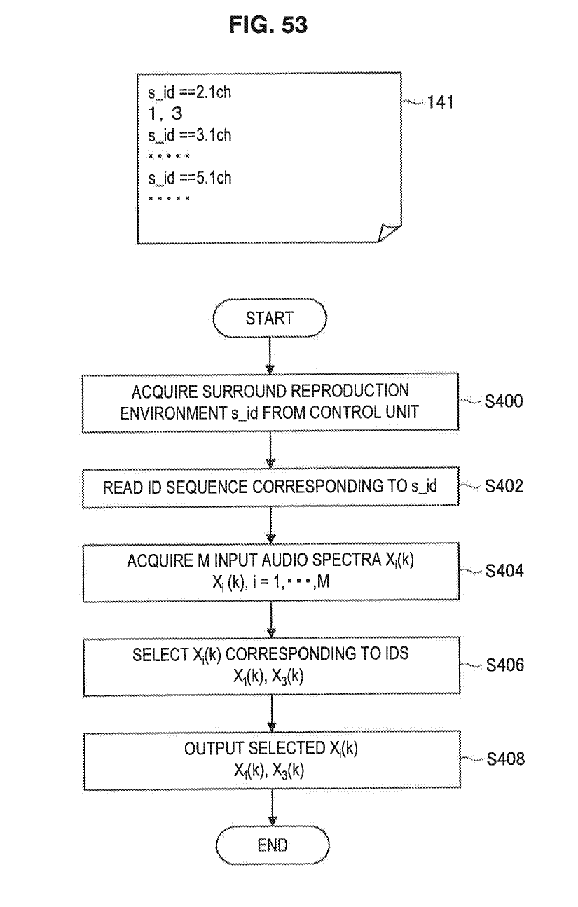

Next, with reference to FIG. 53, the operation of the second input selection unit 121 according to the present embodiment will be described. FIG. 53 is a flowchart illustrating an operation of the second input selection unit 121 according to the present embodiment.

As illustrated in FIG. 53, the second input selection unit 121 acquires s_di representing a surround reproduction environment from the control unit 140 (S400). Then, the second input selection unit 121 reads an ID sequence of selected microphone IDs corresponding to s_id from the table of the environment setting information 141 held in the holding unit 124 (S402). In the environment setting information 141 illustrated in FIGS. 51 and 53, when the surround reproduction environment is 2.1 ch (s_id=2.1 ch), the selection of the microphones M₁ and M₃ for directivity combining of the L channel is prescribed (selected microphone ID=1 and 3).

Then, the second input selection unit 121 acquires the M input audio spectra X₁, X₂, . . . , X_{M} output from the frequency conversion unit 100 (S404). Further, the second input selection unit 121 selects the input audio spectra X₁ and X₃ of the microphones M₁ and M₃ corresponding to the selected microphone IDs acquired in S402 from among the input audio spectra X₁, X₂, . . . , X₁ acquired in S404 (S406). Thereafter, the second input selection unit 121 outputs the input audio spectra X₁ and X₃ selected in S406 to the second combining unit 122 (S408).

Thereby, the second input selection unit 121 appropriately selects the input audio spectrum X for combining the combined audio spectrum Y according to the surround reproduction environment of the notification provided from the control unit 140.

### [4.3.2. Operation of Second Combining Unit]

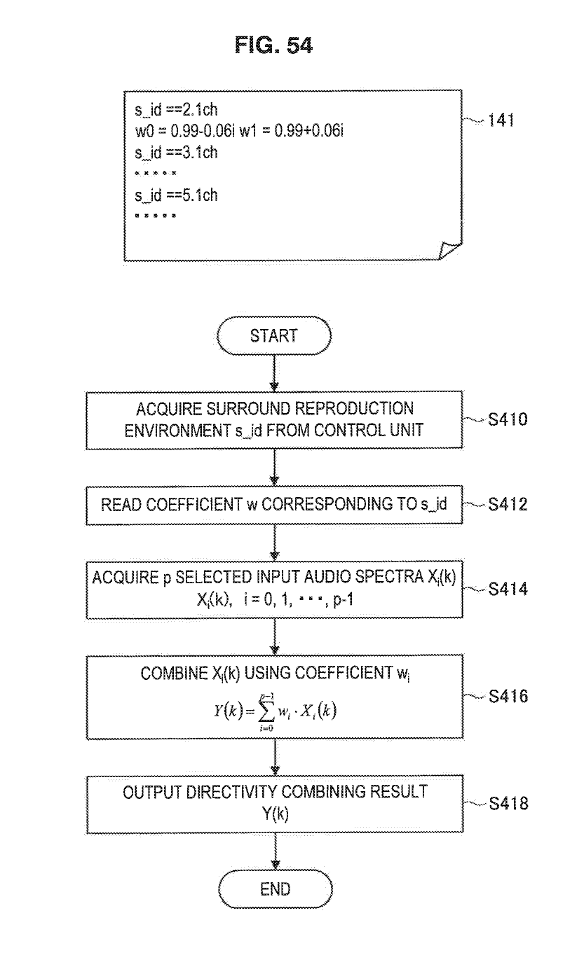

Next, with reference to FIG. 54, an operation of the second combining unit 122 according to the present embodiment will be described. FIG. 54 is a flowchart illustrating an operation of the second combining unit 122 according to the present embodiment.

As illustrated in FIG. 54, first, the second combining unit 122 acquires s_id representing the surround reproduction environment from the control unit 140 (S410). Then, the second combining unit 122 reads a weighting coefficient w corresponding to s_id from the table of the environment setting information 141 held in the holding unit 126 (S412). In the environment setting information 141 illustrated in FIGS. 51 to 54, when the surround reproduction environment is 2.1 ch (s_id=2.1 ch), weighting coefficients w₀ and w₁ by which the input audio spectra X₁ and X₃ of the microphones M₁ and M₃ are multiplied are prescribed to be “0.99-0.06i” and “0.99+0.06i.”

Then, the second combining unit 122 acquires the input audio spectra X₁ and X₃ of the microphones M₁ and M₃ selected by the above-described second input selection unit 121 (S414). Further, the second combining unit 122 combines the combined audio spectrum Y_{L} of the L channel by performing weighting adding on the input audio spectra X₁ and X₃ acquired in S414 using weighting coefficients w₀ and w₁ acquired in S412 (S416).

Thereafter, the second combining unit 122 outputs the combined audio spectrum Y_{L} of the L channel which is the combination result of S416 to the first input selection unit 101 (S418).

Through the above, the second combining unit 122 combines the combined audio spectrum Y_{L} of the L channel using the appropriate weighting coefficients w₀ and w₁ according to the surround reproduction environment of the notification provided from the control unit 140.

### [4.3.3. Operation of First Input Selection Unit]

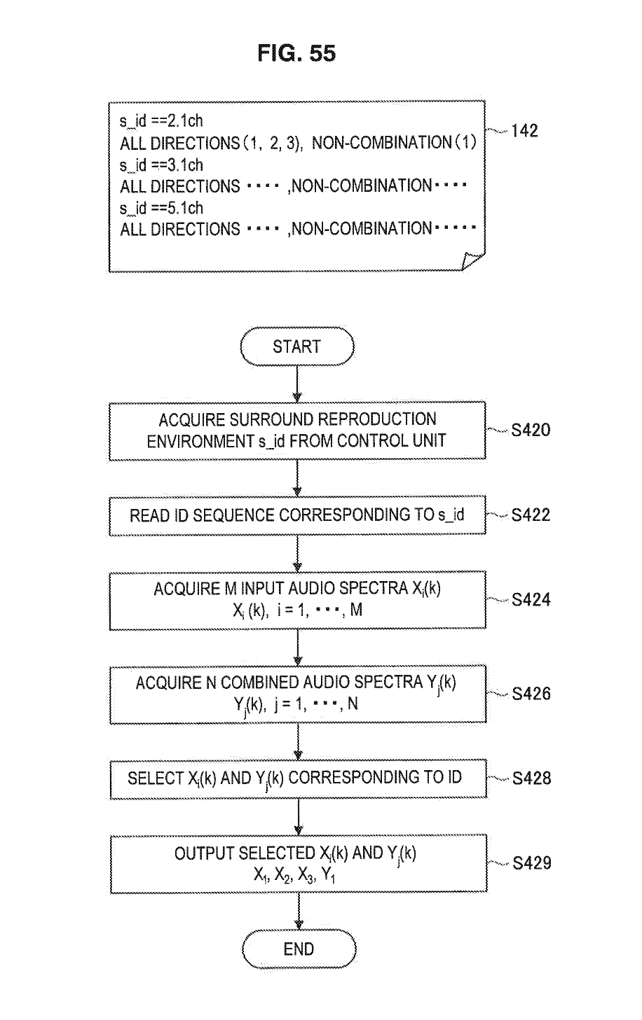

Next, with reference to FIG. 55, the operation of the first input selection unit 101 according to the present embodiment will be described. FIG. 55 is a flowchart illustrating an operation of the first input selection unit 101 according to the present embodiment.

As illustrated in FIG. 55, first, the first input selection unit 101 acquires s_id representing the surround reproduction environment from the control unit 140 (S420). Next, the first input selection unit 101 reads an ID sequence of selection IDs corresponding to s_id from the table of the environment setting information 142 held in the holding unit 105 (S422). In the environment setting information 142 illustrated in FIGS. 52 and 55, when the surround reproduction environment is 2.1 ch (s_id=2.1 ch), a process of selecting the microphones M₁, M₂, and M₃ for the omnidirectional power spectrum Pₐₗₗ (selected ID=1, 2, and 3) and selecting an output (selected ID=1) of the second combining unit 122-1 for the non-combination direction power spectrum Pₑₗₛₑ is prescribed.

Then, the first input selection unit 101 acquires M input audio spectra X₁, X₂, . . . , X_{M} output from the frequency conversion units 100 (S424). Further, the first input selection unit 101 acquires N combined audio spectra Y₁, Y₂, . . . , Y_{N} output from the N second combining units 122-1 to 122-N (S426).

Then, the first input selection unit 101 selects audio spectra X₁, X₂, X₃, and Y₁ corresponding to the selected IDs acquired in S422 from among the input audio spectra X₁, X₂, . . . , X_{M} and the combined audio spectra Y₁, Y₂, . . . , Y_{N} acquired in S424 and S426 (S428). Thereafter, the first input selection unit 101 outputs the audio spectra X₁, X₂, X₃, and Y₁ selected in S406 to the first combining unit 102 (S429).

Thereby, the first input selection unit 101 appropriately selects the audio spectra X and Y for combining the omnidirectional power spectrum Pₐₗₗ and the non-combination direction power spectrum Pₑₗₛₑ according to the surround reproduction environment of the notification provided from the control unit 140.

### [4.3.4. Operation of First Combining Unit]

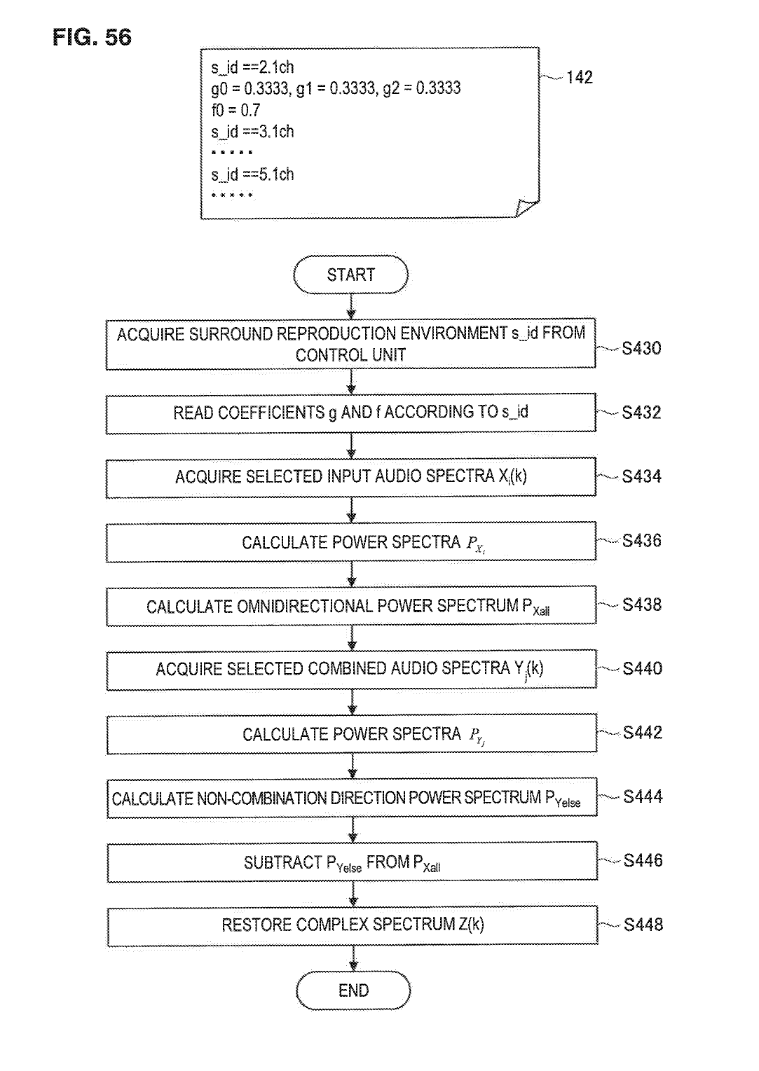

Next, with reference to FIG. 56, the operation of the first combining unit 102 according to the present embodiment will be described. FIG. 56 is a flowchart illustrating the operation of the first combining unit 102 according to the present embodiment.

As illustrated in FIG. 56, first, the first combining unit 102 acquires s_id representing the surround reproduction environment from the control unit 140 (S430). Then, the first combining unit 102 reads weighting coefficients gi and fi corresponding to s_id from the table of the environment setting information 142 held in the holding units 107 and 109 (S432). In the environment setting information 142 illustrated in FIGS. 52 and 56, when the surround reproduction environment is 2.1 ch (s_id=2.1 ch), weighting coefficients g₀, g₁, and g₂ by which the power spectra P_{X1}, P_{X2}, and P_{X3} of the input audio spectra X₁, X₂, and X₃ are multiplied and a weighting coefficient f₀ by which the power spectrum P_{Y1} of the combined audio spectrum Y₁ is multiplied are prescribed.

Then, the first combining unit 102 acquires the input audio spectra X₁, X₂, and X₃ of the microphones M₁, M₂, and M₃ selected by the above-described first input selection unit 101 (S434). Further, the first combining unit 102 calculates each of the power spectra P_{X1}, P_{X2}, and P_{X3} of the input audio spectra X₁, X₂, and X₃ (S436). Thereafter, the first combining unit 102 calculates the omnidirectional power spectrum P_{Xall} by performing weighting addition on the power spectra P_{X1}, P_{X2}, and P_{X3} using the weighting coefficients g₀, g₁, and g₂ acquired in S432 (S438).

Further, the first combining unit 102 acquires the combined audio spectrum Y₁ selected by the above-described first input selection unit 101 (S440). Further, the first combining unit 102 calculates a power spectrum P_{Y1} of the combined audio spectrum Y₁ (S442). Thereafter, the first combining unit 102 calculates the non-combination direction power spectrum P_{Yelse} by performing weighting addition on the power spectrum P_{Y1} using the weighting coefficient f₀ acquired in S432 (S444).

Thereafter, the first combining unit 102 generates a power spectrum P_{R} of the R channel by subtracting the non-combination direction power spectrum P_{Yelse} from the omnidirectional power spectrum P_{Xall} (S446). Further, the first combining unit 102 restores a combined audio spectrum Z_{R} (complex spectrum) of the R channel from the power spectrum P_{R} obtained in S446 (S448).

Through the above, the first combining unit 102 combines the combined audio spectrum Z_{R(k)} of the R channel using the appropriate weighting coefficients g₀, g₁ and f₀ according to the surround reproduction environment of the notification provided from the control unit 140.

### 4.4. Advantageous Effects

The audio signal processing device and method according to the fourth embodiment have been described above in detail. According to the fourth embodiment, it is possible to obtain the following advantageous effects in addition to the advantageous effects of the above-described first to third embodiments.

According to the fourth embodiment, the control unit 140 controls the first directivity combining unit 112 and the second directivity combining unit 120 so that the audio spectrum or the weighting coefficient for use in directivity combining is switched according to the surround reproduction environment selected by the user. Thereby, it is possible to perform directivity combining suitable for the surround reproduction environment and suitably generate and record the combined audio signal z corresponding to each channel of the surround reproduction environment.

Accordingly, it is possible to smoothly cope with a change in the surround reproduction environment because it is possible to perform surround recording corresponding to the surround reproduction environment. Accordingly, the user can select a desired surround reproduction environment and obtain a combined audio signal z suitable for the channel of the surround reproduction environment.

### 5. Fifth Embodiment

Next, the audio signal processing device and the audio signal processing method according to the fifth embodiment of the present disclosure will be described. The fifth embodiment is characterized in that directivity combining, which is difficult to implement with only the built-in microphone M, is implemented by mounting an external microphone on a sound recording device. Because other functional configurations of the fifth embodiment are substantially the same as those of the above-described third embodiment, detailed description thereof will be omitted.

### 5.1. Outline of Fifth Embodiment

First, the outline of the audio signal processing device and method according to the fifth embodiment will be described.

Examples in which all the microphones M are built-in microphones (internal microphones) have been described in the above-described first to fourth embodiments. Because the built-in microphone is a microphone pre-installed in the sound recording device and is fixed within the housing 4 of the sound recording device, it is difficult to detach the built-in microphone.

On the other hand, in the fifth embodiment, combined audio having directivity that is difficult to implement with only the built-in microphone is generated using an external microphone in addition to the above-described built-in microphone. The external microphone is a microphone (externally attached microphone) additionally installed later for a sound recording device, and is detachable from the housing 4 of the sound recording device. Although a mounting position of the external microphone may be an arbitrary position of the housing 4, it is preferable that the mounting position of the external microphone be a position separated from another built-in microphone in view of obtaining input characteristics of various directions as will be described later.

In the fifth embodiment, a plurality of built-in microphones are eccentrically arranged on one side of the housing 4 of the sound recording device, and at least one external microphone is arranged on the other side of the housing 4. According to an influence of an arrangement of the built-in microphones and the external microphone for the housing 4, input characteristics among the built-in microphones and the external microphone differ. An objective of the fifth embodiment is to obtain combined audio having directivity of a direction in which combination is difficult in only the built-in microphones using a difference in the input characteristics

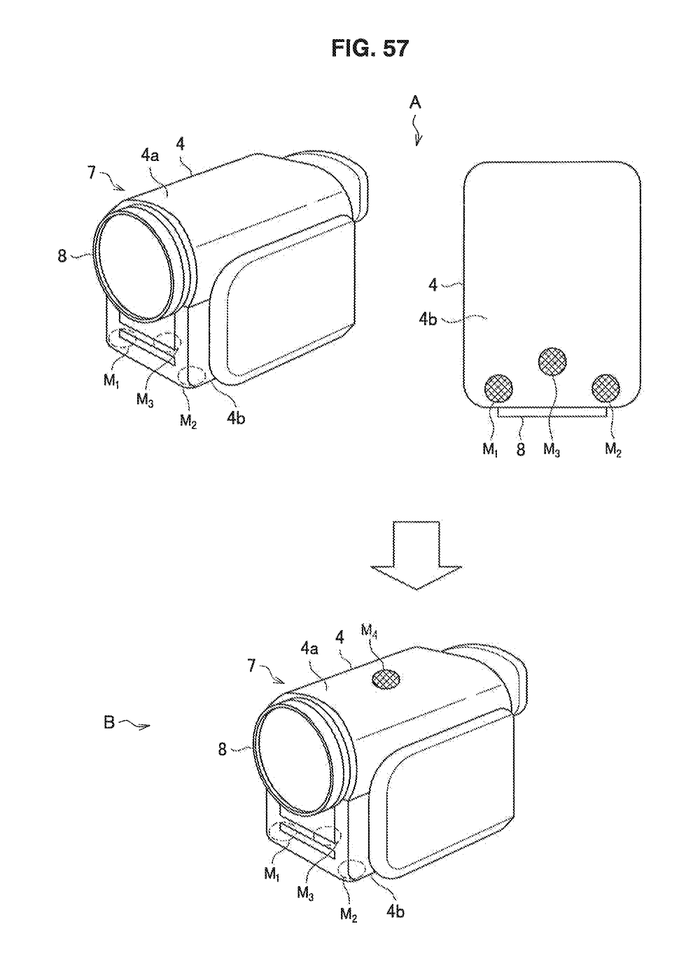

Here, with reference to FIG. 57, a specific example of the arrangement of the microphones M according to the fifth embodiment will be described. FIG. 57 is an explanatory diagram illustrating a video camera 7 on which the built-in microphones M₁, M₂, and M₃ and the external microphone M₄ are installed according to the present embodiment.

As illustrated in FIG. 57A, the three built-in microphones M₁, M₂, and M₃ are installed on a bottom surface 4b of the housing 4 of the video camera 7. On the bottom surface 4b of the camera front side (the side of the lens 8), the built-in microphones M₁, M₂, and M₃ are arranged at positions of vertices of a triangle.

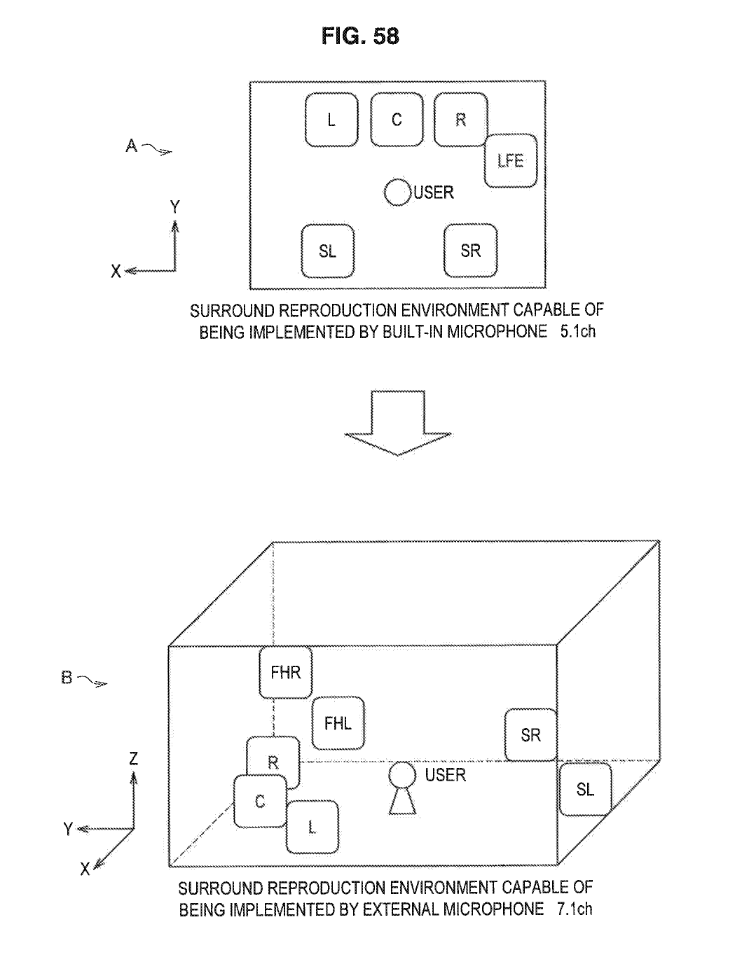

When the built-in microphones M₁, M₂, and M₃ are eccentrically arranged on the front side of the bottom surface 4b of the video camera 7 in this manner, it is difficult to obtain input characteristics of upward/downward directions of the video camera 7 even when it is possible to obtain the input characteristics of the forward/backward direction and the left/right direction of the video camera 7 using the built-in microphones M₁, M₂, and M₃. Accordingly, although it is possible to implement the 5.1-ch surround reproduction environment (C, L, R, SL, SR, and LFE) illustrated in FIG. 58A by combining input audio obtained by the built-in microphones M₁, M₂, and M₃, it is difficult to implement the 7.1-ch surround reproduction environment including FHL and FHR illustrated in FIG. 58B.

Therefore, in the present embodiment, as illustrated in FIG. 57B, an external microphone M₄ is additionally installed on a top surface 4a of the housing 4 of the video camera 7 and information of an audio component of the upward/downward direction is also obtained according to the external microphone M₄. Then, directivity combining of the 7.1-ch surround reproduction environment illustrated in FIG. 58B is implemented using the input audio from the external microphone M₄. Also, the built-in microphones M₁, M₂, and M₃ and the external microphone M₄ are configured by omnidirectional microphones.

Incidentally, as described above, the external microphone M₄ arranged on the top surface 4a are separated from the built-in microphones M₁, M₂, and M₃ arranged on the bottom surface 4b in the upward/downward direction and the housing 4 is located among the external microphone M₄ and the built-in microphones M₁, M₂, and M₃. Accordingly, the input characteristics become significantly different among the external microphone M₄ and the built-in microphones M₁, M₂, and M₃.

When the input characteristics are different in this manner, it is difficult to use the input audio signal x₄ of the external microphone M₄ for the above-described reason in the directivity combining method in the conventional complex spectrum domain. That is, it is difficult to obtain a good directivity combining result even when the input audio signal x₄ of the external microphone M₄ is combined in the complex spectrum domain along with the input audio signals x₁, x₂, and x₃ of the other microphones M₁, M₂, and M₃,

Therefore, in the fifth embodiment, the first directivity combining unit 112 obtains the power spectrum of the input audio signal x₄ of the external microphone M₄, and calculates the input audio in the power spectrum domain. Thereby, it is possible to implement the 7.1-ch surround reproduction environment illustrated in FIG. 58B because it is possible to appropriately perform directivity combining on the input audio of the external microphone M₄ and the built-in microphones M₁, M₂, and M₃.

### 5.2. Functional Configuration of Audio Signal Processing Device

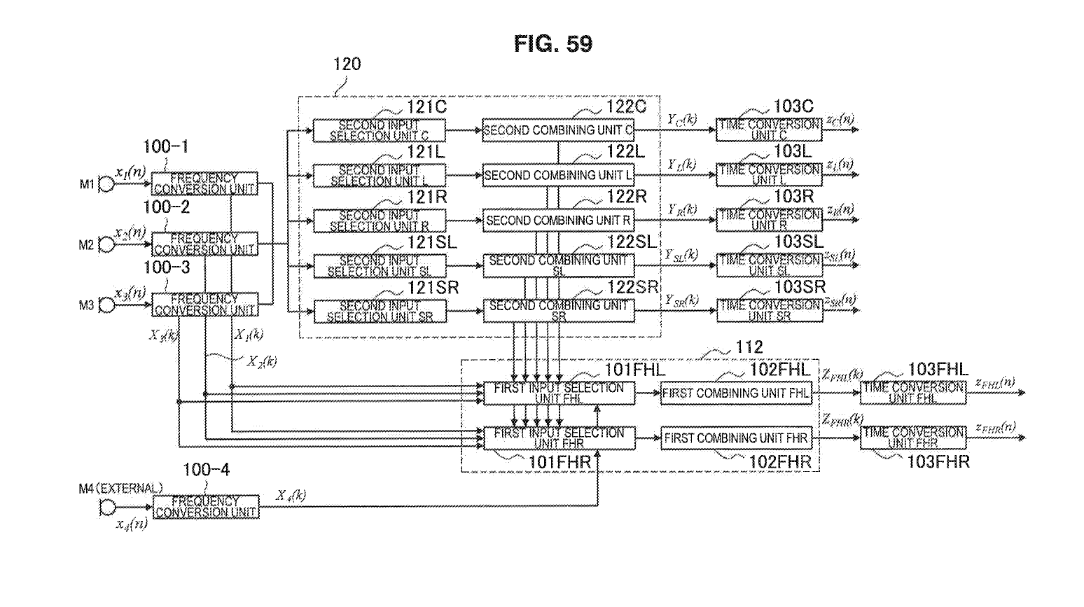

Next, with reference to FIG. 59, a functional configuration example of an audio signal processing device applied to the video camera 7 according to the fifth embodiment will be described. FIG. 59 is a block diagram illustrating a functional configuration of the audio signal processing device according to the fifth embodiment.

FIG. 59 illustrates a configuration example in which directivity combining of the 7.1 channels (C, L, R, SL, SR, FHL, FHR, and LFE) illustrated in FIG. 58B is performed in the microphone arrangement illustrated in FIG. 57.

As illustrated in FIG. 59, the audio signal processing device according to the fifth embodiment includes three microphones M₁, M₂, and M₃ and frequency conversion units 100-1 to 100-3, one external microphone M₄ and a frequency conversion unit 100-4, first input selection units 101FHL and 101FHR, first combining units 102FHL and 102FHR, and time conversion units 103FHL and 103FHR of two channels, and second input selection units 121C to 121 SR, second combining units 122C to 121 SR, and time conversion units 103C to 103SR of five channels.

In the case of the microphone arrangement illustrated in FIG. 57 as described above, the built-in microphones M₁, M₂, and M₃ are arranged in the vicinity of vertex positions of a triangle and input characteristics of M₁, M₂, and M₃ are aligned. Accordingly, the second directivity combining unit 120 can appropriately generate combined audio spectra Y_{C}, Y_{L}, Y_{R}, Y_{SL}, and Y_{SR} of five channels C, L, R, SL, and SR of a horizontal direction by combining the input audio spectra X₁, X₂, and X₃ of the built-in microphones M₁, M₂, and M₃ in a complex spectrum domain. Then, the time conversion units 103C to 103SR output combined audio signals z_{C}, z_{L}, z_{R}, z_{SL}, and z_{SR} of the C, L, R, SL, and SR channels by performing time conversions on Y_{C}, Y_{L}, Y_{R}, Y_{SL}, and Y_{SR}.

In detail, first, the frequency conversion units 100-1 to 100-3 perform frequency conversions of the input audio signals x₁, x₂, and x₃ of the built-in microphones M₁, M₂, and M₃ into the input audio spectra X₁, X₂, and X₃, and output the input audio spectra X₁, X₂, and X₃ to the second input selection units 121C to 121SR. Then, the second input selection units 121C to 121SR and the second combining units 122C to 122SR generate combined audio spectra Y_{C}, Y_{L}, Y_{R}, Y_{SL}, and Y_{SR} of the C, L, R, SL, and SR directions by combining X₁, X₂, and X₃ in the complex spectrum domain. Then, the combined audio spectra Y_{C}, Y_{L}, Y_{R}, Y_{SL}, and Y_{SR} are output to the time conversion units 103C to 103SR and converted into combined audio signals z_{C}, z_{L}, z_{R}, z_{SL}, and z_{SR} of the time domain, so that the combined audio signals z_{C}, z_{L}, z_{R}, z_{SL}, and z_{SR} are recorded on the recording medium 40 as ultimate combination results.

However, because the built-in microphones M₁, M₂, and M₃ are eccentrically arranged on the bottom surface 4b of the housing 4, the input audio spectra X₁, X₂, and X₃ of the built-in microphones M₁, M₂, and M₃ do not have an input characteristic difference in an upward/downward direction. Accordingly, it is difficult for the second directivity combining unit 120 to combine combined audio spectra Y_{FHL} and Y_{FHR} of two channels FHL and FHR of the upward/downward direction from only X₁, X₂, and X₃. Because of this, it is necessary for the first directivity combining unit 112 to combine the combined audio spectra Y_{FHL} and Y_{FHR} of the FHL and FHR channels in the power spectrum domain.

Therefore, in the fifth embodiment, as illustrated in FIG. 59, the external microphone M₄ is additionally installed on the top surface 4a of the housing 4. Then, the frequency conversion unit 100-4 performs frequency conversion on the input audio spectrum X₄ of the external microphone M₄, and outputs the input audio spectrum X₄ to the first directivity combining unit 112.

The first directivity combining unit 112 combines the combined audio spectra Y_{C}, Y_{L}, Y_{R}, Y_{SL}, and Y_{SR} from the second directivity combining unit 120 and the input audio spectrum X₄ of the above-described external microphone M₄ in the power spectrum domain. Thereby, it is possible to appropriately combine the combined audio spectra Z_{FHL} and Z_{FHR} of the FHL and FHR channels.

In detail, first, the frequency conversion units 100-1 to 100-3 perform the frequency conversions of the input audio spectra x₁, x₂, and x₃ of the built-in microphones M₁, M₂, and M₃ into the input audio spectra X₁, X₂, and X₃, and output the input audio spectra X₁, X₂, and X₃ to the second input selection units 121C to 121SR and the first input selection units 101SL and 101SR. Then, the combined audio spectra Y_{C}, Y_{L}, Y_{R}, Y_{SL}, and Y_{SR} combined by the second input selection units 121C to 121SR and the second combining units 122C to 122SR are output to the first input selection units 101FHL and 101FHR. Further, the frequency conversion unit 100-4 performs the frequency conversion of the input audio signal x₄ of the external microphone M₄ into the input audio spectrum X₄, and outputs the input audio signal X₄ to the first input selection units 101SL and 101SR.

Then, the first input selection units 101FHL and 101FHL and the first combining units 102FHL and 102FHL generate the combined audio spectra Z_{FHL} and Z_{FHR} of the FHL and FHR directions by combining X₁, X₂, X₃, X₄, Y_{C}, Y_{L}, Y_{R}, Y_{SL}, and Y_{SR} in the power spectrum domain.

At this time, for example, the first input selection units 101FHL and 101FHR may select the input audio spectrum X₄ of the external microphone M₄ and the combined audio spectra Y_{C}, Y_{L}, Y_{R}, Y_{SL}, and Y_{SR} generated by the second combining unit 122 as audio spectra to be used to combine the combined spectra Z_{FHL} and Z_{FHR} having directivity of the FHL and FHR directions. Then, the first combining units 102FHL and 102FHL may generate the omnidirectional power spectrum P_{Xall} from X₄ selected by the first input selection units 101FHL and 101FHR, generate the non-combination direction power spectrum P_{Yelse} from Y_{C}, Y_{L}, Y_{R}, Y_{SL}, and Y_{SR}, and generate Z_{FHL} and Z_{FHR} from a difference between P_{Xall} and P_{Yelse}. Thereafter, the combined audio spectra Z_{FHL} and Z_{FHR} are output to the time conversion units 103FHL and 103SFHR, respectively, and converted into combined audio signals z_{FHL} and z_{FHR} of the time domain and the combined audio signals z_{FHL} and z_{FHR} of the time domain are recorded on the recording medium 40 as an ultimate combination result.

As described above, in the fifth embodiment, it is possible to implement directivity combining of multiple channels such as 7.1 ch using the external microphone M₄ having input characteristics different from those of the built-in microphones M₁, M₂, and M₃.

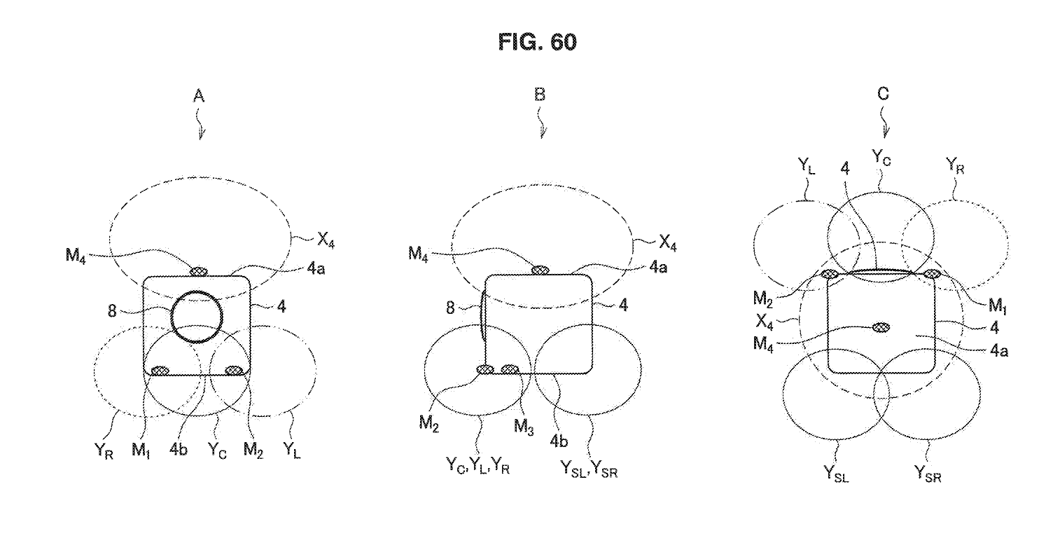

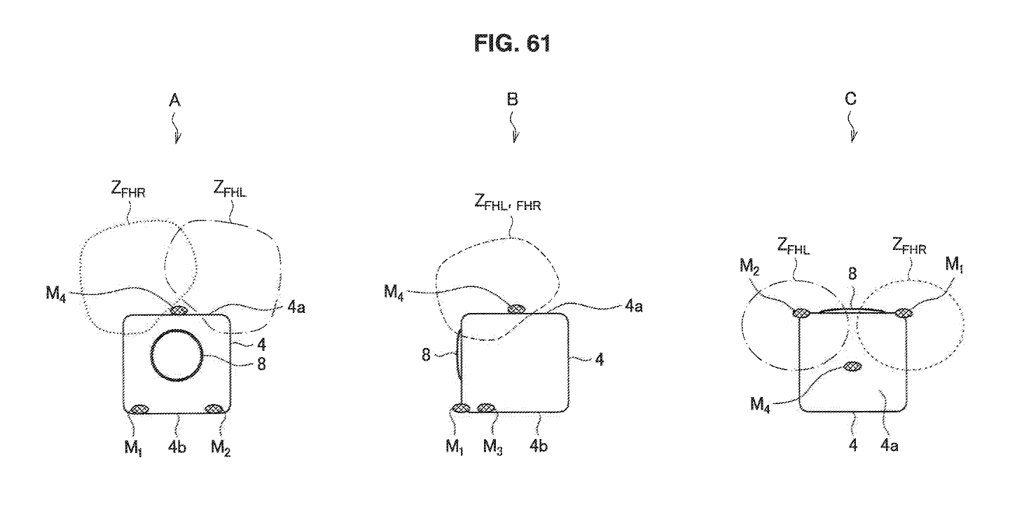

Here, with reference to FIGS. 60 and 61, the principle of directivity combining of the FHL and FHR directions using the above-described external microphone M₄ will be described. FIG. 60 illustrates input characteristics of the external microphone M₄ (characteristics of the input audio signal X₄) in the above-described directivity combining and characteristics of combined audio spectra Y_{C}, Y_{L}, Y_{R}, Y_{SL}, and Y_{SR}. In addition, FIG. 61 illustrates characteristics of the combined audio signals Z_{FHL} and Z_{FHR}.

As illustrated in FIG. 60, the three built-in microphones M₁, M₂, and M₃ are installed on the bottom surface 4b of the housing 4 of the video camera 7. The combined audio spectra Y_{C}, Y_{L}, Y_{R}, Y_{SL}, and Y_{SR} generated by directivity combining from the input audio spectra X₁, X₂, and X₃ of the built-in microphones M₁, M₂, and M₃ have directivity of the horizontal direction. However, Y_{C}, Y_{L}, Y_{R}, Y_{SL}, and Y_{SR} include audio components of the upward/downward direction substantially equally without a difference in characteristics of the upward/downward direction. On the other hand, the input audio spectrum X₄ of the external microphone M₄ includes more audio components of the upward direction than the above-described Y_{C}, Y_{L}, Y_{R}, Y_{SL}, and Y_{SR}.

Accordingly, it is possible to generate characteristics in the upward direction and the left/right direction by combining the above-described Y_{C}, Y_{L}, Y_{R}, Y_{SL}, Y_{SR}, and X₄. Consequently, as illustrated in FIG. 61, the combined audio spectrum Z_{FHL} of the FHL direction diagonally upward to the left is obtained by removing the characteristics of Y_{C}, Y_{R}, Y_{SL}, and Y_{SR} from the characteristics of X₄. In addition, the combined audio spectrum Z_{FHR} of the FHR direction diagonally upward to the right is obtained by removing the characteristics of Y_{C}, Y_{L}, Y_{SL}, and Y_{SR} from the characteristics of X₄.

### 5.3. Audio Signal Processing Method

Next, the audio signal processing method (directivity combining method) according to the audio signal processing device according to the fifth embodiment will be described.

Also, because the overall operation of the audio signal processing device according to the fifth embodiment is similar to those of the above-described second and third embodiments (see FIGS. 29 and 41), the illustration of the overall flow is omitted. However, in the fifth embodiment, directivity combining is performed using the input audio spectrum X₄ of the external microphone M₄ as well as the built-in microphones M₁, M₂, and M₃.

Hereinafter, the operations of the first input selection unit 101 and the first combining unit 102 according to the fifth embodiment will be described in detail. Because the operations of the second input selection unit 121 and the second combining unit 122 are similar to those of the above-described second and third embodiments, detailed description thereof will be omitted.

In addition, the operations of the first input selection unit 101FHL and the first combining unit 102FHL of the FHL channel will be mainly described below. However, the operations of the first input selection unit 101FHL and the first combining unit 102FHL are similar to those of the first input selection unit 101FHR and the first combining unit 102FHR except for a difference in data which is referred to. Hereinafter, because the operations are those of the first input selection unit 101FHR and the first combining unit 102FHR if L and R are reversed, detailed description thereof will be omitted.

### [5.3.1. Operation of First Input Selection Unit]

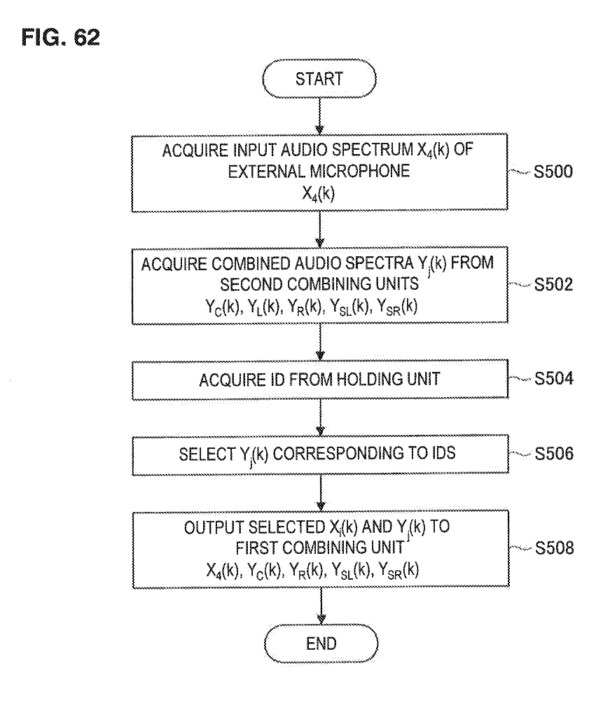

Next, with reference to FIG. 62, the operation of the first input selection unit 101FHL according to the present embodiment will be described. FIG. 62 is a flowchart illustrating the operation of the first input selection unit 101FHL according to the present embodiment.

As illustrated in FIG. 62, first, the first input selection unit 101FHL acquires the input audio spectrum X₄ of the external microphone M₄ from the frequency conversion unit 100-4 (S500). Further, the first input selection unit 101FHL acquires combined audio spectra Y_{C}, Y_{L}, Y_{R}, Y_{SL}, and Y_{SR} of five channels output from the second combining units 122C to 122SR (S502).

Then, the first input selection unit 101FHL acquires an ID sequence including selected IDs from the holding unit 105 (S504). The holding unit 105 (see FIG. 14) holds an ID sequence including identification information (ID) of the microphone M and identification information (ID) of the combined audio spectrum Yᵢ necessary to combine the combined audio spectrum Z_{FHL} of the FHL channel. The developer presets ID sequences according to the arrangement of the microphones M₁, M₂, . . . , M_{M} for every channel of the surround reproduction environment.

Further, the first input selection unit 101FHL selects the audio spectra X₄, Y_{C}, Y_{L}, Y_{R}, Y_{SL}, and Y_{SR} corresponding to the selected IDs acquired in S504 from among the input audio spectrum X₄ and the combined audio spectra Y_{C}, Y_{L}, Y_{R}, Y_{SL}, and Y_{SR} acquired in S500 and S502 (S506). Here, the combined audio spectra Y_{C}, Y_{R}, Y_{SL}, and Y_{SR} excluding Y_{L} and the input audio spectrum X₄ of the external microphone M₄ are selected. Thereafter, the first input selection unit 101 FHL outputs the input the audio spectra X₄, Y_{C}, Y_{R}, Y_{SL}, and Y_{SR} selected in S506 to the first combining unit 102FHL (S508).

According to the above, the first input selection unit 101FHL appropriately selects audio spectra X and Y for combining the omnidirectional power spectrum Pₐₗₗ and the non-combination direction power spectrum Pₑₗₛₑ.

### [5.3.2. Operation of First Combining Unit]

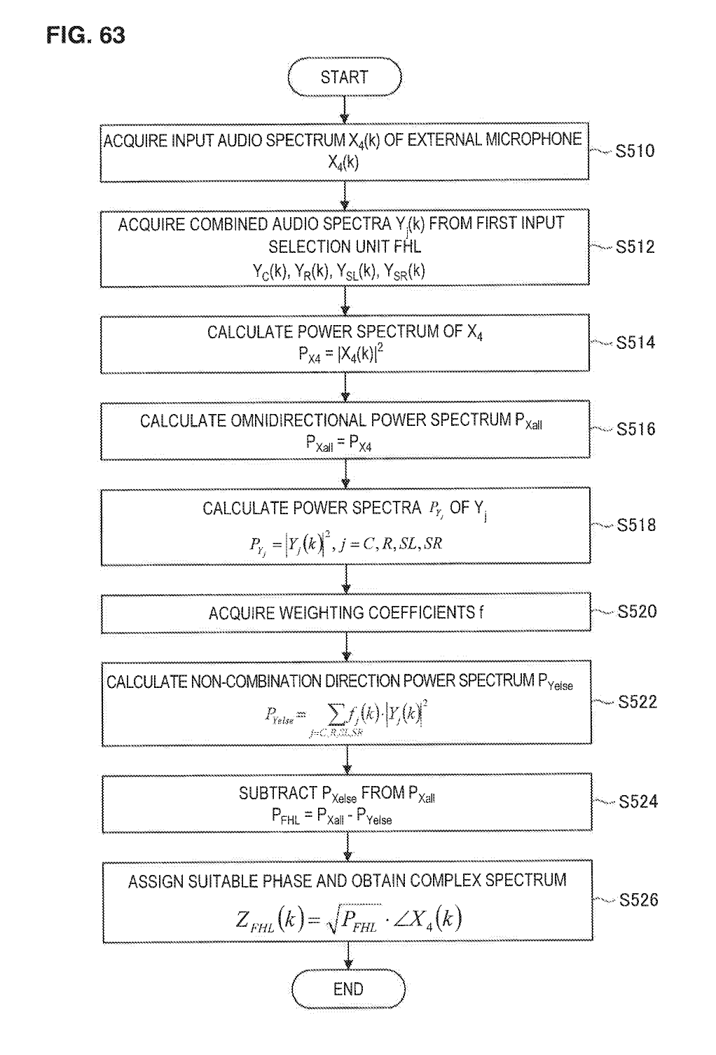

Next, with respect to FIG. 63, the operation of the first combining unit 102FHL according to the present embodiment will be described. FIG. 63 is a flowchart illustrating the operation of the first combining unit 102FHL according to the present embodiment.

As illustrated in FIG. 63, first, the first combining unit 102FHL acquires the input audio spectrum X₄ of the external microphone M₄ from the first input selection unit 101FHL (S510). Further, the first input selection unit 101FHL acquires the combined audio spectra Y_{C}, Y_{R}, Y_{SL}, and Y_{SR} selected by the first input selection unit 101FHL (S512).

Then, the first combining unit 102FHL is, further, the first combining unit 102FHL calculates a power spectrum P_{X4} of the input audio spectrum X₄ of the external microphone M₄ (S514). Further, the first combining unit 102FHL calculates an omnidirectional power spectrum P_{Xall} from the power spectrum P_{X4} (S516). Here, because the external microphone M₄ is installed on the top surface 4a of the housing 4 and X₄ input from M₄ includes the whole circumference of the horizontal direction (see FIG. 60), P_{Xall}=P_{X4}.

Further, the first combining unit 102FHL calculates power spectra P_{YC}, P_{YR}, P_{YSL}, and P_{YSR} of the combined audio spectra Y_{C}, Y_{R}, Y_{SL}, and Y_{SR} (S518). Then, the first combining unit 102FHL acquires weighting coefficients f_{C}, f_{R}, f_{SL}, and f_{SR} for obtaining the non-combination direction power spectrum P_{Yelse} from the holding unit 109 (S520). Thereafter, the first combining unit 102FHL calculates the non-combination direction power spectrum P_{Yelse} by performing weighting addition on the power spectra P_{YC}, P_{YR}, P_{YSL}, and P_{YSR} using the weighting coefficients f_{C}, f_{R}, f_{SL}, and f_{SR} acquired in S520 (S522). P_{Yelse} corresponds to the power spectrum of the audio component having directivity of the direction other than the FHL direction.

Thereafter, the first combining unit 102FHL generates a power spectrum P_{FHL} of the FHL channel by subtracting the non-combination direction power spectrum P_{Yelse} from the omnidirectional power spectrum P_{Xall} (S524). Further, the first combining unit 102FHL restores a combined audio spectrum Z_{FHL} (complex spectrum) of the FHL channel from the power spectrum P_{FHL} obtained in S524 (S526).

According to the above, the first combining unit 102FHL can appropriately combine the combined audio spectrum Z_{FHL}(k) of the FHL channel using the combined audio spectra Y_{C}, Y_{R}, Y_{SL}, and Y_{SR} and the input audio spectrum X₄ of the external microphone M₄.

### 5.4. Advantageous Effects

The audio signal processing device and method according to the fifth embodiment have been described above in detail. According to the fifth embodiment, it is possible to obtain the following advantageous effects in addition to the advantageous effects of the above-described first to third embodiments.

According to the fifth embodiment, when the built-in microphones M₁, M₂, and M₃ are eccentrically arranged on one side of the housing 4 of the video camera 7, the external microphone M₄ is mounted on the other side so that the housing 4 is interposed between the microphones. According to this microphone arrangement, the external microphone M₄ has different input characteristics from the other built-in microphones M₁, M₂, and M₃ due to the influence of the housing 4. Because of this, the input audio spectrum X₄ of the external microphone M, can also include an audio component of the upward/downward direction which is not obtained by the input audio spectra X₁, X₂, and X₃ of M₁, M₂, and M₃.

Accordingly, the second directivity combining unit 120 can obtain combined audio spectra Y_{C}, Y_{L}, Y_{R}, Y_{SL}, and Y_{SR} of five channels from X₁, X₂, and X₃. Further, the first directivity combining unit 112 can obtain the combined audio spectra Z_{FHL} and z_{FHR} of the FHL and FLR channels from X₄ and Y_{C}, Y_{L}, Y_{R}, Y_{SL}, and Y_{SR}. Thereby, it is possible to implement a surround reproduction environment of 7.1 ch which is difficult to implement with only the built-in microphones M₁, M₂, and M₃.

As described above, according to the fifth embodiment, it is possible to implement a multi-channel surround reproduction environment which is difficult to implement with only the existing built-in microphones M₁, M₂, and M₃ by adding the external microphone M₄ to the sound recording device.

### 6. Sixth Embodiment

Next, an audio signal processing device and an audio signal processing method according to the sixth embodiment of the present disclosure will be described. The sixth embodiment is characterized in that the above-described directivity combining is performed by correcting frequency characteristics (amplitude characteristics, phase characteristics, or the like) of the input audio signal x of the microphone when characteristics of the microphones M themselves are different. Because other functional configurations of the sixth embodiment are substantially the same as those of the above-described first to third embodiments, detailed description thereof will be omitted.

### 6.1. Outline of Sixth Embodiment

First, the outline of the audio signal processing device and method according to the sixth embodiment will be described.

In the above-described first to fifth embodiments, measures are taken to solve a problem that the input characteristics of the sound for each microphone are different according to the microphone arrangement for the housing 4 of the sound recording device. On the other hand, in the sixth embodiment, a problem that frequency characteristics (amplitudes, phases, or the like) of the input audio signals x among a plurality of microphones are different because characteristics of the microphones themselves are different is also solved.

In the case in which a plurality of types of microphones M installed in the sound recording device are different (for example, a microphone for a telephone call and a microphone for capturing a moving-image), the case in which there is an element error (individual difference) even in the same type of microphones M, and the like, the frequency characteristics of the input audio signal x become different among the plurality of microphones M.

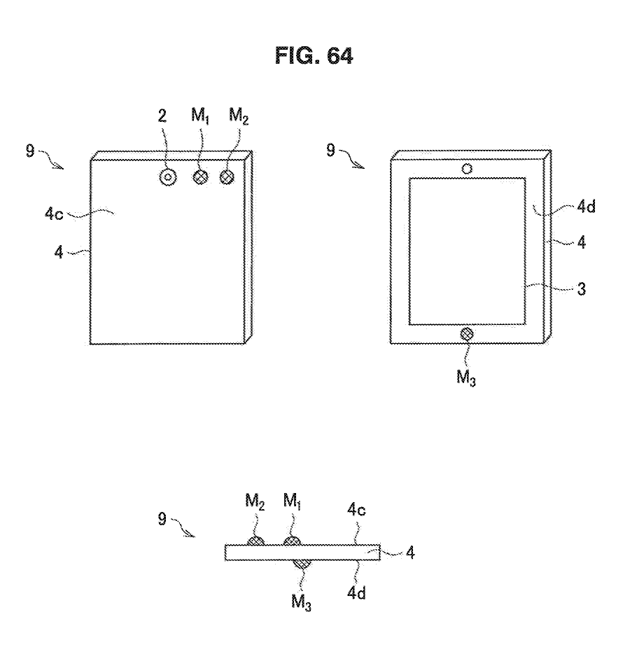

For example, as illustrated in FIG. 64, the case in which the sound recording device is a mobile phone, for example, a smartphone 9, having a moving-image capture function and a telephone call function is considered. On the upper part of the front surface 4c (the side of the lens 2 of the camera) of the housing 4 of the smartphone 9, a pair of left and right stereo microphones M₁ and M₂ are arranged as a microphone for capturing a moving picture. A main objective of the microphones M₁ and M₂ is mainly to collect a sound arriving from the front of the smartphone 9. On the other hand, on the lower part of the rear surface 4d (the side of the screen 3) of the housing 4 of the smartphone 9, the microphone M₃ for the telephone call is arranged. A main objective of this microphone M₃ is to collect a telephone call sound of a user.

The case in which the above-described multi-channel surround sound recording is implemented using the microphone M₃ for the telephone call in combination with the microphones M₁ and M₂ for capturing the moving-image (for surround sound recording) in the device having the telephone call function and the video recording function represented by the above-described smartphone 9 is considered. In this case, because there is a difference in device characteristics among the microphones M₁ and M₂ for capturing the moving-image and the microphone M₃ for the telephone call, a difference also occurs in frequency characteristics of the input audio signals x of the two microphones M.

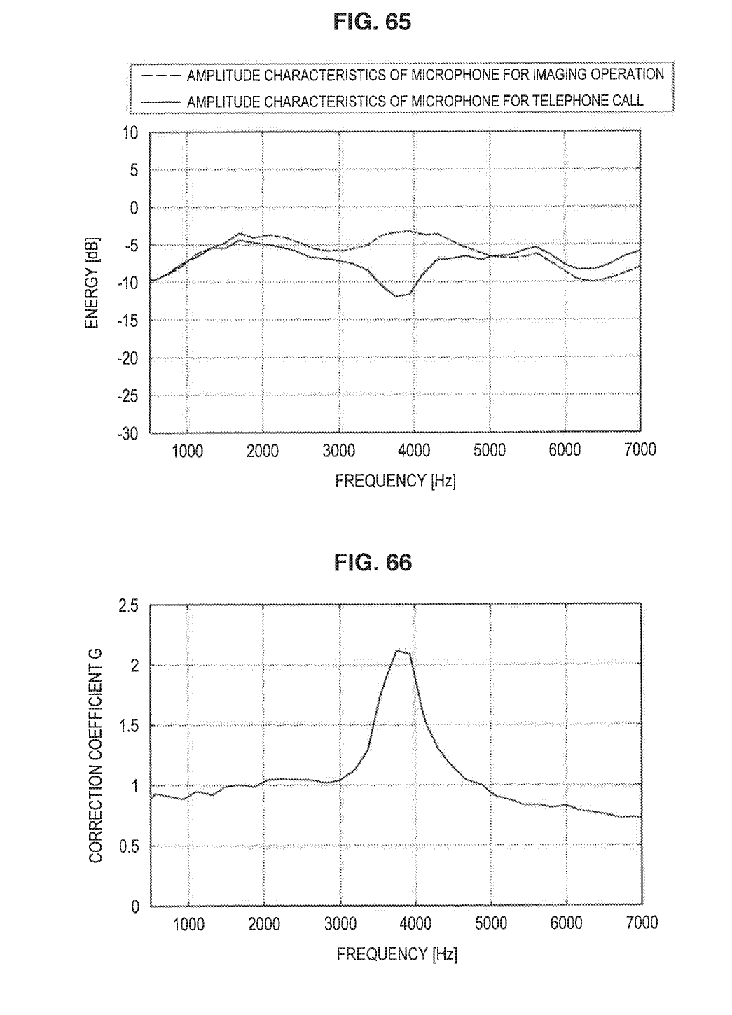

FIG. 65 is a diagram illustrating amplitude characteristics of the microphone M₁ for capturing the moving image and the microphone M₃ for the telephone call. As illustrated in FIG. 65, the amplitude characteristics of the input audio spectrum X from each microphone M are different if a type of microphone M is different. Although the amplitude characteristics of the microphone M₃ for the telephone call are degraded remarkably before and after 4000 Hz, the amplitude characteristics of the microphone M₃ are substantially the same as the amplitude characteristics of the microphone M₁ for capturing the moving image in the other frequency bands.

Accordingly, it is only necessary to correct the input audio spectrum X₃ to increase an amplitude (gain) of the input audio spectrum X₃ of the microphone M₃ for the telephone call in the frequency band before and after 4000 Hz so as to make the amplitude characteristics of the microphone M₃ for the telephone call and the amplitude characteristics of the microphone M₁ for capturing the moving image match each other.

For example, there is a method of multiplying the input audio spectrum X₃ of the microphone M₃ for the telephone call by a correction coefficient G as the correction method. That is, a difference between the input audio spectrum X₁ of the microphone M₁ for capturing the moving image and the input audio spectrum x₃ of the microphone M₃ for the telephone call is calculated for every frequency component k, and the correction coefficient G is calculated for every frequency component k based on the difference. Then, it is only necessary to multiply the input audio spectrum X₃ of the microphone M₃ for the telephone call by the coefficient G.

FIG. 66 illustrates the correction coefficient G calculated from the difference between the input audio spectrum X₁ of the microphone M₁ for capturing the moving image and the input audio spectrum X₃ of the microphone M₃ for the telephone call in the example of FIG. 65. As illustrated in FIG. 66, the correction coefficient G is increased to about 2 in a frequency band before and after 4000 Hz and is substantially 1 in the other frequency bands. If the input audio spectrum X₃ of the microphone M₃ for the telephone call is multiplied by the correction coefficient G, it is possible to increase the amplitude of the input audio spectrum X₃ in the frequency band before and after 4000 Hz and adjust the input audio spectrum to the input audio spectrum X₁ of the microphone M₁ for capturing the moving image.

Hereinafter, the audio signal processing device and method according to the sixth embodiment for implementing the above-described directivity combining after performing the correction of input audio as described above will be described.

### 6.2. Functional Configuration of Audio Signal Processing Device

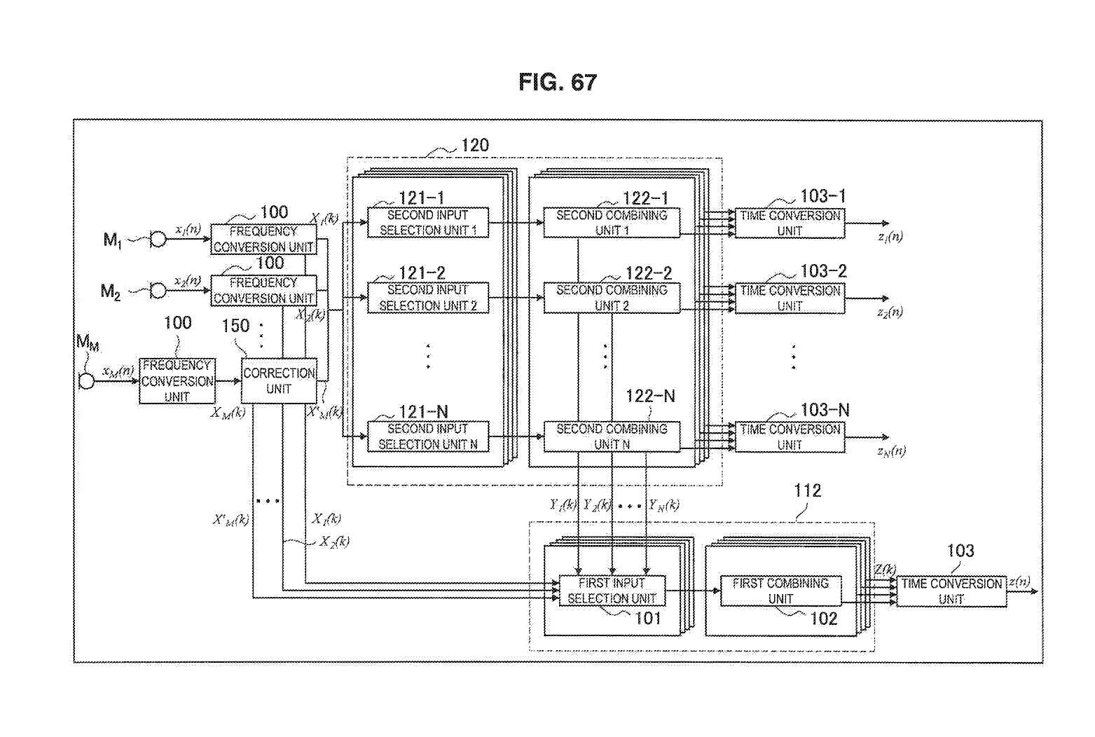

Next, with reference to FIG. 67, a functional configuration example of an audio signal processing device applied to the video camera 7 according to the sixth embodiment will be described. FIG. 67 is a block diagram illustrating a functional configuration of the audio signal processing device according to the sixth embodiment.

As illustrated in FIG. 67, the audio signal processing device according to the sixth embodiment includes M microphones M₁, M₂, . . . , M_{M}, M frequency conversion units 100, a first input selection unit 101, a first combining unit 102, a time conversion unit 103, N second input selection units 121-1 to 121-N, N second combining units 122-1 to 122-N, and N time conversion units 103-1 to 103-N. M is the number of installed microphones and N is the number of channels of the surround reproduction environment.

As illustrated in FIG. 67, the audio signal processing device according to the sixth embodiment further includes a correction unit 150 in addition to constituent elements of the audio signal processing devices (see FIGS. 22 and 34) according to the above-described second and third embodiments. The sixth embodiment is characterized in that the correction unit 150 corrects the input audio spectrum X_{M} output from a microphone M_{M} (for example, the microphone for the telephone call) having different characteristics from the other microphones M₁, M₂, . . . , M_{M-1} (for example, microphones for capturing the moving image). Because other functional configurations according to the sixth embodiment are substantially the same as those of the above-described second and third embodiments, detailed description thereof will be omitted.

The correction unit 150 corrects the input audio spectrum X₄ output from at least one microphone M_{M} having different characteristics from the other microphones M₁, M₂, . . . , M_{M-1} based on a difference of the input audio spectra X₁, X₂, . . . , X_{M} input from the microphones M₁, M₂, . . . , M_{M} when the characteristics of a plurality of microphones M₁, M₂, . . . , M_{M} are different. For example, the correction unit 150 corrects the input audio spectrum X_{M} of the microphone M_{M} using a correction coefficient G(k) and outputs an input audio spectrum X′_{M} after the correction to the second input selection unit 121 and the first input selection unit 101. Because of this, the correction unit 150 holds the correction coefficient G(k) in the holding section (not illustrated).

The correction coefficient G(k) is a coefficient for correcting frequency characteristics (amplitude characteristics, phase characteristics, or the like) of the input audio signal X_{M} of a certain microphone M_{M} and adjusting the frequency characteristics to frequency characteristics of an input audio spectrum X₁ of the other microphones M₁, M₂, . . . , M_{M-1}. The developer of the sound recording device presets this correction coefficient G(k) based on a difference between the input audio spectrum X₁ of the microphone M₁ and the input audio spectrum X_{M} of the microphone M_{M} (see FIGS. 66 and 67). This correction coefficient G(k) is set for every frequency component k of the input audio spectrum X.

As in the following Formula (60), the correction unit 150 corrects X_{M}(k) by multiplying the input audio spectrum X_{M}(k) of the microphone M_{M} by the above-described correction coefficient G(k) for every frequency component k of the input audio spectrum X_{M}(k), and outputs an input audio spectrum X′_{M}(k) after the correction.

X′_{M}(k)=G(k)×X_{M}(k) (60)

### 6.3. Audio Signal Processing Method

Next, the audio signal processing method (directivity combining method) according to the audio signal processing device according to the sixth embodiment will be described.

Also, because the overall operation of the audio signal processing device according to the sixth embodiment is similar to those of the above-described second and third embodiments (see FIGS. 29 and 41), the illustration of the overall flow is omitted. However, the sixth embodiment includes a correction process in which the above-described correction unit 150 corrects an input audio spectrum Z of a specific microphone M after the frequency conversion process (S32 of FIG. 29 and S52 of FIG. 41).

In addition, the operation of the correction unit 150 according to the sixth embodiment will be described in detail hereinafter. Because the operations of the first input selection unit 101, the first combining unit 102, the second input selection unit 121, and the second combining unit 122 are similar to those of the above-described second and third embodiments, detailed description thereof will be omitted.

### [6.3.1. Operation of Correction Unit]

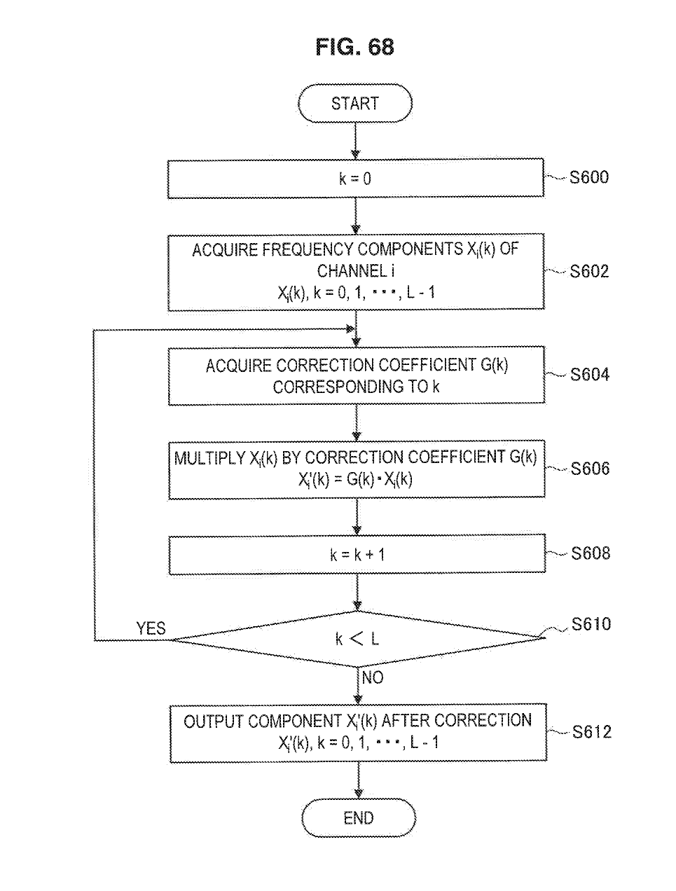

Next, with reference to FIG. 68, the operation of the correction unit 150 according to the present embodiment will be described. FIG. 68 is a flowchart illustrating the operation of the correction unit 150 according to the present embodiment.

As illustrated in FIG. 68, for example, after the correction unit 150 sets the frequency index k to 0 (S600), all frequency components Xᵢ(k) of an input audio spectrum Xᵢ from a microphone Mᵢ of a correction target are acquired (S602).

Then, the correction unit 150 acquires the correction coefficient G(k) corresponding to the frequency index k (S604). Further, the frequency component Xᵢ(k) of the input audio spectrum Xᵢ acquired in the above-described S602 is multiplied by the correction coefficient G(k) acquired in S604 (S606). Thereby, Xᵢ(k) is corrected to X′ᵢ(k). X′ᵢ(k) is obtained by adjusting the frequency characteristics of the input audio spectrum Xᵢ of the microphone Mᵢ of the correction target to the frequency characteristics of an input audio spectrum Xⱼ of the other microphone Mⱼ.

Further, after the frequency index k is incremented by 1 (S608), the correction unit 150 iterates the above-described processes of S604 to S608 until the frequency index k reaches L (S610). Thereby, Xᵢ(k) is generated by sequentially correcting Xᵢ(k) using the correction coefficient G(k).

The correction unit 150 outputs all frequency components X′ᵢ(k) of an input audio spectrum X′ᵢ(k) after the correction obtained in the above-described correction process to the first input selection unit 101 and the second input selection unit 121 each time.

Thereby, it is possible to correct the input audio spectrum Xᵢ from the microphone Mᵢ of the correction target in accordance with the characteristics of the other microphone M and output the corrected input audio spectrum Xᵢ to the first directivity combining unit 112 and the second directivity combining unit 120.

### 6.4. Advantageous Effects

The audio signal processing device and method according to the sixth embodiment have been described above in detail. According to the sixth embodiment, it is possible to obtain the following advantageous effects in addition to the advantageous effects of the above-described first to third embodiments.

According to the sixth embodiment, the correction unit 150 can suitably implement the above-described directivity combining by excluding an influence by a difference in characteristics of the microphones M themselves (a difference between the types of microphones M or an individual difference of a microphone element) by correcting the input audio spectrum X_{M}. In particular, the above-described correction is useful when the microphone M₃ for the telephone call also serves as the microphone M for surround sound recording in a device having the moving-image capture function and the telephone call function such as the smartphone 9.

The preferred embodiments of the present invention have been described above with reference to the accompanying drawings, whilst the present invention is not limited to the above examples, of course. A person skilled in the art may find various alterations and modifications within the scope of the appended claims, and it should be understood that they will naturally come under the technical scope of the present invention.

For example, although the digital camera 1, the video camera 7, and the smartphone 9 have been described as an examples of the audio signal processing device in the above-described embodiments, the present technology is not limited to these examples. As long as the audio signal processing device of the present technology is a device having a processor capable of executing the above-described directivity combining, the present technology is applicable to an arbitrary device such as an audio reproduction device as well as an audio recording device. For example, the audio signal processing device can be applied to arbitrary electronic devices such as a recording/reproduction device (for example, a BD/DVD recorder), a television receiver, a system stereo device, an imaging device (for example, a digital camera and a digital video camera), a portable terminal (for example, a portable music/video player, a portable game device, and an integrated circuit (IC) recorder), a personal computer, a game device, a car navigation device, a digital photo frame, home appliances, a vending machine, an automatic teller machine (ATM), and a kiosk terminal.

Additionally, the present technology may also be configured as below.

(1)

An audio signal processing device including:

frequency conversion units configured to generate a plurality of input audio spectra by performing frequency conversions on input audio signals input from a plurality of microphones provided in a housing;

a first input selection unit configured to select input audio spectra corresponding to a first combination direction from among the input audio spectra based on an arrangement of the microphones for the housing; and

a first combining unit configured to generate a combined audio spectrum having directivity of the first combination direction by calculating power spectra of the input audio spectra selected by the first input selection unit.

(2)

The audio signal processing device according to (1),

wherein the first combining unit calculates the power spectra of the input audio spectra selected by the first input selection unit,

wherein the first combining unit generates an omnidirectional power spectrum including an omnidirectional audio signal component around the housing and a non-combination direction power spectrum including an audio signal component of a direction other than the first combination direction by combining the power spectra based on the arrangement of the microphones for the housing, and

wherein the first combining unit generates the combined audio spectrum having directivity of the first combination direction based on a power spectrum obtained by subtracting the non-combination direction power spectrum from the omnidirectional power spectrum.

(3)

The audio signal processing device according to (2),

wherein the first combining unit generates the omnidirectional power spectrum by performing weighting addition on the power spectra of the input audio spectra selected by the first input selection unit using first weighting coefficients set according to the arrangement of the microphones for the housing, and

wherein the first combining unit generates the non-combination direction power spectrum by performing weighting addition on the power spectra of the input audio spectra selected by the first input selection unit using second weighting coefficients set according to the arrangement of the microphones for the housing.

(4)

The audio signal processing device according to any one of (1) to (3), further including:

a plurality of second input selection units configured to select input audio spectra corresponding to each combination direction of a plurality of combination directions from among the input audio spectra based on the arrangement of the microphones for the housing; and

a plurality of second combining units configured to generate combined audio spectra having directivity of each combination direction by combining the input audio spectra selected by the second input selection units.

(5)

The audio signal processing device according to (4),

wherein, when there is a difference in input characteristics among the plurality of microphones due to an influence of the arrangement of the microphones for the housing, the combined audio spectrum having the directivity of the first combination direction is generated by combining the power spectra of the input audio spectra selected by the first input selection unit using the first combining unit, and

wherein, when there is no difference in input characteristics among the plurality of microphones, the combined audio spectrum having the directivity of the first combination direction is generated by combining the power spectra of the input audio spectra selected by the second input selection units using the second combining units.

(6)

The audio signal processing device according to (4) or (5),

wherein the first input selection unit selects audio spectra corresponding to the first combination direction from among the combined audio spectra generated by the second combining units and the input audio spectra based on the arrangement of the microphones for the housing,

wherein the first combining unit generates an omnidirectional power spectrum including an omnidirectional audio signal component around the housing by calculating power spectra of the audio spectra selected by the first input selection unit and combining the power spectra,

wherein the first combining unit generates a non-combination direction power spectrum including an audio signal component of a direction other than the first combination direction by calculating the power spectra of the audio spectra selected by the first input selection unit and combining the power spectra, and

wherein the first combining unit generates the combined audio spectrum having the directivity of the first combination direction based on a power spectrum obtained by subtracting the non-combination direction power spectrum from the omnidirectional power spectrum.

(7)

The audio signal processing device according to (4) or (5), further including:

an output selection unit configured to select and output either the combined audio spectrum generated by the first combining unit or the combined audio spectra generated by the second combining units as the combined audio spectrum having the directivity of the first combination direction according to a frequency band of the combined audio spectrum.

(8)

The audio signal processing device according to (7),

wherein the output selection unit selects and outputs only the combined audio spectra generated by the second combining units as the combined audio spectrum having the directivity of each combination direction of the plurality of combination directions including the first combination direction in a frequency band of less than a predetermined frequency, and

wherein the output selection unit selects and outputs either the combined audio spectrum generated by the first combining unit or the combined audio spectra generated by the second combining units as the combined audio spectrum having the directivity of each combination direction of the plurality of combination directions including the first combination direction based on the arrangement of the microphones for the housing in a frequency band of the predetermined frequency or more.

(9)

The audio signal processing device according to any one of (4) to (8),

wherein the plurality of combination directions including the first combination direction correspond to a plurality of channels of a surround reproduction environment,

wherein the first input selection unit changes audio spectra to be selected to generate the combined audio spectrum having the directivity of the first combination direction from the combined audio spectra generated by the second combining units and the input audio spectra according to the surround reproduction environment,

wherein the first combining unit changes weighting coefficients to be used when weighting addition is performed on the power spectra of the audio spectra selected by the first input selection unit according to the surround reproduction environment,

wherein the second input selection units change the input audio spectra to be selected to generate the combined audio spectra having the directivity of each combination direction of the plurality of combination directions from among the input audio spectra according to the surround reproduction environment, and

wherein the second combining units change weighting coefficients to be used when weighting addition is performed on the input audio spectra selected by the second input selection units according to the surround reproduction environment.

(10)

The audio signal processing device according to any one of (4) to (9), wherein the microphone includes
a plurality of built-in microphones installed on one side of the housing, and
at least one external microphone installed to be removable from multiple sides of the housing,

wherein input characteristics among the built-in microphones and the external microphone are different due to an influence of an arrangement of the built-in microphones and the external microphone for the housing,

wherein the first input selection unit selects the input audio spectrum of the external microphone and the combined audio spectra generated by the second combining units as the input audio spectra to be selected to generate the combined audio spectrum having the directivity of the first combination direction, and

wherein the first combining unit generates the combined audio spectrum having the directivity of the first combination direction by combining power spectra of the input audio spectra and the combined audio spectra selected by the first input selection unit.

(11)

The audio signal processing device according to any one of (1) to (10), further including:

a correction unit configured to correct the input audio spectrum input from at least one microphone based on a difference between the input audio spectra input from the plurality of microphones when characteristics are different among the plurality of microphones.

(12)

An audio signal processing method including:

generating a plurality of input audio spectra by performing frequency conversions on a plurality of input audio signals input from a plurality of microphones provided in a housing;

selecting input audio spectra corresponding to a first combination direction from among the input audio signals based on an arrangement of the microphones for the housing; and

generating a combined audio spectrum having directivity of the first combination direction by calculating power spectra of the selected input audio spectra.

(13)

A program for causing a computer to execute:

generating a plurality of input audio spectra by performing frequency conversions on a plurality of input audio signals input from a plurality of microphones provided in a housing;

selecting input audio spectra corresponding to a first combination direction from among the input audio signals based on an arrangement of the microphones for the housing; and

generating a combined audio spectrum having directivity of the first combination direction by calculating power spectra of the selected input audio spectra.

(14)

A computer-readable recording medium having a program recorded thereon, the program causing a computer to execute:

generating a plurality of input audio spectra by performing frequency conversions on a plurality of input audio signals input from a plurality of microphones provided in a housing;

selecting input audio spectra corresponding to a first combination direction from among the input audio signals based on an arrangement of the microphones for the housing; and

generating a combined audio spectrum having directivity of the first combination direction by calculating power spectra of the selected input audio spectra.

### REFERENCE SIGNS LIST

1 digital camera
2 lens
3 screen
4 housing
5 sound
6 speaker
7 video camera
8 lens
9 smartphone
40 recording medium
50 sound collection unit
60 audio processing unit
70 control unit
80 operation unit
100 frequency conversion unit
101 first input selection unit
102 first combining unit
103 time conversion unit
104 selection unit
105 holding unit
106 first calculation unit
107 holding unit
108 second calculation unit
109 holding unit
110 subtraction unit
111 third calculation unit
112 first directivity combining unit
120 second directivity combining unit
121 second input selection unit
122 second combining unit
123 selection unit
124 holding unit
125 calculation unit
126 holding unit
130 output selection unit
131 selection unit
132 holding unit
140 control unit
141 environment setting information
142 environment setting information
150 correction unit
M microphone

1. An audio signal processing device comprising:
frequency conversion units configured to generate a plurality of input audio spectra by performing frequency conversions on input audio signals input from a plurality of microphones provided in a housing;
a first input selection unit configured to select input audio spectra corresponding to a first combination direction from among the input audio spectra based on an arrangement of the microphones for the housing; and
a first combining unit configured to generate a combined audio spectrum having directivity of the first combination direction by calculating power spectra of the input audio spectra selected by the first input selection unit.

2. The audio signal processing device according to claim 1,
wherein the first combining unit calculates the power spectra of the input audio spectra selected by the first input selection unit,
wherein the first combining unit generates an omnidirectional power spectrum including an omnidirectional audio signal component around the housing and a non-combination direction power spectrum including an audio signal component of a direction other than the first combination direction by combining the power spectra based on the arrangement of the microphones for the housing, and
wherein the first combining unit generates the combined audio spectrum having directivity of the first combination direction based on a power spectrum obtained by subtracting the non-combination direction power spectrum from the omnidirectional power spectrum.

3. The audio signal processing device according to claim 2,
wherein the first combining unit generates the omnidirectional power spectrum by performing weighting addition on the power spectra of the input audio spectra selected by the first input selection unit using first weighting coefficients set according to the arrangement of the microphones for the housing, and
wherein the first combining unit generates the non-combination direction power spectrum by performing weighting addition on the power spectra of the input audio spectra selected by the first input selection unit using second weighting coefficients set according to the arrangement of the microphones for the housing.

4. The audio signal processing device according to claim 1, further comprising:
a plurality of second input selection units configured to select input audio spectra corresponding to each combination direction of a plurality of combination directions from among the input audio spectra based on the arrangement of the microphones for the housing; and
a plurality of second combining units configured to generate combined audio spectra having directivity of each combination direction by combining the input audio spectra selected by the second input selection units.

5. The audio signal processing device according to claim 4,
wherein, when there is a difference in input characteristics among the plurality of microphones due to an influence of the arrangement of the microphones for the housing, the combined audio spectrum having the directivity of the first combination direction is generated by combining the power spectra of the input audio spectra selected by the first input selection unit using the first combining unit, and
wherein, when there is no difference in input characteristics among the plurality of microphones, the combined audio spectrum having the directivity of the first combination direction is generated by combining the power spectra of the input audio spectra selected by the second input selection units using the second combining units.

6. The audio signal processing device according to claim 4,
wherein the first input selection unit selects audio spectra corresponding to the first combination direction from among the combined audio spectra generated by the second combining units and the input audio spectra based on the arrangement of the microphones for the housing,
wherein the first combining unit generates an omnidirectional power spectrum including an omnidirectional audio signal component around the housing by calculating power spectra of the audio spectra selected by the first input selection unit and combining the power spectra,
wherein the first combining unit generates a non-combination direction power spectrum including an audio signal component of a direction other than the first combination direction by calculating the power spectra of the audio spectra selected by the first input selection unit and combining the power spectra, and
wherein the first combining unit generates the combined audio spectrum having the directivity of the first combination direction based on a power spectrum obtained by subtracting the non-combination direction power spectrum from the omnidirectional power spectrum.

7. The audio signal processing device according to claim 4, further comprising:
an output selection unit configured to select and output either the combined audio spectrum generated by the first combining unit or the combined audio spectra generated by the second combining units as the combined audio spectrum having the directivity of the first combination direction according to a frequency band of the combined audio spectrum.

8. The audio signal processing device according to claim 7,
wherein the output selection unit selects and outputs only the combined audio spectra generated by the second combining units as the combined audio spectrum having the directivity of each combination direction of the plurality of combination directions including the first combination direction in a frequency band of less than a predetermined frequency, and
wherein the output selection unit selects and outputs either the combined audio spectrum generated by the first combining unit or the combined audio spectra generated by the second combining units as the combined audio spectrum having the directivity of each combination direction of the plurality of combination directions including the first combination direction based on the arrangement of the microphones for the housing in a frequency band of the predetermined frequency or more.

9. The audio signal processing device according to claim 4,
wherein the plurality of combination directions including the first combination direction correspond to a plurality of channels of a surround reproduction environment,
wherein the first input selection unit changes audio spectra to be selected to generate the combined audio spectrum having the directivity of the first combination direction from the combined audio spectra generated by the second combining units and the input audio spectra according to the surround reproduction environment,
wherein the first combining unit changes weighting coefficients to be used when weighting addition is performed on the power spectra of the audio spectra selected by the first input selection unit according to the surround reproduction environment,
wherein the second input selection units change the input audio spectra to be selected to generate the combined audio spectra having the directivity of each combination direction of the plurality of combination directions from among the input audio spectra according to the surround reproduction environment, and
wherein the second combining units change weighting coefficients to be used when weighting addition is performed on the input audio spectra selected by the second input selection units according to the surround reproduction environment.

10. The audio signal processing device according to claim 4,
wherein the microphone includes
a plurality of built-in microphones installed on one side of the housing, and
at least one external microphone installed to be removable from multiple sides of the housing,
wherein input characteristics among the built-in microphones and the external microphone are different due to an influence of an arrangement of the built-in microphones and the external microphone for the housing,
wherein the first input selection unit selects the input audio spectrum of the external microphone and the combined audio spectra generated by the second combining units as the input audio spectra to be selected to generate the combined audio spectrum having the directivity of the first combination direction, and
wherein the first combining unit generates the combined audio spectrum having the directivity of the first combination direction by combining power spectra of the input audio spectra and the combined audio spectra selected by the first input selection unit.

11. The audio signal processing device according to claim 1, further comprising:
a correction unit configured to correct the input audio spectrum input from at least one microphone based on a difference between the input audio spectra input from the plurality of microphones when characteristics are different among the plurality of microphones.

12. An audio signal processing method comprising:
generating a plurality of input audio spectra by performing frequency conversions on a plurality of input audio signals input from a plurality of microphones provided in a housing;
selecting input audio spectra corresponding to a first combination direction from among the input audio signals based on an arrangement of the microphones for the housing; and
generating a combined audio spectrum having directivity of the first combination direction by calculating power spectra of the selected input audio spectra.

13. A program for causing a computer to execute:
generating a plurality of input audio spectra by performing frequency conversions on a plurality of input audio signals input from a plurality of microphones provided in a housing;
selecting input audio spectra corresponding to a first combination direction from among the input audio signals based on an arrangement of the microphones for the housing; and
generating a combined audio spectrum having directivity of the first combination direction by calculating power spectra of the selected input audio spectra.

14. A computer-readable recording medium having a program recorded thereon, the program causing a computer to execute:
generating a plurality of input audio spectra by performing frequency conversions on a plurality of input audio signals input from a plurality of microphones provided in a housing;
selecting input audio spectra corresponding to a first combination direction from among the input audio signals based on an arrangement of the microphones for the housing; and
generating a combined audio spectrum having directivity of the first combination direction by calculating power spectra of the selected input audio spectra.
